(19) United States
(12) Patent Application Publication
(10) Pub. No.: US 2018/0309372 A1
(43) Pub. Date: Oct. 25, 2018

(54) SYSTEM AND METHOD FOR A SWITCHED MODE CONVERTER

(71) Applicant: Infineon Technologies Austria AG, Villach (AT)

(72) Inventors: Kennith Kin Leong, Villach (AT); Nico Fontana, Villach (AT); Gerald Deboy, Klagenfurt (AT)

(21) Appl. No.: 15/494,075

(22) Filed: Apr. 21, 2017

(51) Int. Cl. H02M 3/335; H02M 1/42; H02M 1/44; H02M 3/158; H02M 1/14; H02M 1/08; H02M 1/32

(52) U.S. Cl. CPC H02M 3/33546; H02M 1/4241; H02M 1/44; H02M 2001/0009; H02M 1/14; H02M 1/08; H02M 1/32; H02M 3/158

(57) ABSTRACT

In accordance with an embodiment, a converter includes: a rectifying stage having a first supply terminal and a second supply terminal, the first supply terminal and the second supply terminal configured to receive a bipolar ac signal from an AC power source, the rectifying stage including a half-bridge circuit coupled between the first supply terminal and the second supply terminal, a transformer, and a resonant tank coupled between an output of the half-bridge circuit and a primary winding of the transformer; and a DC-DC converter stage coupled between the rectifying stage and an output terminal.

### TECHNICAL FIELD

The present invention relates generally to an electronic circuit, and, in particular embodiments, to a system and method for a switched mode converter.

### BACKGROUND

Power supply systems are pervasive in many electronic applications from computers to automobiles. Generally, voltages within a power supply system are generated by performing a DC-DC, DC-AC, and/or AC-DC conversion by operating a switch loaded with an inductor or transformer. One class of such systems includes switch-mode power supply (SMPS). An SMPS is usually more efficient than other types of power conversion systems because power conversion is performed by controlled charging and discharging of the inductor or transformer and reduces energy lost due to power dissipation caused by resistive voltage drops.

Specific topologies of SMPS include buck converters, boost converters, and buck-boost converters, among others. Depending on the topology selected and the needs of a particular system, the SMPS may be implemented using a half-bridge architecture, a full bridge architecture, or with any other implementation known in the art.

A transformer may be used in some converters, in part, to provide galvanic isolation between input and output of the converter. For example, galvanically isolating an alternating current (AC) power source from the output of the converter may help protect against electrical shocks.

Converters may be implemented with resonant topologies. Resonant topologies typically exhibit high efficiency and high power density. Resonant topologies may be implemented by resonating a combination of inductors and capacitors. For example, an LLC converter is a resonant converter that includes two inductors and one capacitor.

A particular type of power supply that is widely used is the AC adapter. AC adapters are external AC/DC power supplies typically used to provide DC power from a standard AC power source. AC adapters may receive their power from an AC power source. The two most common types of AC power sources (also referred to as mains power) are the 120 Vᵣₘₛ, 60 Hz power source, also known as low-line power source or low-line power, and the 230 Vᵣₘₛ, 50 Hz power source, also known as high-line power source or high-line power. The root-mean-square (RMS) voltage may not be exactly 120 Vᵣₘₛ and 230 Vᵣₘₛ for low-line and high-line, respectively. For example, the mains voltage of a low-line input may vary between 85 Vᵣₘₛ and 140 Vᵣₘₛ. Similarly, the mains voltage of a high-line input may vary between 200 Vᵣₘₛ and 270 Vᵣₘₛ. The AC signal produced by a low-line power source may be referred to as a low-line AC signal, low-line signal or low-line voltage. Similarly, the AC signal produced by a high-line power source may be referred to as a high-line AC signal, high-line signal or high-line voltage.

Universal adapters are AC adapters that are configured to operate with either low-line power or high-line power. Some universal adapters automatically adjust to the type input power received. Other universal adapters may allow for manual selection of the mode of operation.

Converters may also be used in systems that comply with a particular standard. For example, the USB Power Delivery (USB-PD) specification describes the standard related to power delivery in USB applications.

### SUMMARY

In accordance with an embodiment, a converter includes: a rectifying stage having a first supply terminal and a second supply terminal, the first supply terminal and the second supply terminal configured to receive a bipolar ac signal from an AC power source, the rectifying stage including a half-bridge circuit coupled between the first supply terminal and the second supply terminal, a transformer, and a resonant tank coupled between an output of the half-bridge circuit and a primary winding of the transformer; and a DC-DC converter stage coupled between the rectifying stage and an output terminal.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1a shows a schematic diagram of a converter with a LLC converter stage, according to an embodiment of the present invention;

FIG. 1b shows a schematic diagram of a possible implementation of the converter of FIG. 1a, according to an embodiment of the present invention;

FIG. 1c shows waveforms of the converter of FIG. 1b, according to an embodiment of the present invention;

FIG. 2a shows a converter including an alternating current LLC converter (ACX) converter stage, according to another embodiment of the present invention;

FIG. 2b shows a possible implementation of an ACX converter, according to an embodiment of the present invention;

FIGS. 2c-2d show possible implementations of bidirectional switches, according to embodiments of the present invention;

FIGS. 2e-2h illustrate the switching and current behavior of the ACX converter of FIG. 2b, according to an embodiment of the present invention;

FIGS. 2i and 2j illustrate waveforms of the ACX converter of FIG. 2b during normal operation, according to an embodiment of the present invention;

FIG. 2k illustrates a flow chart of an embodiment method of operating an ACX converter, according to an embodiment of the present invention;

FIGS. 3a-3j illustrate the operation of an ACX primary circuit of an ACX converter with zero voltage switching (ZVS), according to an embodiment of the present invention;

FIG. 3k illustrates a flow chart of an embodiment method of operating an ACX primary circuit with ZVS, according to an embodiment of the present invention;

FIG. 4 shows an ACX converter, according to another embodiment of the present invention;

FIGS. 5a and 5b illustrate a schematic diagram and waveforms of an ACX converter operating with a first mode of control, according to an embodiment of the present invention;

FIGS. 6-8 illustrate waveforms of various ACX converters utilizing various modes of control, according to various embodiments of the present invention;

FIG. 9a shows a possible implementation of an ACX converter, according to another embodiment of the present invention;

FIGS. 9b-9e illustrate the switching and current behavior of the ACX converter of FIG. 9a, according to an embodiment of the present invention;

FIG. 10a shows a possible implementation of an ACX converter, according to another embodiment of the present invention;

FIGS. 10b-10e illustrate the switching and current behavior of the ACX converter of FIG. 10a, according to an embodiment of the present invention;

FIG. 11a shows another possible implementation of the converter of FIG. 2a, according to an embodiment of the present invention;

FIGS. 11b-11e illustrate the switching and current behavior of the ACX converter of FIG. 11a, according to an embodiment of the present invention;

FIGS. 11f-11i illustrate waveforms of the converter of FIG. 11a during normal operation, according to an embodiment of the present invention;

FIG. 12a shows a possible implementation of the converter of FIG. 2a, according to another embodiment of the present invention;

FIGS. 12b-12g illustrate the switching and current behavior of the DC-DC converter of FIG. 12a, according to an embodiment of the present invention;

FIGS. 12h-12i illustrate waveforms of the DC-DC converter of FIG. 12a during normal operation, according to an embodiment of the present invention;

FIGS. 12j-12k illustrate waveforms of the converter of FIG. 12a during normal operation, according to an embodiment of the present invention;

FIG. 13a shows a possible implementation of the converter of FIG. 2a, according to another embodiment of the present invention;

FIGS. 13b, and 13c illustrate waveforms of the converter of FIG. 13a during normal operation, according to an embodiment of the present invention;

FIG. 14a shows a possible implementation of the converter of FIG. 2a, according to another embodiment of the present invention;

FIGS. 14b-14e illustrate the switching and current behavior of the DC-DC converter of FIG. 14a, according to an embodiment of the present invention;

FIGS. 14f and 14g illustrate waveforms of the DC-DC converter of FIG. 14a during normal operation, according to an embodiment of the present invention;

FIGS. 14h and 14i illustrate waveforms of the converter of FIG. 14a during normal operation, according to an embodiment of the present invention;

FIG. 15a shows a possible implementation of the converter of FIG. 2a, according to another embodiment of the present invention;

FIGS. 15b, and 15c illustrate waveforms of the converter of FIG. 15a during normal operation, according to an embodiment of the present invention;

FIG. 16a shows a converter including an ACX converter stage with power factor correction (PFC), according to another embodiment of the present invention;

FIG. 16b shows a possible implementation of the converter of FIG. 16a, according to an embodiment of the present invention;

FIG. 16c illustrate waveforms of the converter of FIG. 16b during normal operation, according to an embodiment of the present invention; and

FIGS. 17 and 18 show possible implementations of the converter of FIG. 16a, according to an embodiment of the present invention.

Corresponding numerals and symbols in different figures generally refer to corresponding parts unless otherwise indicated. The figures are drawn to clearly illustrate the relevant aspects of the preferred embodiments and are not necessarily drawn to scale. To more clearly illustrate certain embodiments, a letter indicating variations of the same structure, material, or process step may follow a figure number.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, a converter having a resonant converter stage cascaded with a DC-DC converter stage in various configurations, voltage and power levels. Embodiments of the present invention may be used with other configurations, and other voltage and power levels.

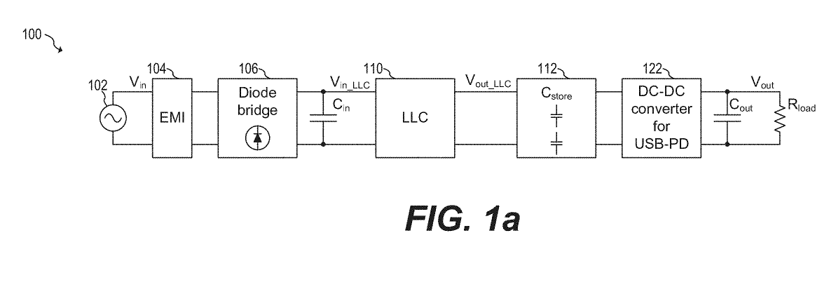

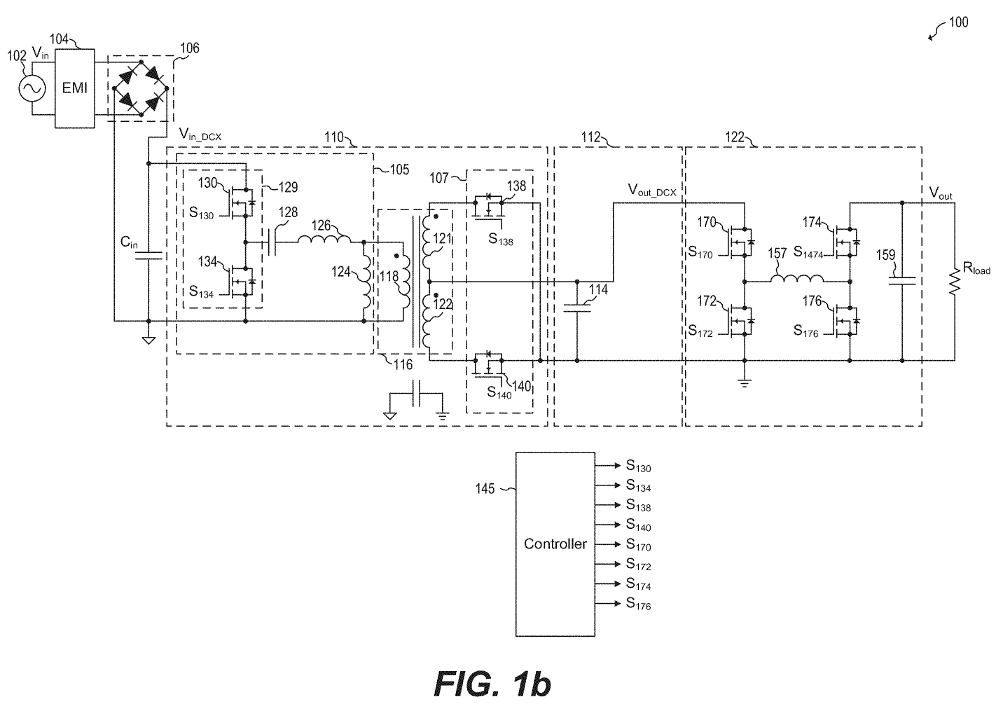

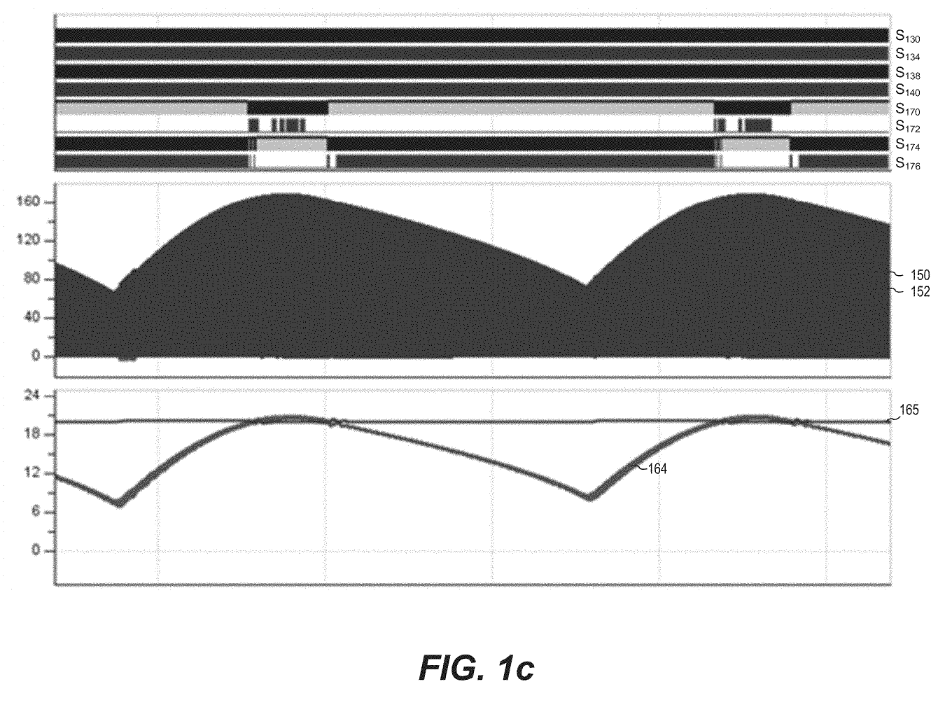

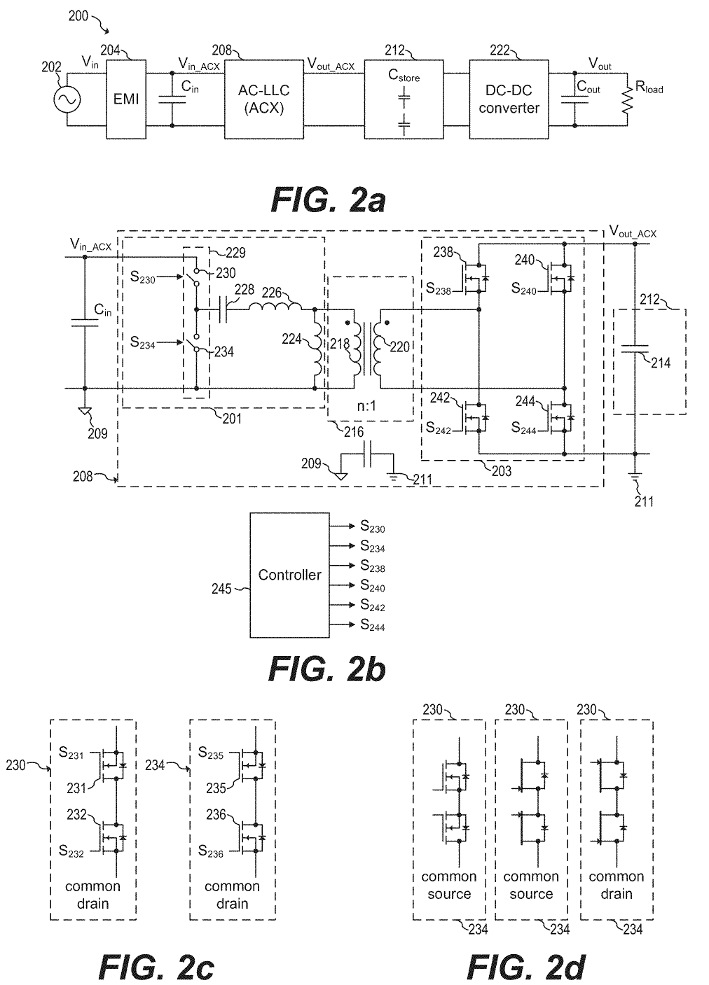

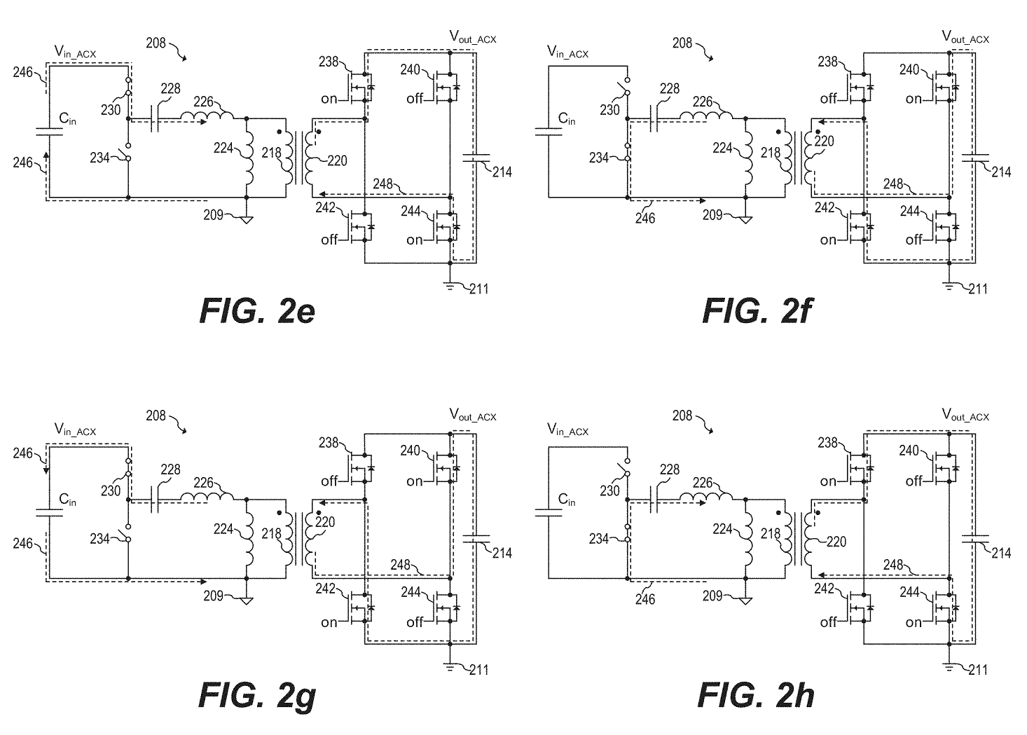

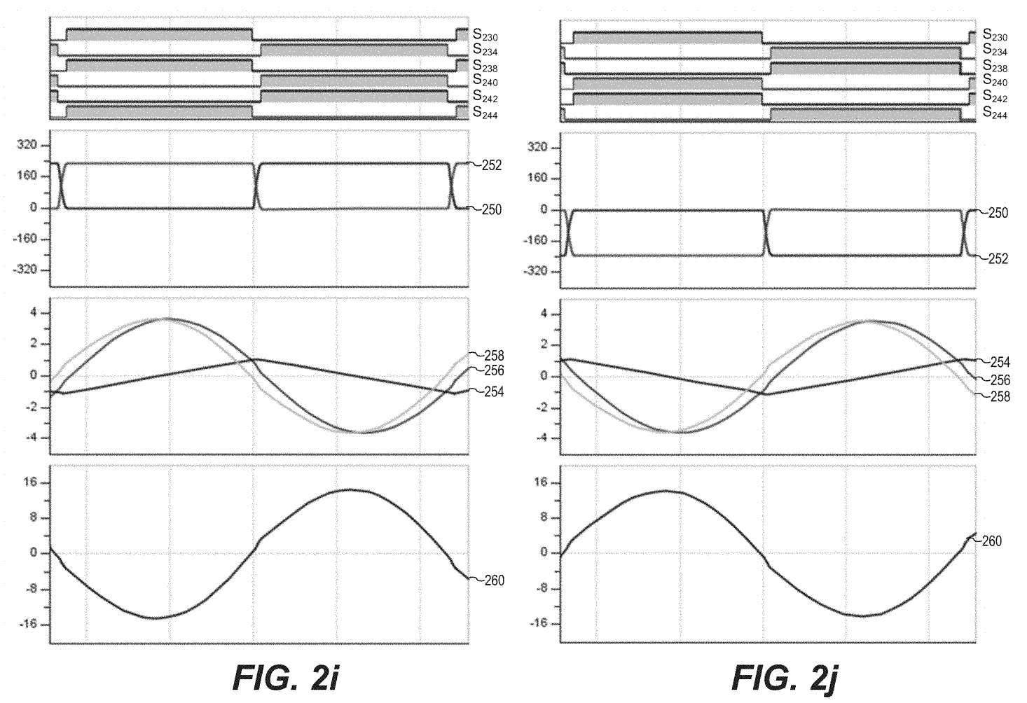

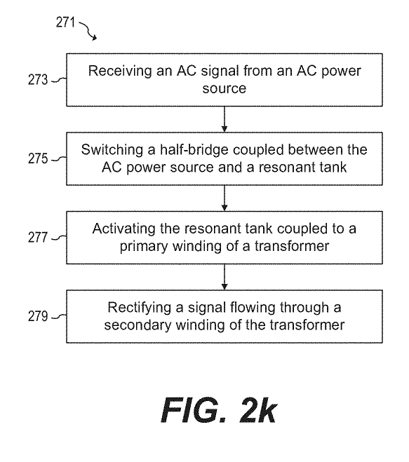

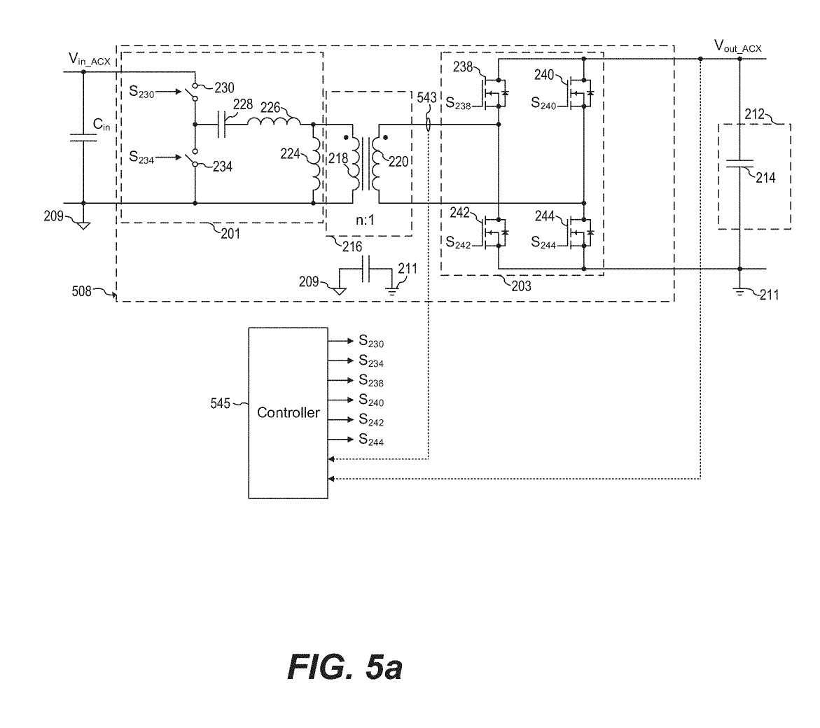

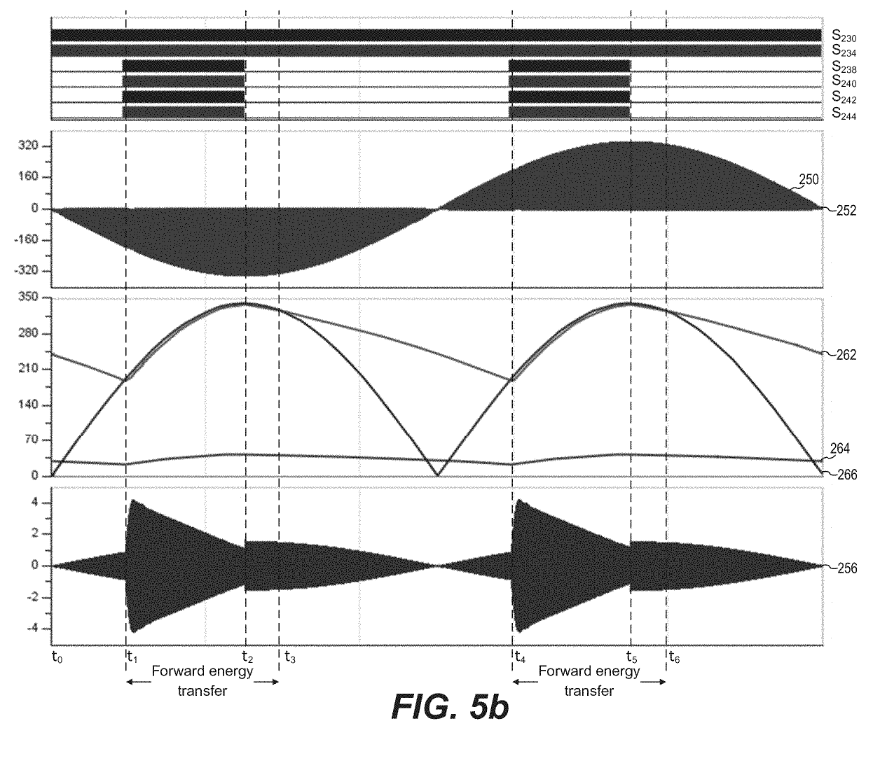

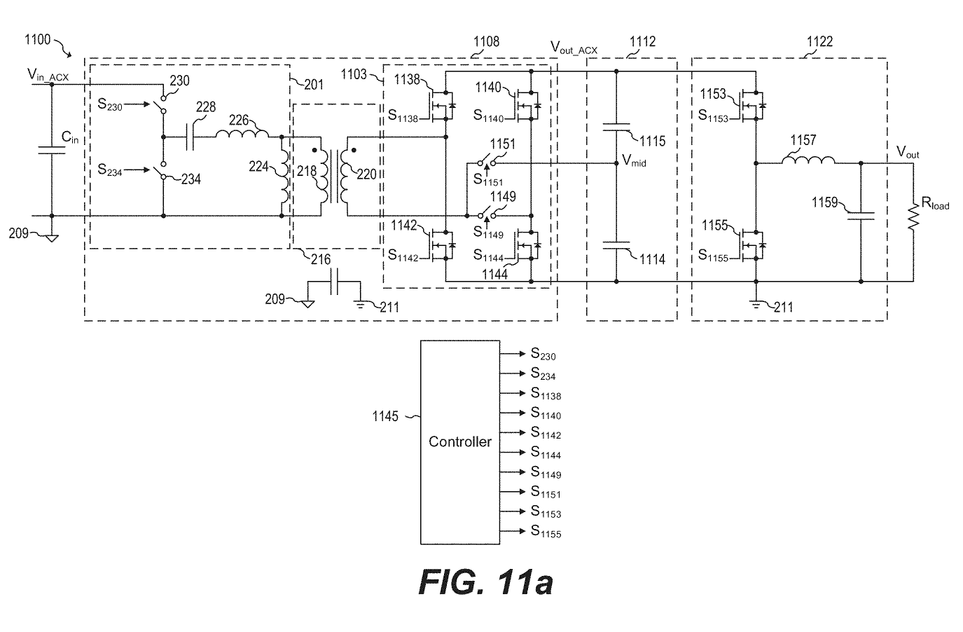

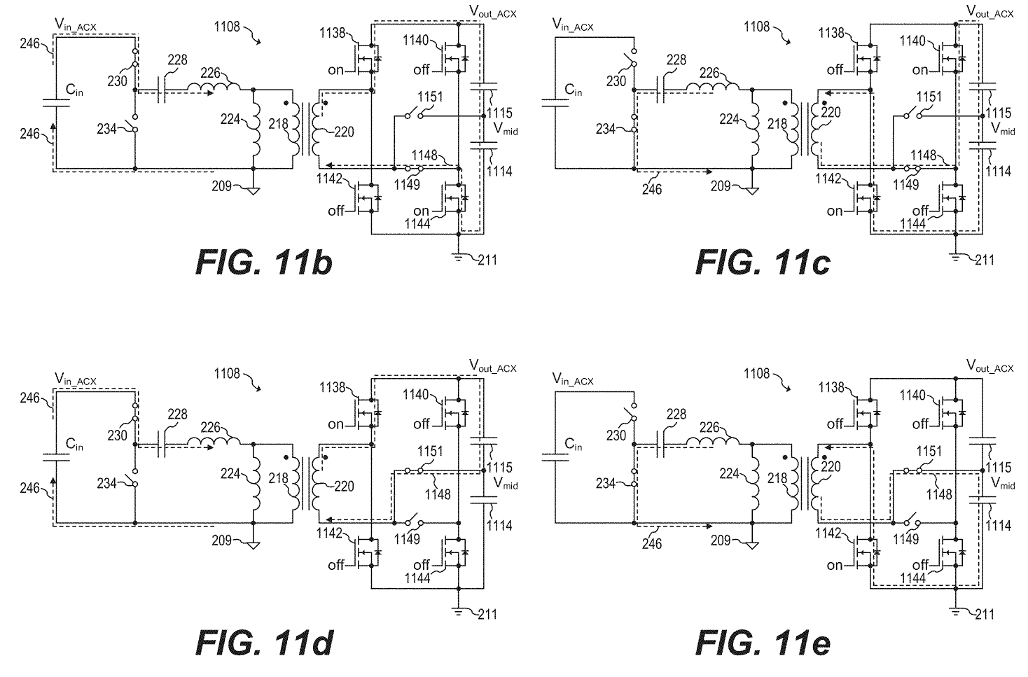

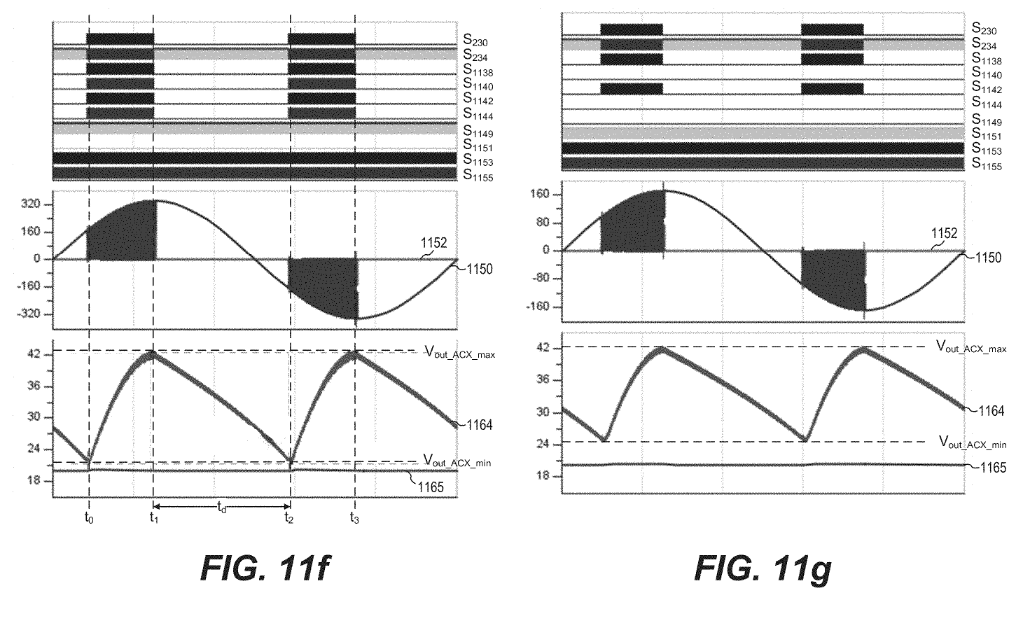

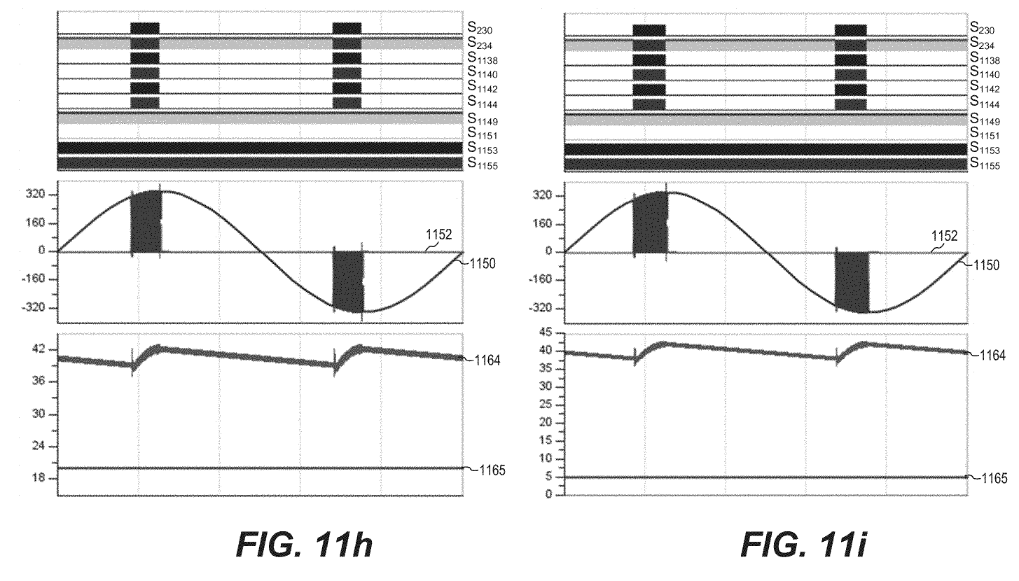

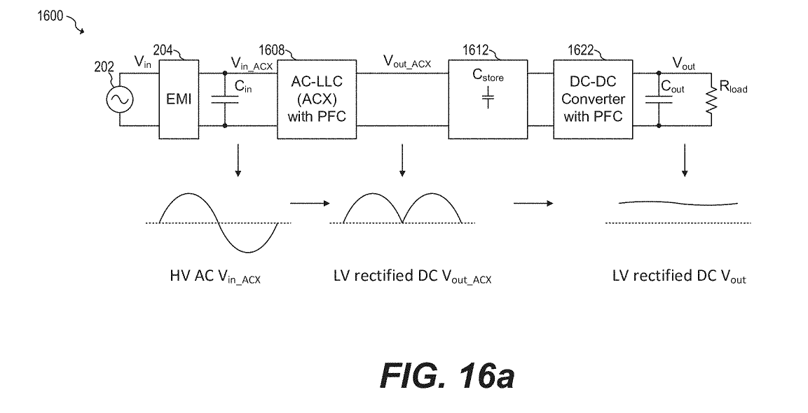

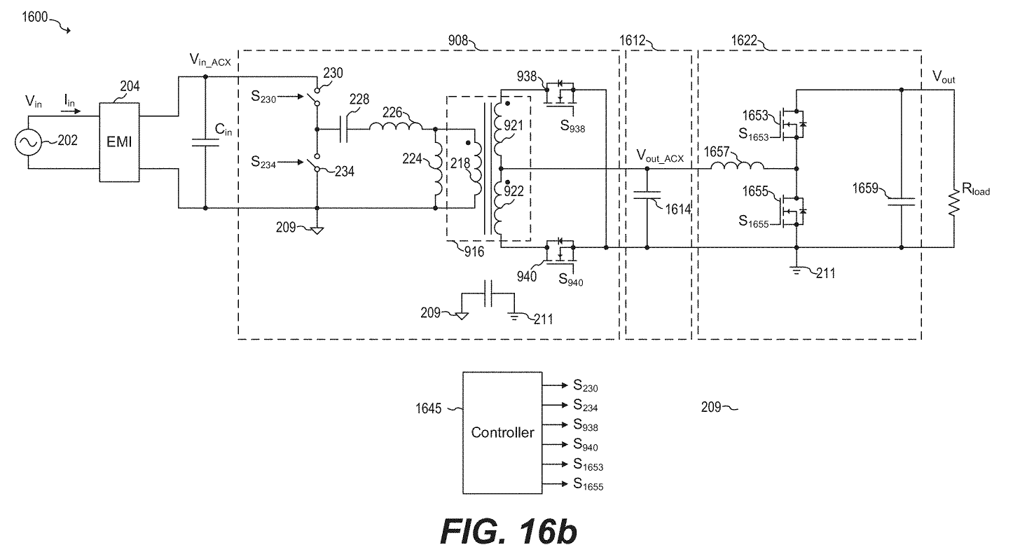

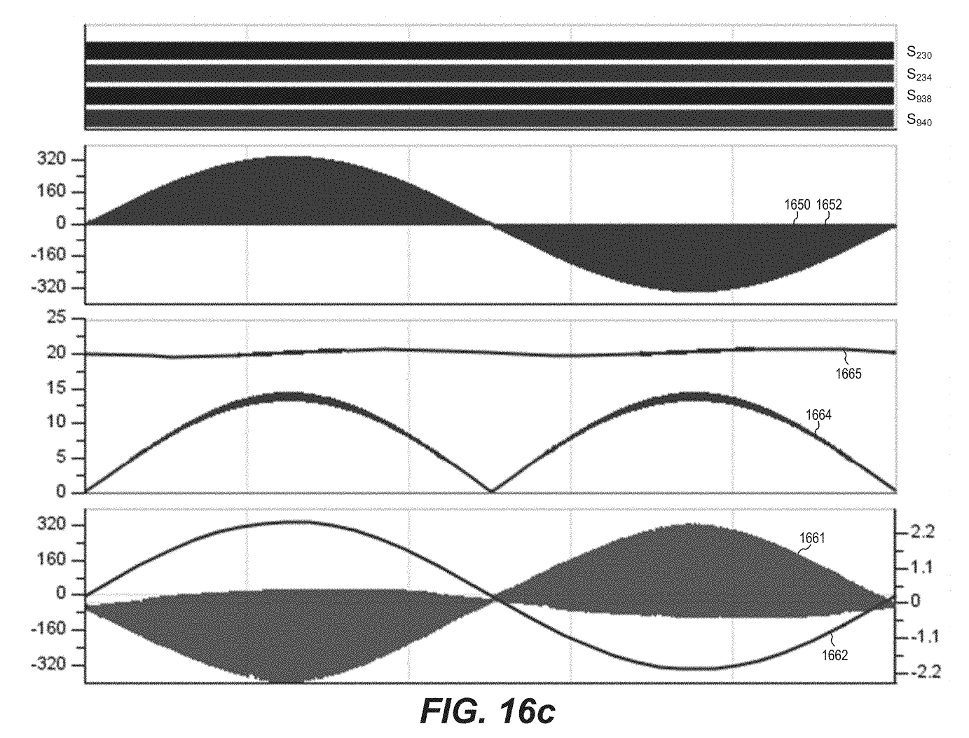

FIG. 1a shows a schematic diagram of a first embodiment of the present invention. FIG. 1b shows a schematic diagram of a possible implementation of the first embodiment of the present invention. FIG. 2a shows a schematic diagram of a second embodiment of the present invention. FIGS. 11a, 12a, 13a, 14a and 15a show five schematic diagrams of possible implementations of the second embodiment of the present invention. FIG. 16a shows a schematic diagram of a third embodiment of the present invention. FIGS. 16b, 17, and 18 show schematic diagrams of three possible implementations of the third embodiment of the present invention. FIGS. 2b, 9a and 10a show schematic diagrams of three possible implementation of an ACX converter of the second or third embodiment of the present invention. FIGS. 2b and 2c show schematic diagrams of four possible implementations of bidirectional switches of an ACX converter of the second or third embodiment of the present invention. FIGS. 5b and 6-8 show waveforms using four possible modes of control of an ACX converter of the second embodiment of the present invention. FIG. 16c show waveforms using a possible mode of control of an ACX converter of the third embodiment of the present invention.

In an embodiment of the present invention, a converter provides a regulated DC output to a load by using a resonant converter stage that receives energy from an AC power source, and a DC-DC converter stage that regulates the output voltage. The resonant converter may also provide galvanic isolation between the AC power source and the load. The DC-DC converter may be implemented to comply with industry standards, such as USB-PD, and may support a wide range of voltage and power levels. Some embodiments may be implemented with power factor correction (PFC). Other embodiments may be implemented without PFC. The resonant converter stage with zero voltage switching (ZVS) or quasi-ZVS (QZVS) techniques. The DC-DC converter stage may also be implemented with ZVS or QZVS.

In some embodiments, the resonant converter stage is implemented with a traditional LLC topology that uses a bridge rectifier coupled between the AC power source and the LLC converter. The LLC converter may operate with a constant frequency and duty cycle Other embodiments may implement the resonant converter stage with an ACX topology configured to receive an AC signal from the AC power source and produce a rectified signal. Embodiments implementing the resonant converter stage with an ACX topology may operate without a bridge rectifier. The ACX converter may be implemented with bidirectional switches that may switch with constant frequency and duty cycle.

Some applications may benefit from AC/DC conversion. For example, the USB-PD specification version 1.1, revision 3.0, makes it possible for a monitor with a supply from the wall to simultaneously charge a laptop through a USB cable while operating as a display. Some embodiments of the present invention are configured to receive an AC signal from an AC power source and provide power to a load while complying with the USB-PD standard. A resonant stage implemented with an LLC converter may be used to transfer energy from the AC power source to a DC-DC converter while providing galvanic isolation. A diode-bridge may be used to provide a rectified signal to the LLC converter.

FIG. 1a shows converter 100 with LLC converter 110, according to an embodiment of the present invention. Converter 100 includes AC power source 102, electromagnetic interference (EMI) filter 104, diode bridge 106, input capacitor Cᵢₙ, LLC converter 110, energy storage stage 112, DC-DC converter 122, output capacitor Cₒᵤₜ and load R_{load}.

During normal operation, diode bridge 106 may rectify an AC signals received from AC power source 102 and provide a rectified voltage to node Vᵢₙ_{_}_{LLC}. Capacitor Cᵢₙ may provide energy storage, in part, to reduce the voltage ripple of node Vᵢₙ_{_}_{LLC}. LLC converter no may receive the rectified voltage and deliver power to energy storage stage 112. LLC converter 110 may also provide galvanic isolation from AC power source 102 by using a transformer. DC-DC converter 122 may be used to deliver and regulate power to load R_{load}. EMI filter 104 may be used to reduce or eliminate EMI generated by converter 100.

Diode bridge 106 is configured to rectify an AC signal from AC power source 102 and produce a DC voltage at node Vᵢₙ_{_}_{LLC}. Diode bridge 106 may be implemented according to various ways known in the art. For example, some embodiments may implement diode bridge 106 with four diodes. Other embodiments may use synchronous rectification techniques.

LLC converter no may receive a rectified signal from diode bridge 106 and produce a DC voltage at node Vₒᵤₜ_{_}_{LLC}. LLC converter no may be implemented as a conventional LLC converter. For example, the switching frequency of LLC converter no may be modulated to produce a regulated voltage at node Vₒᵤₜ_{_}_{LLC}. Alternatively, LLC converter no may be implemented with fixed frequency techniques. For example, since DC-DC converter 122 is coupled between LLC converter no and output node Vₒᵤₜ, LLC converter no may switch at a constant frequency and constant duty cycle, and the voltage of node Vₒᵤₜ may be regulated by DC-DC converter 122. The switching frequency of LLC converter 122 may be, for example, higher than 20 kHz. Implementations with frequencies of 100 kHz or higher are also possible. In some embodiments, LLC converter 110 may implement ZVS or QZVS.

DC-DC converter 122 may be implemented according to various ways known in the art. For example, DC-DC converter 122 may be implemented as a buck converter, boost converter, buck-boost converter with inverting and non-inverting topologies.

EMI filter 104 may be implemented according to various ways known in the art. EMI filter 104 may be configured to filter out frequencies in the range of frequencies that LLC converter no switches. Since LLC converter no may switch at frequencies higher than mains frequency, EMI filter 104 may be implemented with smaller inductors. In some embodiments, EMI filter 104 may be implemented as a notch filter to filter out a single frequency. For example, such may be the case for embodiments implementing LLC converter no with fixed frequency operation.

FIG. 1b shows a possible implementation of converter 100, according to an embodiment of the present invention As shown in FIG. 1131, diode bridge 106 includes 4 diodes. LLC converter no includes LLC primary circuit 105, transformer 116, and LLC secondary circuit 107. LLC primary circuit 105 includes half-bridge 129, resonant capacitor 128, resonant inductors 126, and 124. Half-bridge 129 includes transistors 130, 134. Transformer 116 includes primary winding 118, upper secondary winding 121, and lower secondary winding 122. LLC secondary circuit 107 includes transistors 138 and 140. Energy storage stage 112 includes capacitor 114. DC-DC converter 122 is implemented as a non-inverting buck-boost and includes transistors 170, 172, 174, and 176, capacitor 159, and inductor 157. Capacitor 159 also serves as output capacitor Cₒᵤₜ.

During normal operation, LLC converter 110 receives a DC signal at node Vᵢₙ_{_}_{LLC} and produces a step down voltage at node Vₒᵤₜ_{_}_{LLC}. Energy storage stage 112 stores energy and may also reduce the voltage ripple of node Vₒᵤₜ_{_}_{LLC}. DC-DC converter 122 receives the step down voltage of node Vₒᵤₜ_{_}_{LLC} and produces a regulated voltage at node Vₒᵤₜ.

LLC converter no may operate as a conventional LLC converter. For example, half-bridge 129 may switch according to switching techniques of a conventional LLC converter to transfer energy to the secondary side of transformer 116. For example, the switching frequency of LLC converter 110 may be modulated to control the voltage of node Vₒᵤₜ_{_}_{LLC}. LLC converter no may switch at frequencies higher than 20 kHz. LLC converter no may switch at frequencies around 100 kHz. Other frequencies may be used.

LLC secondary circuit 107 may be implemented according to various ways known in the art. For example, as shown in FIG. 1b, LLC secondary circuit 107 may be implemented with a center-tap configuration. Other embodiments may implement LLC secondary circuit 107 with a voltage doubler topology, a full-bridge topology, or any other topology known in the art.

DC-DC converter 122 may produce a regulated voltage at node Vₒᵤₜ. Since DC-DC converter 122 is implemented as a buck-boost converter, DC-DC converter 122 may operate as a buck converter when the voltage of node Vₒᵤₜ_{_}_{LLC} is higher than the desired voltage at Vₒᵤₜ, and may operate as a boost converter when the voltage of node Vₒᵤₜ_{_}_{LLC} is lower than the desired voltage at Vₒᵤₜ. When DC-DC 122 operates as a buck converter, transistor 176 is off and transistor 174 is on, and transistors 170 and 172 switch on and off according to a typical buck converter. When DC-DC 122 operates as a boost converter, transistor 170 is on, transistor 172 is off, and transistors 174 and 176 switch on and off according to a typical boost converter.

Since DC-DC converter 122 is implemented as a non-inverted buck-boost converter, DC-DC converter 122 may produce a regulated output irrespective of whether AC power source 102 produces a high-line signal or a low-line signal. For example, when AC power source 102 produces a high-line voltage, DC-DC converter 122 may operate as a buck converter for the majority of the time. When AC power source 102 produces a low-line voltage, DC-DC converter 122 may operate as a boost converter for the majority of the time.

DC-DC converter 122 may regulate the voltage of node Vₒᵤₜ to, for example, 20 V, 18 V, 12 V, 10 V, 5 V, 3.3 V, 1.8 V, 1.2 V, or 1 V. Other values may be used. DC-DC converter 122 may be implemented according to various ways known in the art and may be configured to regulate the voltage while complying with a particular standard such as, for example, USB-PD. For example, as shown in FIG. 1b, DC-DC converter 122 may be implemented with a buck-boost topology. Other embodiments may implement DC-DC converter 122 as a buck converter, boost converter, or with any other topology known in the art. Converter 100 may be modified to accommodate for a particular DC-DC converter implementation.

Controller 145 is configured to produce signals S₁₃₀, S₁₃₄, S₁₃₈, S₁₄₀, S₁₇₀, S₁₇₂, S₁₇₄, and S₁₇₆, to drive transistors 130, 134, 138, 140, 170, 172, 174, and 176, respectively. Coupling controller 145 to transistors 130, 134, 138, 140, 170, 172, 174, and 176 may be achieved through direct electrical connection or indirect electrical connections. For example, opto-couplers may be used to electrically isolate controller 145 from other parts of the circuit. Coupling between controller 145 and other components of converter 100 may also be achieved in other ways known in the art.

Controller 145 may be implemented as a single chip. For example, controller 145 may be implemented in a monolithic substrate. Alternatively, controller 145 may be implemented as a collection of controllers, such as, for example, a controller for controlling LLC converter 110, and a controller for controlling DC-DC converter 122. Other implementations known in the art are also possible.

Transformer 116 may include primary winding 118, upper secondary winding 121, and lower secondary winding 122. Other transformer implementations are possible. For example, transformer 116 may be implemented with a single secondary winding. The selection of the transformer may depend on the particular application. Converter 100 may be modified to accommodate a particular transformer implementation. For example, LLC converter no and controller 145, may be modified to accommodate a particular transformer selection. In some embodiments, resonant inductors 126 and 124 may be incorporated into transformer 116. Alternatively, resonant capacitor 128 and resonant inductors 126 and 124 may be implemented with discrete components. Other implementations are also possible.

FIG. 1c shows waveforms of converter 100 as implemented in FIG. 1b during an AC cycle, according to an embodiment of the present invention. FIG. 1c includes curve 150 of the drain-to-source voltage (V_{ds}) of transistor 130, curve 152 of the V_{ds} of transistor 134, curve 165 of the voltage of node Vₒᵤₜ, curve 164 of the voltage of node Vₒᵤₜ_{_}_{LLC}, the signals S₁₃₀, S₁₃₄, S₁₃₈, S₁₄₀, S₁₇₀, S₁₇₂, S₁₇₄, and S₁₇₆. FIG. 1c illustrates waveforms of converter 100 when operating with power source 102 producing a low-line AC signal.

As shown in FIG. 1c, signals S₁₃₀, S₁₃₄, S₁₃₈ and S₁₄₀ are continuously switching according to switching of a typical LLC converter. Signals S₁₇₀, S₁₇₂, S₁₇₄ and S₁₇₆ switch as either buck or a boost depending on whether curve 164 is above or below curve 165. The envelope of the voltage across transistors 130 and 134 track the AC signal from AC power source 102, as shown in curves 150 and 152. Curves 150 and 152 may not be distinguishable from each other in FIG. 1c.

Advantages of some embodiments of the present invention include that a LLC converter may be implemented with two transistors on the primary side of the transformer. Since transformer size is typically inversely related to the switching frequency, using an LLC topology with a switching frequency substantially higher than the switching frequency of mains power may result in a physically small transformer.

In an embodiment of the present invention, an ACX converter receives an AC signal from an AC power source and produces a rectified signal while providing galvanic isolation between the AC power source and a load. The ACX converter is implemented with a half-bridge including two bidirectional switches that switch at a constant frequency and duty cycle. A DC-DC converter coupled to the ACX converter regulates the output voltage delivered to the load.

FIG. 2a shows converter 200 including ACX converter 208, according to another embodiment of the present invention. Converter 200 includes AC power source 202, EMI filter 204, input capacitor Cᵢₙ, AC-LLC (ACX) converter 208, energy storage stage 212, DC-DC converter 222, output capacitor Cₒᵤₜ and load R_{load}.

During normal operation, ACX converter 208 receives an AC signal from AC power source 102 and delivers a rectified signal to energy storage stage 212 and DC-DC converter 222. ACX converter 208 also provides galvanic isolation from AC power source 102 by the use of a transformer. DC-DC converter 222 regulates and delivers power to load R_{load}. EMI filter 204 may be used to reduce or eliminate EMI generated by converter 200.

As shown in FIG. 2a, ACX converter 208 is exposed to a full AC signal swing as opposed to receiving a rectified signal. Since ACX converter 208 is capable of operating with an AC signal as an input, capacitor Cᵢₙ may be implemented with a small capacitance. Since capacitors tend to be physically smaller with lower capacitances, using capacitor Cᵢₙ with a small capacitance may reduce the physical volume of converter 200.

ACX converter 208 may be implemented with bidirectional switches switching at a constant frequency and duty cycle. The switching frequency may depend on the particular application and may be, for example, 100 kHz. In some embodiments, ACX converter 208 may implement ZVS or QZVS. The switching duty cycle of the bidirectional switches of ACX converter 208 may be, for example, 50%. A smaller duty cycle may be used depending on the application. For example, a duty cycle smaller than 50% may be used to accommodate for ZVS or QZVS.

DC-DC converter 222 may be implemented according to various ways known in the art. For example, DC-DC converter 222 may be implemented as a buck converter, boost converter, buck-boost converter, and with inverting and non-inverting topologies. In some embodiments, DC-DC converter 222 may be combined with ACX secondary circuit 203.

EMI filter 204 may be implemented according to various ways known in the art. Since ACX converter 208 may switch at a constant frequency, EMI 204 may be implemented, for example, as a notch filter configured to remove the switching frequency of ACX converter 208.

FIG. 2b shows a possible implementation of ACX converter 208, according to an embodiment of the present invention. ACX converter 208 includes ACX primary circuit 201, transformer 216, ACX secondary circuit 203, and controller 245. ACX primary circuit 201 includes half-bridge 229, resonant capacitor 228, and resonant inductors 226 and 224. Half-bridge 229 includes bidirectional switches 230 and 234. Transformer 216 includes primary winding 218 and secondary winding 220. ACX secondary circuit 203 includes transistors 238, 240, 242, and 244.

During normal operation, ACX converter 208 receives an AC signal at node Vᵢₙ_{_}_{ACX} and delivers a rectified output at node Vₒᵤₜ_{_}_{ACX}. In particular, half-bridge 229 receives an AC signal from node Vᵢₙ_{_}_{ACX} and bidirectional switches 230 and 234 switch at a constant frequency and duty cycle to transfer energy to the secondary sides of transformer 216. Transistors 238, 240, 242, and 244 operate as a rectifying bridge that produces a rectified output at node Vₒᵤₜ_{_}_{ACX}.

Transistors 238, 240, 242, and 244 may switch to produce a rectified voltage of node Vₒᵤₜ_{_}_{ACX} according to synchronous rectification techniques. For example, transistors 238, 240, 242 and 244 may switch with ZVS or QZVS according to synchronous rectification techniques known in the art. As can be seen in FIG. 2b, even if transistors 238, 240, 242 and 244 are continuously off, a rectified voltage may be produced at node Vₒᵤₜ_{_}_{ACX} by the body diodes of transistors 238, 240, 242, and 244. Therefore, some embodiments may implement diodes instead of transistors for transistors 238, 240, 242, and 244.

Controller 245 is configured to produce signals S₂₃₀, S₂₃₄, S₂₃₈, S₂₄₀, S₂₄₂, and S₂₄₄, to drive bidirectional switches 230 and 234, and transistors 238, 240, 242, and 244, respectively. As described below with respect to FIGS. 2c and 2d, in some embodiments signal S₂₃₀ may include two independent signals for independently controlling two independent transistors of bidirectional switch S₂₃₀. Similarly, signal S₂₃₄ may include two independent signals for independently controlling two independent transistors of bidirectional switch S₂₃₄.

Coupling controller 245 to bidirectional switches 230 and 234, and transistors 238, 240, 242, and 244 may be achieved through direct electrical connection or indirect electrical connections. For example, opto-couplers may be used to electrically isolate controller 245 from other parts of the circuit. Coupling between controller 245 and other components of converter 200 may also be achieved in other ways known in the art.

Controller 245 may be implemented as a single chip. For example, controller 245 may be implemented in a monolithic substrate. Alternatively, controller 245 may be implemented as a collection of controllers, such as, for example, a controller for controlling ACX primary circuit 201, and a controller for controlling ACX secondary circuit 203. Other implementations known in the art are also possible.

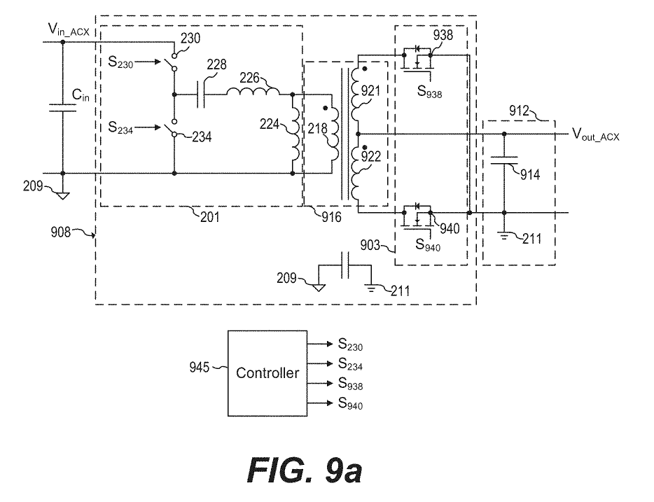

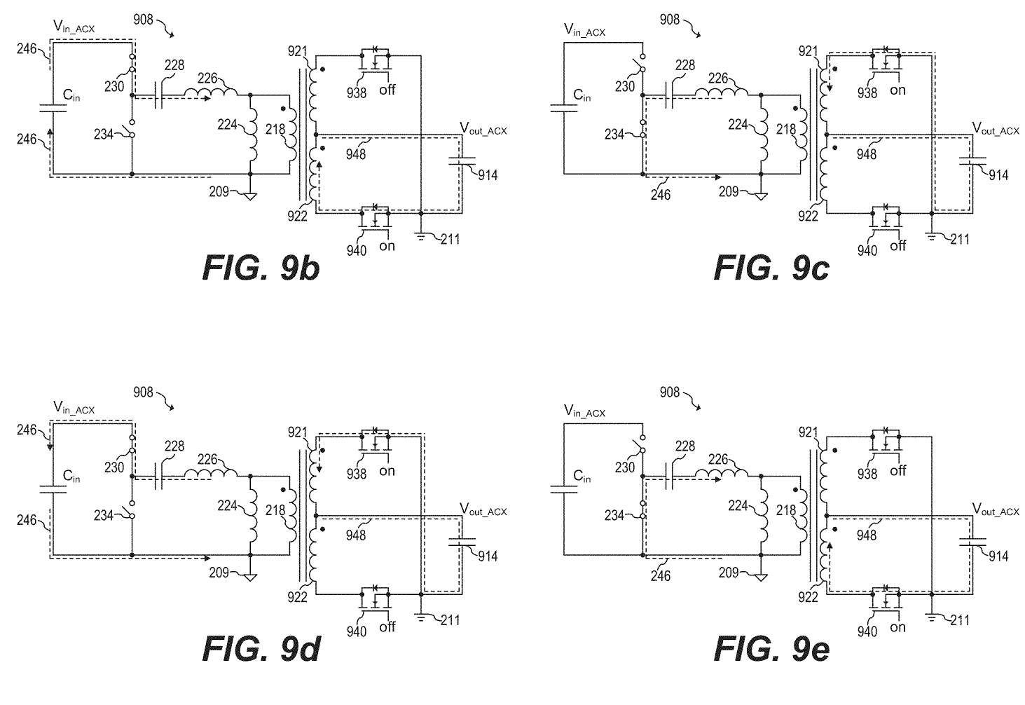

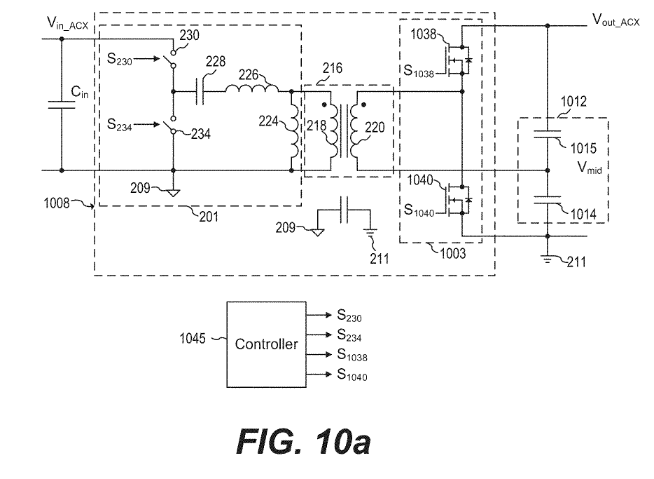

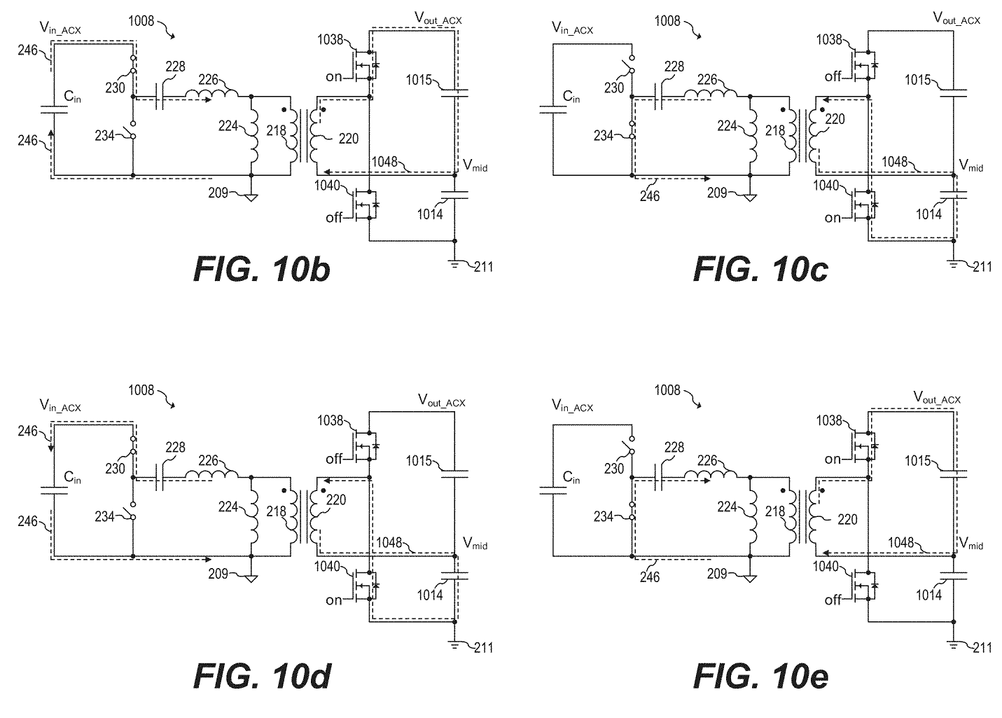

ACX secondary circuit 203 may be implemented as a full-bridge synchronous rectifier. Alternatively, other implementations, such as a center-tap configuration or a voltage doubler may be used. For example, FIGS. 9a and 10a show possible implementations of an ACX secondary circuit in an ACX converter.

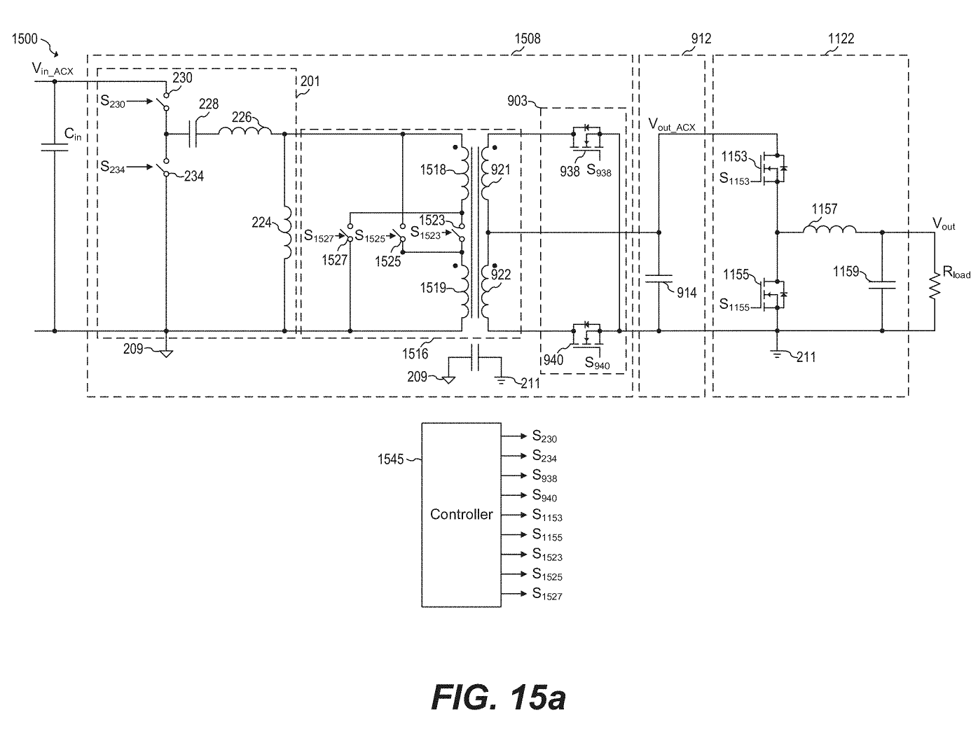

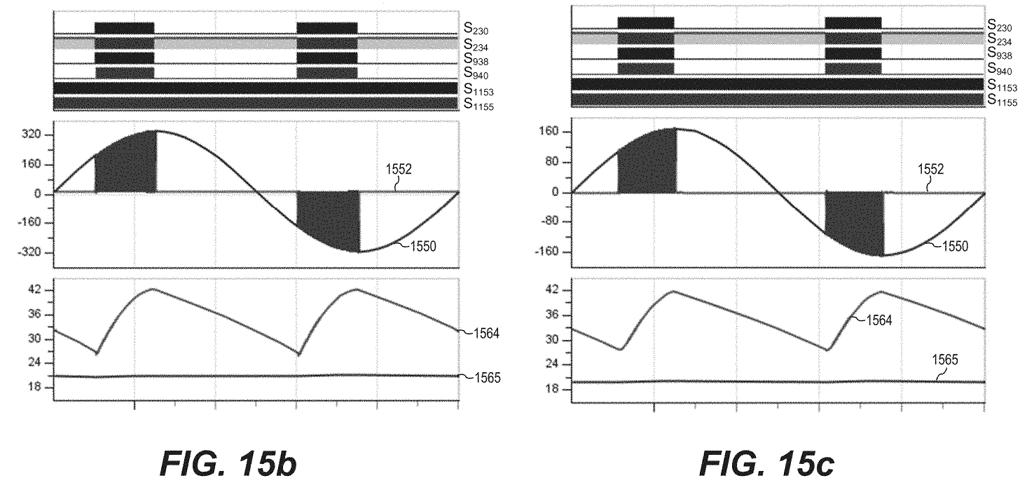

Transformer 216 may include primary winding 218, and secondary winding 220. Other transformer implementations are possible. For example, transformer 216 may be implemented with a center-tapped configuration. The selection of the transformer may depend on the particular application. Converter 200 may be modified to accommodate a particular transformer implementation. For example, ACX converter 208 and controller 245, may be modified to accommodate a particular transformer selection. FIGS. 9a and 15a, for example, show possible implementations of transformer 216.

In some embodiments, resonant inductors 226 and 224 may be incorporated into transformer 216. Alternatively, resonant capacitor 128 and resonant inductors 226 and 224 may be implemented with discrete components. Other implementations are also possible.

Bidirectional switches 230 and 234 may switch at a fixed frequency above the frequency of the AC voltage of node Vᵢₙ_{_}_{ACX}. The particular switching frequency of bidirectional switches 230 and 234 may depend on the particular application. For example, bidirectional switches 230 and 234 may switch at 100 kHz. Other frequencies may be used.

Bidirectional switches 230 and 234 may be implemented according to various ways known in the art. For example, FIG. 2c shows a possible implementation of bidirectional switches 230 and 234, according to an embodiment of the present invention. As shown in FIG. 2c, bidirectional switches 230 and 234 may be implemented with NMOS transistors in a back-to-back, common-drain configuration. Each of the transistors of bidirectional switches 230 and 234 may be independently controllable. In others words, controller 245 may produce independent signals S₂₃₁, S₂₃₂, S₂₃₅ and S₂₃₆ for controlling bidirectional switches 230 and 234, respectively.

Alternatively, bidirectional switches 230 and 234 may be implemented with other transistor technologies and in other configurations. For example, FIG. 2d shows possible implementations of bidirectional switches with common-source and common-drain back-to-back configurations and using different transistor technologies, including metal-oxide-semiconductor field effect transistor (MOSFET) and high electron mobility transistors (HEMTs), according to embodiments of the present invention. Other transistor types, such as gallium nitride (GaN) transistors, GaN HEMT, junction field-effect transistor (JFET), bipolar junction transistor (BJT), and others may also be used.

FIGS. 2e-2h illustrate the switching and current behavior of ACX converter 208, according to an embodiment of the present invention. In particular, FIGS. 2e-2h illustrate the switch and current behavior of ACX converter 208 when operating in different states. FIGS. 2e and 2f correspond to current and switching behavior when the voltage of node Vᵢₙ_{_}_{ACX} is positive with respect to primary ground 209 and FIGS. 2g and 2h correspond to current and switching behavior when the voltage of node Vᵢₙ_{_}_{ACX} is negative with respect to primary ground 209. As shown in FIG. 2e, when the voltage of node Vᵢₙ_{_}_{ACX} is positive, ACX primary circuit 201 is in a first state with bidirectional switch 230 closed and bidirectional switch 234 open. Current 246, therefore, may flow from capacitor Cᵢₙ towards resonant capacitor 228 and resonant inductor 226. Current flowing through primary winding 218 may induce current 248 to flow from ground 211, through transistor 244, secondary winding 220, and transistor 238 towards node Vₒᵤₜ_{_}_{ACX}. Transistors 238 and 248, therefore, may be on, in part, to reduce conduction losses, while transistors 240 and 242 may be off.

After a resonant period, current 246 may change polarity and ACX primary circuit 201 transitions to a second state with bidirectional switch 230 open and bidirectional switch 234 closed, as show in FIG. 2f. When current flowing through primary winding 218 flows in the opposite direction, current 248 may also change direction. Current 248, therefore, may flow from ground 211, through transistor 242, secondary winding 220, and transistor 240 towards node Vₒᵤₜ_{_}_{ACX}. Transistors 242 and 242, therefore, may be on, in part, to reduce conduction losses, while transistors 238 and 248 may be off. In an embodiment having bidirectional switches 230 and 234 switching at a switching frequency of 100 kHz, the resonant period is 10 μs, and the period of time spent in the state illustrated in FIG. 2e and the state illustrated in FIG. 2f lasts approximately half of that period (˜5 μs). The associated capacitor (e.g. capacitor 228) and inductor (e.g. inductor 226) value could follow approximately the formula of the resonant frequency of capacitor 228 (C) and inductor 226 (L):

$${f}_{sw} = \frac{1}{2 π \sqrt{LC}}$$

When the voltage of node Vᵢₙ_{_}_{ACX} is negative, ACX primary circuit 201 may be in the first state with bidirectional switch 230 closed and bidirectional switch 234 open, as shown in FIG. 2g. Current 246, therefore, may flow from primary ground 209, through resonant inductor 226, resonant capacitor 228, and bidirectional switch 230 towards capacitor Cᵢₙ. Current flowing through primary winding 218 may induce current 248 to flow from ground 211, through transistor 242, secondary winding 220, and transistor 240 towards node Vₒᵤₜ_{_}_{ACX}. Transistors 240 and 242, therefore, may be on, in part, to reduce conduction losses, while transistors 238 and 248 may be off.

After a resonant period, current 246 may change polarity and ACX primary circuit 201 transitions to a second state with bidirectional switch 230 open and bidirectional switch 234 closed, as show in FIG. 2h. When current flowing through primary winding 218 flows in the opposite direction, current 248 may also change direction. Current 248, therefore, may flow from ground 211, through transistor 244, secondary winding 220, and transistor 238 towards node Vₒᵤₜ_{_}_{ACX}. Transistors 238 and 244, therefore, may be on, in part, to reduce conduction losses, while transistors 242 and 240 may be off.

As shown in FIGS. 2e-2h, bidirectional switches 230 and 234 may switch at a constant frequency, which may be tuned with the resonant period the resonant tank including resonant capacitor 228 and resonant inductor 226. The current flow in ACX converter 208 may change polarity based on the polarity of the voltage of node Vᵢₙ_{_}_{ACX}. In other words, currents 246 and 248 may exhibit a 180° phase shift with respect to the switching of bidirectional switches 230 and 234 when the polarity of the voltage of node Vᵢₙ_{_}_{ACX} flips.

FIGS. 2i and 2j illustrate waveforms of ACX converter 208 during normal operation, according to an embodiment of the present invention. The waveforms of FIGS. 2i and 2j may be understood in view of FIGS. 2e-2h. In particular, the waveforms of FIGS. 2i and 2j relate to embodiments where AC power source 202 produces low-line AC signals. FIG. 2i illustrate waveforms when the voltage of node Vᵢₙ_{_}_{ACX} is near the most positive voltage while FIG. 2j illustrate waveforms when the voltage of node Vᵢₙ_{_}_{ACX} is near the most negative voltage.

FIGS. 2i and 2j include curves 250 and 252 of the voltage across bidirectional switches 230 and 234, respectively, curve 254 of the current flowing through resonant inductor 224, curve 256 of the current flowing through resonant inductor 226, curve 258 of the current flowing through primary winding 218, curve 260 of the current flowing through secondary winding 220 and signals S₂₃₀, S₂₃₄, S₂₃₈, S₂₄₀, S₂₄₂, and S₂₄₄ for driving bidirectional switches 230 and 234 and transistors 238, 240, 242 and 244, respectively.

As shown in FIG. 2i, when signal S₂₃₀ is high and signal S₂₃₄ is low, current flows flowing through resonant inductor 226 is positive, as shown by curve 256. Current flowing through secondary winding 220 is negative and also flows through transistors 238 and 244, which are turned on by signals S₂₃₈ and S₂₄₄. After a resonant period, the current flowing through resonant inductor 226 reaches zero. When the current flowing though resonant inductor 226 reaches zero, bidirectional switch 230 is open and bidirectional switch 234 is closed by signals S₂₃₀ and S₂₃₄, respectively. When bidirectional switch 230 is open and bidirectional switch 234 is closed, the current flowing through secondary winding 220 changes polarity and becomes positive while the current flowing through resonant inductor 226 changes polarity and becomes negative.

A similar behavior is observed when the voltage of node Vᵢₙ_{_}_{ACX} is negative. As shown in FIG. 2j, when signal S₂₃₀ is high and signal S₂₃₄ is low, current flowing through resonant inductor 226 is negative, as shown by curve 256. Current flowing through secondary winding 220 is positive and also flows through transistors 240 and 242, which are turned on by signals S₂₄₀ and S₂₄₂. After a resonant period, the current flowing through resonant inductor 226 reaches zero. When the current flowing though resonant inductor 226 reaches zero, bidirectional switch 230 is open and bidirectional switch 234 is closed by signals S₂₃₀ and S₂₃₄, respectively. When bidirectional switch 230 is open and bidirectional switch 234 is closed, the current flowing through secondary winding 220 changes polarity and becomes negative while the current flowing through resonant inductor 226 changes polarity and becomes positive.

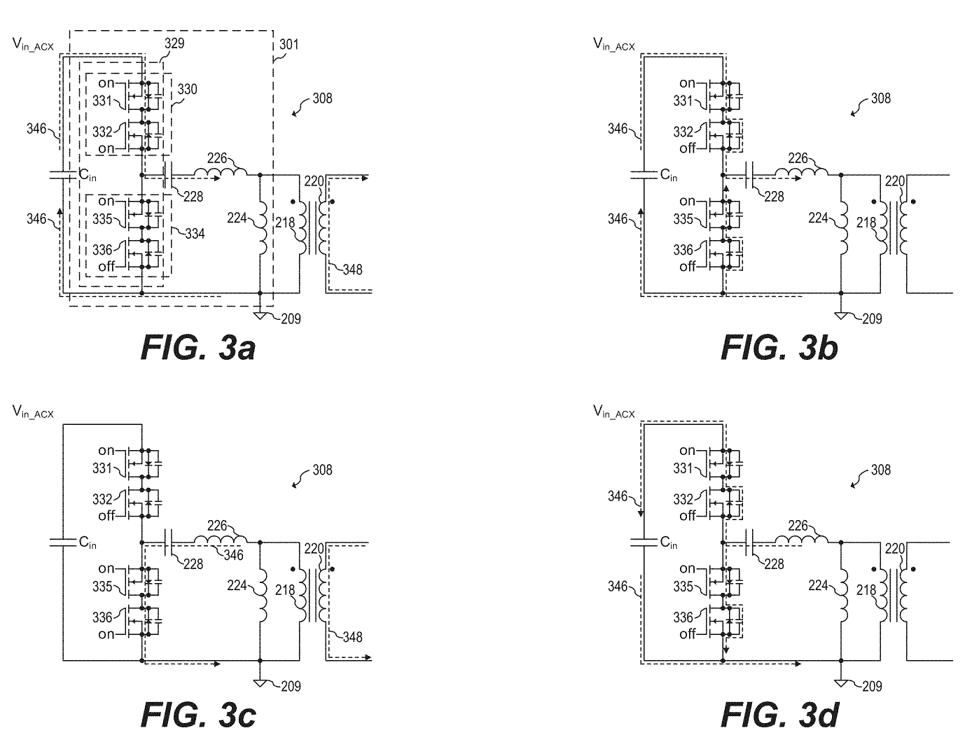

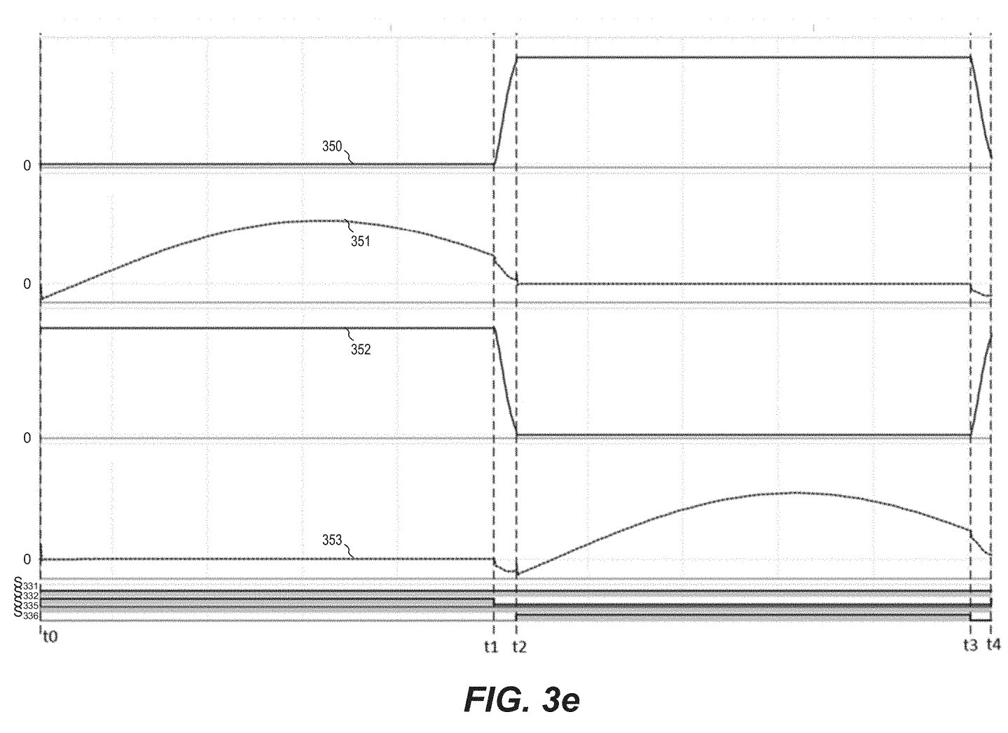

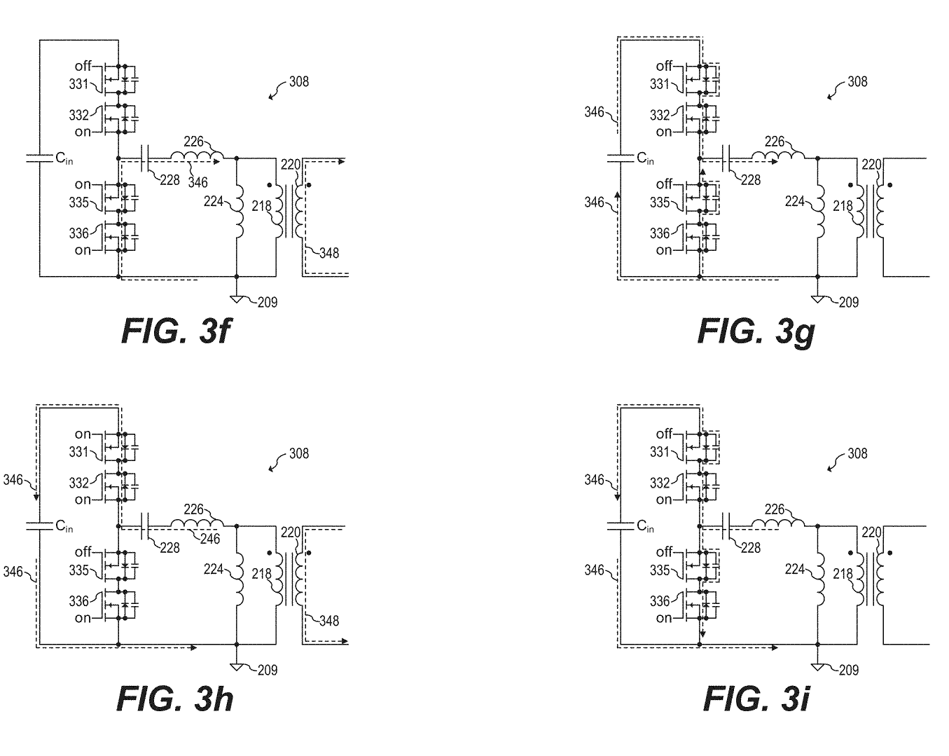

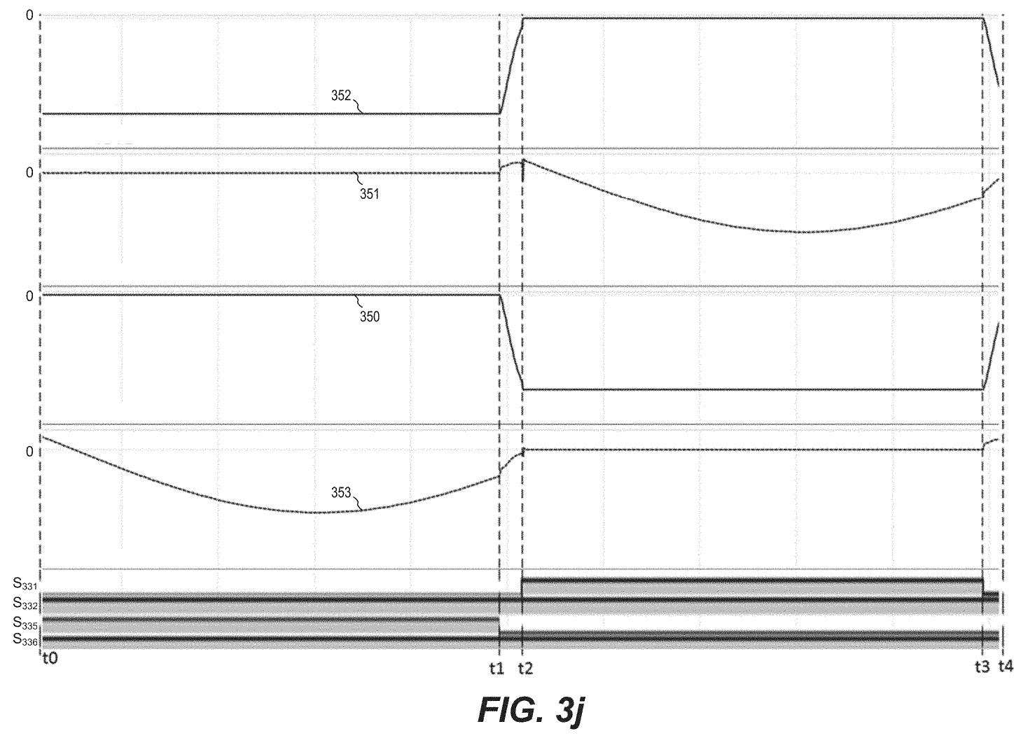

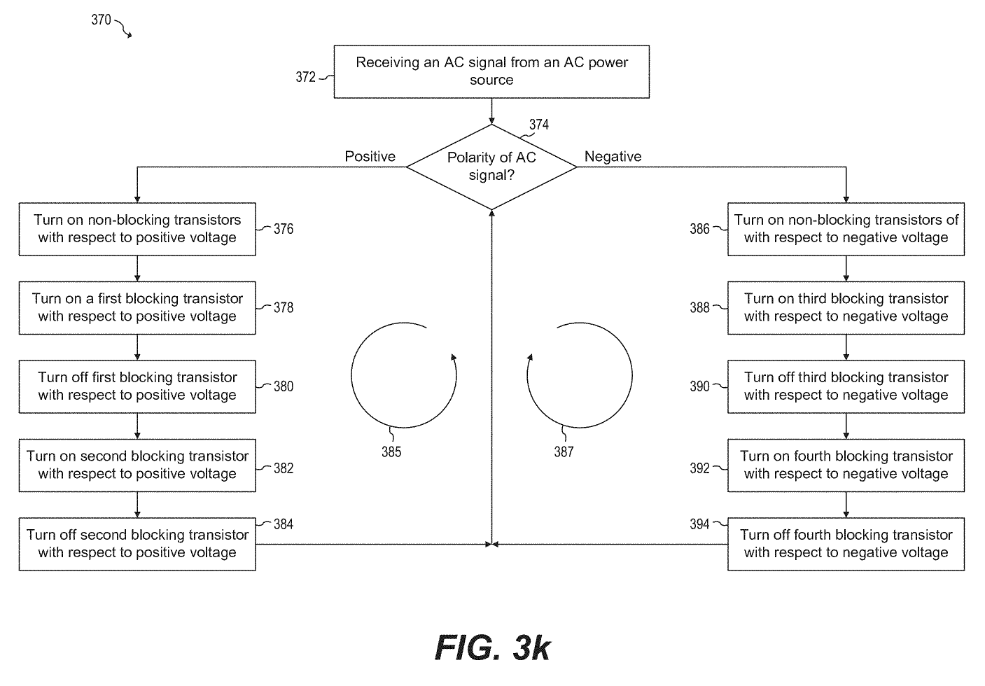

FIG. 2k illustrates a flow chart of embodiment method 271 of operating an ACX converter, according to an embodiment of the present invention. Method 271 may be implemented in ACX converter 208, but it may also be implemented in other ACX converter implementations, other circuit architectures and in other ways known in the art. For example, the ACX converters of FIGS. 3a, 4, 5a, 9a, 10a, 11a, 15a, 16a, 17, and 18 may implement method 271 of operating an ACX converter. The discussion that follows assumes that ACX converter 208, as illustrated in FIGS. 2a-2h, implements method 271 of operating an ACX converter.

The ACX converter receives an AC signal from an AC power source, such as AC power source 202 during step 273. The AC signal may be, for example, a high-line AC signal, also refereed as a high-line input voltage or high-line input, or a low-line AC signal, also referred as a low-line input voltage, or low-line input. During step 275, a half-bridge receiving the AC signal, such as half-bridge 229, switches with a constant frequency and a constant duty cycle. In particular, an upper bidirectional switch and a lower bidirectional switch of the half-bridge may switch with opposite phases at the constant frequency and constant duty cycle. The constant duty cycle may be 50% or lower. The duty cycle may be adjusted such that ZVS or QZVS is achieved. The constant frequency may be adjusted to be at or near a resonant frequency of a resonant tank coupled to the half-bridge. The resonant tank includes a resonant capacitor, such as resonant capacitor 228, and a first and second resonant inductors, such as resonant inductors 226 and 224 respectively. The resonant tank may be coupled to a primary winding of a transformer, such as primary winding 218 of transformer 216.

During step 277, the resonant tank is activated. In other words, the resonant tank is activated such that it resonates. Specifically, when the first bidirectional switch is closed and the second bidirectional switch is open, the resonant tank is exposed to the voltage of a first supply node, such as node Vᵢₙ_{_}_{ACX}, thereby inducing the flow of current on a first direction, and when the first bidirectional switch is open and the second bidirectional switch is closed, the resonant tank is exposed to the voltage of a second supply node, such as primary ground 209, thereby inducting current flowing in a second direction opposite the first direction.

When the voltage of the first supply node is higher than the voltage of the second supply node, the first bidirectional switch may be closed and the second bidirectional switch may be open, and current flows from the first supply node, through the resonant tank, and through the primary winding of the transformer, such as shown in FIG. 2e. After a resonant period, such as a resonant period of the resonant tank, the first bidirectional switch is open and the second bidirectional switch is closed, and the current flowing through the resonant tank changes polarity, such as shown in FIG. 2f.

When the voltage of the first supply node is lower than the voltage of the second supply node, the first bidirectional switch may be closed and the second bidirectional switch may be open and current flows from the resonant tank towards the first supply node, such as shown in FIG. 2g. After a resonant period, such as a resonant period of the resonant tank, the first bidirectional switch is open and the second bidirectional switch is closed, and the current flowing through the resonant tank changes polarity, such as shown in FIG. 2h.

As the current flowing through the primary winding of the transformer changes polarity, a current induced in a secondary winding of the transformer, such as secondary winding 220, also changes polarity, thereby producing an alternating voltage across the secondary winding. The alternating voltage of the secondary winding may be rectified with a rectifying circuit, such as, for example, ACX secondary circuit 203. The rectifying circuit may switch according to synchronous rectification techniques to produce a rectified voltage of an output node of the ACX converter, such as node Vₒᵤₜ_{_}_{ACX}. For example, ACX secondary circuit 203 may switch as shown in FIGS. 2e-2h and further illustrated in FIGS. 2i and 2j. It is understood ACX secondary circuit 203 may be implemented in other ways known in the art to produce a rectified voltage of the output of the ACX converter.

Advantages of embodiments of the present invention include that since the ACX converter is configured to operate with an AC signal, the ACX converter may operate without a rectifying bridge between the AC power source and the input of ACX converter. As an additional benefit, small input capacitor Cᵢₙ may be used since ACX converter may operate without controlling a ripple of the input voltage. The energy storage having capacitors with higher capacitance, therefore, may be implemented in energy storage stage 212. Since energy storage stage 212 is typically exposed to lower peak voltages than node Vᵢₙ_{_}_{ACX}, lower-rated capacitors may be used. Since capacitors rated at low voltages are generally smaller than capacitors rated at high voltages, the physical volume of converters implementing the ACX converter may be reduced. Some embodiments of the present invention, therefore, may have a smaller physical volume than systems that use a rectifying bridge where the energy storage is on the primary side.

Other advantages of embodiments of the present invention include that since bidirectional switches 230 and 234 switch at a constant frequency and duty cycle irrespective of the polarity of the voltage of node Vᵢₙ_{_}_{ACX}, the implementation of controller 245 may be simplified. The use of a fixed frequency may have the additional advantage of simplifying the implementation of EMI filter 204, which may be implemented to filter out the particular switching frequency of ACX converter 208. The relative high switching frequency of ACX converter 208 may also result in a smaller transformer implementation.

ACX converters may also be implemented with ZVS and QZVS. For example, FIGS. 3a-3j illustrate the operation of ACX primary circuit 301 of ACX converter 308 with ZVS, according to an embodiment of the present invention. As shown, for example, in FIG. 3a, ACX primary circuit 301 includes half-bridge 329, resonant capacitor 228, and resonant inductors 226 and 224. Half-bridge 329 includes bidirectional switches 330 and 334. Bidirectional switches 330 and 334 are implemented with switches 331 and 332, and 335 and 336 in a common-drain configuration, respectively.

FIGS. 3a-3d illustrate the operation of ACX primary circuit 301 when the voltage of node Vᵢₙ_{_}_{ACX} is higher than primary ground 209. Each of the FIGS. 3a-3d illustrates a different state of operation of ACX primary circuit 301. As shown in FIG. 3a, when the voltage of node Vᵢₙ_{_}_{ACX} is higher than primary ground 209, ACX primary circuit 301 may be in a state having transistors 331, 332 and 335 on, and transistor 336 off. Current 346, therefore, may flow from capacitor Cᵢₙ towards resonant capacitor 228 and resonant inductor 226. Current flowing through primary winding 218 may induce current 348 to flow in a first direction. A time after current 346 begins to flow as shown in FIG. 3a, transistor 332 is turned off, as shown in FIG. 3b. When transistor 332 is turned off, current 346 may discharge the drain-to-source (C_{ds}) capacitance of transistor 336, thereby reducing the V_{ds} of transistor 336. When the V_{ds} of transistor 336 is reduced, for example, to 0 V, transistor 336 is turned on with ZVS, as shown in FIG. 3c. When transistors 335 and 336 are on, current 346 flows from resonant capacitor 228 and resonant inductor 226 and through transistors 335 and 336, as shown in FIG. 3c. Since the current flowing through primary winding 218 changed polarity with respect to FIG. 3a, current 348 may also change polarity, and flow through secondary winding 220 in a second direction opposite the first direction. A time after transistor 336 is turned on, transistor 336 is turned off, as shown in FIG. 3d. When transistor 336 is turned off, current 346 may discharge the C_{ds} capacitance of transistor 332, thereby reducing the V_{ds} of transistor 332. When the V_{ds} of transistor 332 is reduced, for example, to 0 V, transistor 332 is turned on with ZVS, as shown in FIG. 3a, repeating the sequence.

FIG. 3e illustrates waveforms of ACX primary circuit 308 switching with ZVS when the input voltage has a positive polarity, according to an embodiment of the present invention. The waveforms of FIG. 3e may be understood in view of FIGS. 3a-3d. FIG. 3e includes curves 350 and 352 of the voltage across bidirectional switches 330 and 334, respectively, curves 351 and 353 of the current flowing through bidirectional switches 330 and 334, respectively, and signals S₃₃₁, S₃₃₂, S₃₃₅, and S₃₃₆ for driving transistors 331, 332, 335, and 336, respectively.

As shown in FIG. 3e, at time t₀ transistors 331, 332 and 335 are on while transistor 336 is off, which corresponds to FIG. 3a. During the time between t₀ and t₁, the voltage across bidirectional switch 330 is low, close to 0 V, while the voltage across bidirectional switch 334 is high, as shown by curves 350 and 352, respectively. During the time between t₀ and t₁, current flowing through bidirectional switch 330 increases, then peaks and then decreases according to a resonant period, as shown by curve 351. During the time between t₀ and t₁, there is no current flowing through bidirectional switch 334, as shown by curve 353. At time t₁, transistor 332 is turned off, which corresponds to FIG. 3b.

During the time between t₁ and t₂, the voltage across bidirectional switch 330 increases while the voltage across bidirectional switch 334 decreases, as shown by curves 350 and 352, respectively. At time t₂, therefore, transistor 336 may be turned on with ZVS, which corresponds to FIG. 3c.

During the time between t₂ and t₃, the voltage across bidirectional switch 334 is low, close to 0 V, while the voltage across bidirectional switch 330 is high, as shown by curves 352 and 350, respectively. During the time between t₂ and t₃, current flowing through bidirectional switch 334 increases, then peaks and then decreases according to a resonant period, as shown by curve 353, while there is no current flowing through bidirectional switch 330, as shown by curve 351. At time t₃, transistor 336 is turned off, which corresponds to FIG. 3d.

During the time between t₃ and t₄, the voltage across bidirectional switch 330 decreases while the voltage across bidirectional switch 334 increases, as shown by curves 350 and 352, respectively. At time t₄, therefore, transistor 332 may be turned on with ZVS, which corresponds to FIG. 3a, repeating the sequence.

FIGS. 3f-3i illustrate the operation of ACX primary circuit 301 when the voltage of node Vᵢₙ_{_}_{ACX} is lower than primary ground 209. As shown in FIG. 3f, when the voltage of node Vᵢₙ_{_}_{ACX} is lower than primary ground 209, transistors 332, 335 and 336 are on while transistor 331 is off. Current 346, therefore, may flow through bidirectional switch 334 towards resonant capacitor 228 and resonant inductor 226. Current flowing through primary winding 218 may induce current 348 to flow in the first direction. A time after current 346 begins to flow as shown in FIG. 3f, transistor 335 is turned off, as shown in FIG. 3g. When transistor 335 is turned off, current 346 may discharge the C_{ds} capacitance of transistor 331, thereby reducing the V_{ds} of transistor 331. When the V_{ds} of transistor 331 is reduced, for example, to 0 V, transistor 331 is turned on with ZVS, as shown in FIG. 3h. When transistors 331 and 332 are on, current 346 flows from resonant capacitor 228 and resonant inductor 226 and through transistors 331 and 332, as shown in FIG. 3h. Since the current flowing through primary winding 218 changed polarity with respect to FIG. 3f, current 348 may also change polarity, and flow through secondary winding 220 in the second direction opposite the first direction. A time after transistor 331 is turned on, transistor 331 is turned off, as shown in FIG. 3i. When transistor 331 is turned off, current 346 may discharge the C_{ds} capacitance of transistor 335, thereby reducing the V_{ds} of transistor 335. When the V_{ds} of transistor 335 is reduced, for example, to 0 V, transistor 335 is turned on with ZVS, as shown in FIG. 3e, repeating the sequence.

FIG. 3j illustrates waveforms of ACX primary circuit 308 switching with ZVS when the input voltage has a negative polarity, according to an embodiment of the present invention. The waveforms of FIG. 3j may be understood in view of FIGS. 3f-3i. FIG. 3j includes curves 350 and 352 of the voltage across bidirectional switches 330 and 334, respectively, curves 351 and 353 of the current flowing through bidirectional switches 330 and 334, respectively, and signals S₃₃₁, S₃₃₂, S₃₃₅, and S₃₃₆ for driving transistors 331, 332, 335, and 336, respectively.

As shown in FIG. 3j, at time t₀ transistors 332, 335 and 336 are on while transistor 331 is off, which corresponds to FIG. 3f. During the time between t₀ and t₁, the voltage across bidirectional switch 334 is low, close to 0 V, while the voltage across bidirectional switch 330 is high, as shown by curves 352 and 350, respectively. During the time between t₀ and t₁, current flowing through bidirectional switch 334 increases, then peaks and then decreases according to a resonant period, as shown by curve 353, while there is no current flowing through bidirectional switch 330, as shown by curve 351. At time t₁, transistor 335 is turned off, which corresponds to FIG. 3g.

During the time between t₁ and t₂, the voltage across bidirectional switch 330 decreases while the voltage across bidirectional switch 334 increases, as shown by curves 350 and 352, respectively. At time t₂, therefore, transistor 331 may be turned on with ZVS, which corresponds to FIG. 3h.

During the time between t₂ and t₃, the voltage across bidirectional switch 330 is low, close to 0 V, while the voltage across bidirectional switch 334 is high, as shown by curves 350 and 352, respectively. During the time between t₂ and t₃, current flowing through bidirectional switch 330 increases, then peaks and then decreases according to a resonant period, as shown by curve 351, while there is no current flowing through bidirectional switch 334, as shown by curve 353. At time t₃, transistor 331 is turned off, which corresponds to FIG. 3i.

During the time between t₃ and t₄, the voltage across bidirectional switch 334 decreases while the voltage across bidirectional switch 330 increases, as shown by curves 352 and 350, respectively. At time t₄, therefore, transistor 335 may be turned on with ZVS, which corresponds to FIG. 3f, repeating the sequence.

While ACX primary circuit 301 includes bidirectional switches 330 and 334 implemented with NMOS transistors in a back-to-back, common-drain configuration, it is understood that other transistor types and configurations are possible. For example, ACX primary circuit may be implemented with ZVS with any of the bidirectional switches shown in FIG. 2d. The control of the switching signals of the bidirectional switches may be changed to accommodate different configurations of bidirectional switches.

FIG. 3k illustrates a flow chart of embodiment method 370 of operating an ACX primary circuit with ZVS, according to an embodiment of the present invention. Method 370 may be implemented in ACX primary circuit 301, but it may also be implemented in other circuit architectures and in other ways known in the art. For example, the ACX converters of FIGS. 2a, 4, 5a, 9a, 10a, 11a, 15a, 16a, 17, and 18 may implement method 271 of operating an ACX converter. The discussion that follows assumes that ACX primary circuit 301, as illustrated in FIGS. 3a-3d and 3f-3i, implement method 370 of operating an ACX primary circuit with ZVS.

The ACX primary circuit receives an AC signal from an AC power source, such as AC power source 202 during step 372. The AC signal may be, for example, a high-line AC signal or a low-line AC signal. The polarity of the AC signal is determined during step 374. If the AC signal is positive, non-blocking transistors, such as transistors 331 and 335, are turned on during step 376. During step 378, a first blocking transistor, such as transistor 332, is turned on. As a result, current may flow through the first blocking transistor and a resonant tank, such as a resonant tank including resonant capacitor 228 and resonant inductor 226. During step 380 and a first time after the first blocking transistor is turned on, the first blocking transistor is turned off. The first time may be a time substantially similar to the resonant period of the resonant tank. Turning off the first blocking transistor may discharge a drain capacitance of a second blocking transistor, such as transistors 336 as well as cause the current flowing through the resonant tank to change polarity. During step 382 and a second time after turning off the first blocking transistor, the second blocking transistor may be turned on. Since the drain capacitance of the second transistor is reduced, for example, to 0 V, the second blocking transistor may turn on with ZVS during step 382. During step 384 and a third time after turning on the second blocking transistor, the second blocking transistor may be turned off. The third time may be substantially similar to the first time. Turning off the second blocking transistor may discharge a drain capacitance of the first blocking transistor as well as cause the current flowing through the resonant tank to change polarity. The polarity of the AC signal is checked during step 374. If the polarity of the AC signal continues to be positive, step 376 may be skipped and the first blocking transistor may be turned on during step 378, repeating the sequence. Since the drain capacitance of the first blocking transistor is reduced, for example, to 0 V, the first blocking transistor may be turned on with ZVS during step 378. The sequence of steps including 378, 380, 382, and 384 correspond to loop 385. Since the switching frequency of the blocking transistors is higher than the mains frequency, it is understood that loop 385 may be executed several times consecutively.

The determination of which transistors are non-blocking transistors may depend on the polarity of the AC signal as well as on the configuration of the bidirectional switch. For example, for a positive AC signal, the non-blocking transistors of ACX primary circuit 301 are transistors 331 and 335 and the blocking transistors of ACX primary circuit 301 are transistors 332 and 336. For a negative AC signal, the non-blocking transistors of ACX primary circuit 301 are transistors are 332 and 336 and the blocking transistors of ACX primary circuit 301 are transistors 331 and 335. A person skilled in the art would be able to determine which transistors of the bidirectional switch are the blocking and non-blocking transistors depending on the polarity of the AC signal and the implementation of the bidirectional switch.

If the AC signal is negative, non-blocking transistors, such as transistors 332 and 336, are turned on during step 376. During step 386, a third blocking transistor, such as transistor 335, is turned on. As a result, current may flow through the third blocking transistor and the resonant tank. During step 388 and a fourth time after the third blocking transistor is turned on, the fourth blocking transistor is turned off. The fourth time may be substantially similar to the first time. Turning off the third blocking transistor may discharge a drain capacitance of a fourth blocking transistor, such as transistors 331 as well as cause the current flowing through the resonant tank to change polarity. During step 390 and a fifth time after turning off the third blocking transistor, the fourth blocking transistor may be turned on. Since the drain capacitance of the fourth transistor is reduced, for example, to 0 V, the fourth blocking transistor may turn on with ZVS during step 382. During step 392 and a sixth time after turning on the fourth blocking transistor, the fourth blocking transistor may be turned off. The sixth time may be substantially similar to the first time. Turning off the fourth blocking transistor may discharge a drain capacitance of the third blocking transistor as well as cause the current flowing through the resonant tank to change polarity. The polarity of the AC signal is checked during step 374. If the polarity of the AC signal continues to be negative, step 386 may be skipped and the third blocking transistor may be turned on during step 388, repeating the sequence. Since the drain capacitance of the third blocking transistor is reduced, for example, to 0 V, the third blocking transistor may be turned on with ZVS during step 378. The sequence of steps including 388, 390, 392, and 394 correspond to loop 387. Since the switching frequency of the blocking transistors is higher than the mains frequency, it is understood that loop 387 may be executed several times consecutively.

Advantages of some embodiments of the present invention include an increase efficiency resulting from the ACX converter switching with ZVS or QZVS in both the ACX primary circuit and the ACX secondary circuit. Since the non-blocking transistor may not switch during a first polarity of the AC signal, the switching of ACX primary circuit may be simplified, with, for example, only two transistor switching at the ACX switching frequency.

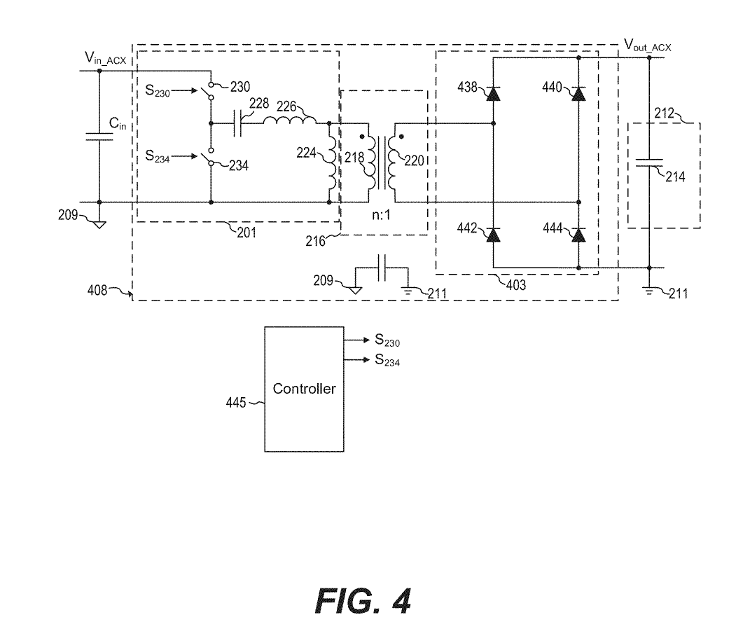

In addition to an ACX converter operating at fixed frequency and duty cycle, control of the ACX converter may be further simplified. For example, FIG. 4 shows ACX converter 408, according to an embodiment of the present invention. ACX converter 408 includes ACX primary circuit 201, transformer 216, ACX secondary circuit 403, and controller 445. Transformer 216 includes primary winding 218 and secondary winding 220 in an n:1 ratio. ACX secondary circuit 403 includes diodes 438, 440, 442, and 444.

ACX converter 408 may operate in a similar manner as ACX converter 208. ACX converter 408, however, uses diodes 438, 440, 442, and 444 instead of transistors 238, 240, 242, and 244 for rectification purposes.

In the embodiment of FIG. 4, energy may be transferred from the primary side of transformer 216 to the secondary side of transformer 216 when the absolute value of the voltage of node Vᵢₙ_{_}_{ACX} is higher than the voltage node Vₒᵤₜ_{_}_{ACX}, adjusted by the turn ratio of transformer 216. Specifically, energy may be transferred from the primary side of transformer 216 to the secondary side of transformer 216 when

|Vᵢₙ_{_}_{ACX}|>2·n·Vₒᵤₜ_{_}_{ACX} (1)

where n is the turn ratio of transformer 216. In some embodiments, n is equal to 2. Other values of n may be used. Equation 1 is also referred to as the forward energy transfer rule. When Equation 1 is true, the forward energy transfer condition is satisfied and energy is transferred from the primary side of the transformer to the secondary side of the transformer. When Equation 1 is false, the forward energy transfer condition is not satisfied. When the forward energy transfer condition is not satisfied, diodes 438, 440, 442, and 444 may prevent transfer of energy from the secondary side of the transformer back to the primary side of the transformer.

Controller 445 is configured to produce signals S₂₃₀, S₂₃₄, to drive bidirectional switches 230 and 234, respectively. As described above with respect to ACX converters 208 and 308, signals S₂₃₀ and S₂₄₀ may include additional signals for driving internal transistors of the bidirectional switches and may be configured to switch bidirectional switches 230 and 234 with ZVS. Controller 445, therefore, may produce signals S₂₃₀ and S₂₃₄ in open loop. In other words, controller 445 may control ACX converter 408 without sensing signals of ACX converter 408.

When the ACX secondary circuit is implemented with transistors, the transistors of the ACX secondary circuit may be turned on to reduce conduction losses when the forward energy transfer condition is satisfied. The transistors of the ACX secondary circuit may be turned off to prevent energy from transferring from the secondary side of the transformer to the primary side of the transformer when the forward energy transfer condition is not satisfied. For example, FIGS. 5a and 5b illustrate a schematic diagram and waveforms of ACX converter 508 when operating with a first mode of control, according to an embodiment of the present invention. As shown in FIG. 5a. ACX converter 508 includes ACX primary circuit 201, transformer 216, ACX secondary circuit 203, controller 545, and current sensor 543.

ACX converter 508 may operate in a similar manner as ACX converter 408. ACX converter 508, however, uses transistors 238, 240, 242, and 244 instead of diodes 438, 440, 442, and 444 for rectification purposes.

To prevent energy transfer from the secondary side of transformer 216 to the primary side of transformer 216, controller 545 may turn off transistors 238, 240, 242, and 244 when the forward energy transfer condition is not satisfied. In other words, controller 545 may start switching transistors 238, 240, 242, and 244 according to synchronous rectification techniques when the forward energy transfer condition is satisfied and turn off transistors 238, 240, 242, and 244 when the forward energy transfer condition is not satisfied.

To determine when to start switching transistors 238, 240, 242, and 244, controller 545 may sense when the current flowing through the body diodes of transistors 238, 240, 242, or 244 becomes positive. One way to detect when the current flowing through the body diodes of transistors 238, 240, 242, or 244 becomes positive is to monitor a current flowing towards node Vₒᵤₜ_{_}_{ACX} with current sensor 543. Controller 545, therefore, may begin switching transistors 238, 240, 242, and 244 according to synchronous rectification techniques when the current flowing through current sensor 543 becomes positive.

To determine when to stop switching transistors 238, 240, 242, and 244, controller 545 may sense the voltage at node Vₒᵤₜ_{_}_{ACX} and turn off transistors 238, 240, 242, and 244 when the voltage of node Vₒᵤₜ_{_}_{ACX} reaches a peak value. The determination of the peak value may be performed with a peak detector (not shown).

Current sensor 543 may be implemented according to various ways known in the art. For example, an analog-to-digital converter (ADC) may be used to sense a voltage across a sense resistor to determine the current. Other circuits and methods may be used to implement current sensor 543.

Controller 545 may be coupled to current sensor 543 and node Vₒᵤₜ_{_}_{ACX} according to various ways known in the art. For example, opto-couplers may be used for coupling purposes to electrically isolate the controller from other parts of the circuit. Alternatively, controller 545 may be electrically isolated in other ways known in art. Other embodiments may couple controller 545 to current sensor 543 and node Vₒᵤₜ_{_}_{ACX} with a direct electrical connection.

FIG. 5b illustrates waveforms of ACX converter 508 when operating with a first mode of control, according to an embodiment of the present invention. FIG. 5b includes curves 250 and 252 of the voltage across bidirectional switches 230 and 234, respectively, curve 256 of the current flowing through resonant inductor 226, curve 264 of the voltage of node Vₒᵤₜ_{_}_{ACX}, curve 266 of the absolute value of the voltage of node Vᵢₙ_{_}_{ACX}, curve 262 of the voltage of node Vₒᵤₜ_{_}_{ACX} times 2 times the turn ratio of transformer 216 (2·n·Vₒᵤₜ_{_}_{ACX}), and signals S₂₃₀, S₂₃₄, S₂₃₈, S₂₄₀, S₂₄₂, and S₂₄₄ for driving bidirectional switches 230 and 234 and transistors 238, 240, 242 and 244, respectively.

The waveforms of FIG. 5b may be understood in view of the waveforms of FIGS. 2i and 2j. In particular, FIG. 5b illustrates waveforms over a full period of the AC signal of node Vᵢₙ_{_}_{ACX}. Since bidirectional switches 230 and 234 switch at frequencies substantially higher than the frequency of the AC signal, curves 250 and 252 may not be distinguishable from each other in FIG. 5b. As shown in FIG. 5b, signals S₂₃₀ and S₂₃₄ are continuously switching. Transistors 238, 240, 242, and 244 turn on and off when the forward energy transfer condition is satisfied. In particular, transistors 238, 240, 242, and 244 begin switching when the forward energy transfer condition is satisfied, as shown by curves 262 and 264 in time t₁ and t₄, and stop switching when the voltage of node Vᵢₙ_{_}_{ACX} peaks, as shown by curve 266 in times t₂ and t₃.

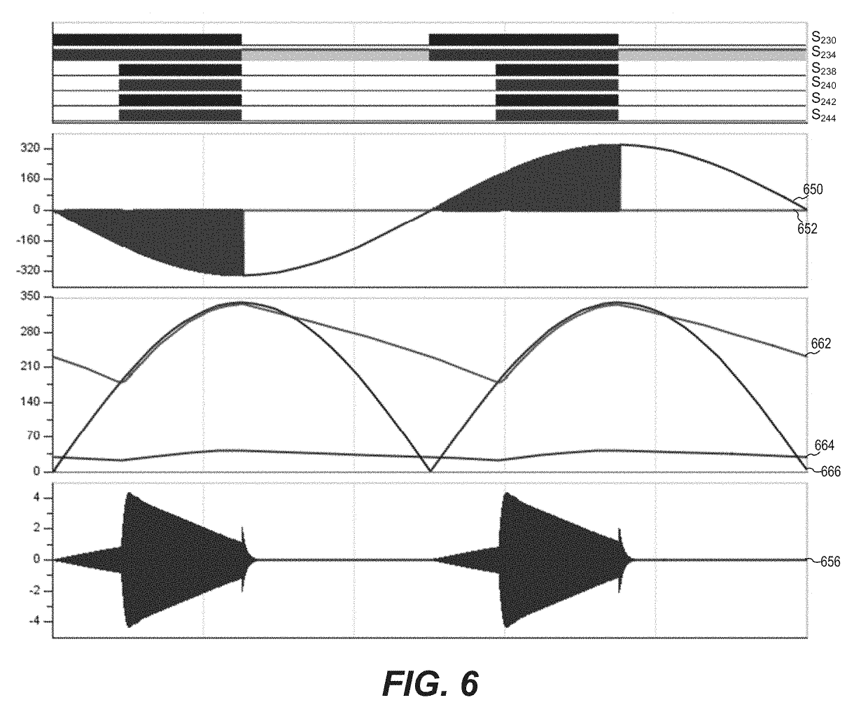

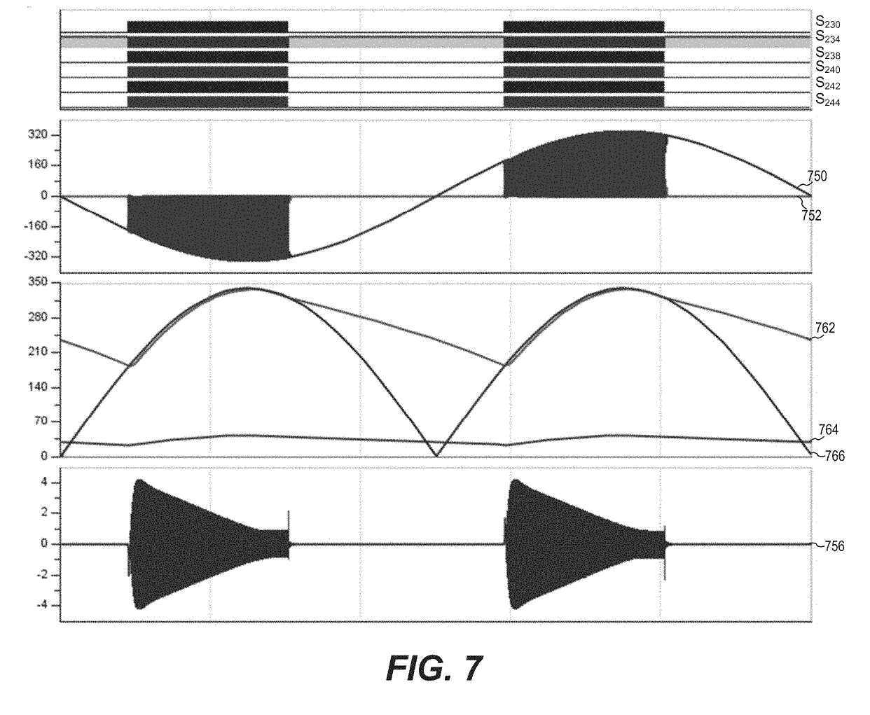

As shown in FIG. 5b, ACX converter 508 continuously switches bidirectional switches 230 and 234 during the full period of the AC signal of node Vᵢₙ_{_}_{ACX}. The transistors of ACX secondary circuit 203 switch during portions of the period when the forward energy transfer condition is satisfied. Some embodiments may stop switching bidirectional switches 230 and 234 during period of times, as shown, for example, in the embodiments of FIGS. 6-8. Some embodiments may switch the transistors of ACX secondary circuit 203 continuously when the forward energy transfer condition is satisfied, as shown, for example, in the embodiment of FIG. 7. Embodiments switching the transistors of ACX secondary circuit 203 during different times when the forward energy transfer condition is satisfied are also possible. For example, FIGS. 6-8 illustrate waveforms of various ACX converters utilizing various modes of control, according to various embodiments of the present invention.

FIG. 6 illustrates a waveform diagram of an ACX converter when operating with a second mode of control, according to an embodiment of the present invention. The waveforms of FIG. 6 may be understood, for example, in view of ACX converter 208 or 508. FIG. 6 includes curves 650 and 652 of the voltage across bidirectional switches 230 and 234, respectively, curve 656 of the current flowing through resonant inductor 226, curve 664 of the voltage of node Vₒᵤₜ_{_}_{ACX}, curve 666 of the absolute value of the voltage of node Vᵢₙ_{_}_{ACX}, curve 662 of the voltage of node Vₒᵤₜ_{_}_{ACX} times 2 times the turn ratio of transformer 216 (2·n·Vₒᵤₜ_{_}_{ACX}), and signals S₂₃₀, S₂₃₄, S₂₃₈, S₂₄₀, S₂₄₂, and S₂₄₄ for driving bidirectional switches 230 and 234 and transistors 238, 240, 242 and 244, respectively.

As shown in FIG. 6, bidirectional switches 230 and 234 begin switching when the AC signal of node Vᵢₙ_{_}_{ACX} has a zero-crossing and stops switching the AC signal of node Vᵢₙ_{_}_{ACX} peaks. During times when bidirectional switches 230 and 234 are not switching, bidirectional switch 230 may be off while bidirectional switch 234 may be on, as shown signals S₂₃₀ and S₂₃₄, and reflected by curves 650 and 652, respectively. Keeping bidirectional switch 234 on may clamp a voltage across resonant tank as may provide a path for current to flow.

By avoiding switching bidirectional switches during times where there is no energy transfer from the primary side of transformer 216 to the secondary since of transformer 216, efficiency of the ACX converter may be increased. Specifically, some of the switching losses associated with the switching of the bidirectional switches may be avoided without substantially impacting the energy delivery.

Detecting the start time and stop time for driving bidirectional switches 230 and 234 may be performed according to various ways known in the art. For example, the start time may be detected by monitoring the voltage of node Vᵢₙ_{_}_{ACX} and detecting the zero crossing. The stop time may be determined by monitoring the voltage of node Vᵢₙ_{_}_{ACX} and detecting the peak voltage of node Vᵢₙ_{_}_{ACX}. Alternatively, an ACX converter may determine the frequency of the AC signal of node Vᵢₙ_{_}_{ACX} and use a timer that counts from the time the zero crossing is detected to determine when to stop switching bidirectional switches 230 and 234. Other methods known in the art may be used.

FIG. 7 illustrates a waveform diagram of an ACX converter when operating with a third mode of control, according to an embodiment of the present invention. The waveforms of FIG. 7 may be understood, for example, in view of ACX converter 208 or 508. FIG. 7 includes curves 750 and 752 of the voltage across bidirectional switches 230 and 234, respectively, curve 756 of the current flowing through resonant inductor 226, curve 764 of the voltage of node Vₒᵤₜ_{_}_{ACX}, curve 766 of the absolute value of the voltage of node Vᵢₙ_{_}_{ACX}, curve 762 of the voltage of node Vₒᵤₜ_{_}_{ACX} times 2 times the turn ratio of transformer 216 (2·n·Vₒᵤₜ_{_}_{ACX}), and signals S₂₃₀, S₂₃₄, S₂₃₈, S₂₄₀, S₂₄₂, and S₂₄₄ for driving bidirectional switches 230 and 234 and transistors 238, 240, 242 and 244, respectively.

As shown in FIG. 7, bidirectional switches 230 and 234 begin switching when the forward energy transfer condition is satisfied and stop switching when the forward energy transfer condition is not satisfied. Similarly, the transistors of ACX secondary circuit 203 begin switching when the forward energy transfer condition is satisfied and stop switching when the forward energy transfer condition is not satisfied.

Detecting the start time and stop time for driving bidirectional switches 230 and 234 may be performed according to various ways known in the art. For example, the start time may be detected by monitoring the voltage of node Vᵢₙ_{_}_{ACX} and comparing it with the voltage of node Vₒᵤₜ_{_}_{ACX} to determine when the forward energy transfer condition is satisfied. Other methods known in the art may be used.

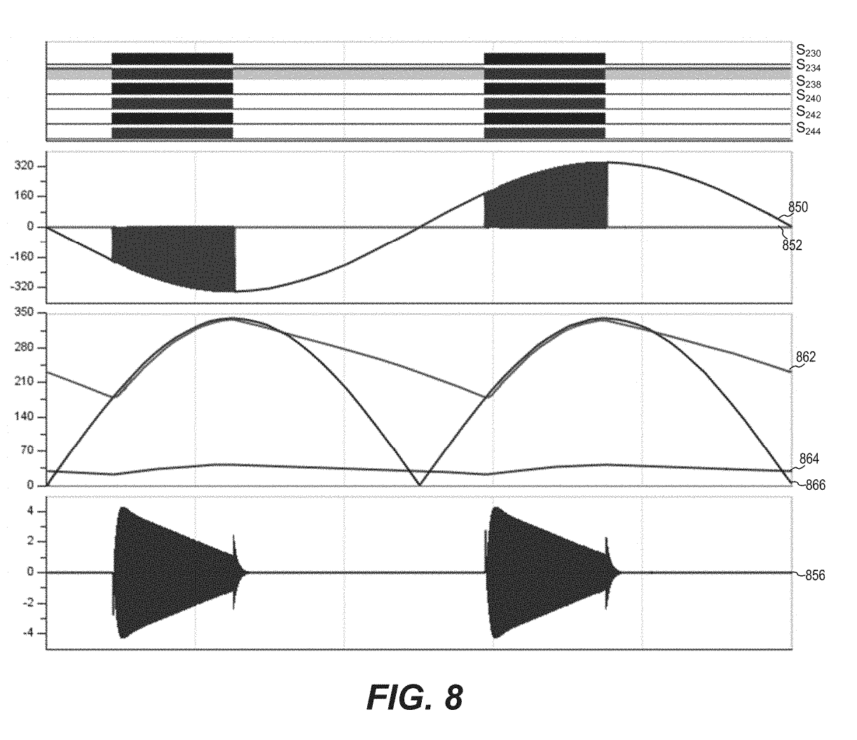

FIG. 8 illustrates a waveform diagram of an ACX converter when operating with a fourth mode of control, according to an embodiment of the present invention. The waveforms of FIG. 8 may be understood, for example, in view of ACX converter 208 or 508. FIG. 8 includes curves 850 and 852 of the voltage across bidirectional switches 230 and 234, respectively, curve 856 of the current flowing through resonant inductor 226, curve 864 of the voltage of node Vₒᵤₜ_{_}_{ACX}, curve 866 of the absolute value of the voltage of node Vᵢₙ_{_}_{ACX}, curve 862 of the voltage of node Vₒᵤₜ_{_}_{ACX} times 2 times the turn ratio of transformer 216 (2·n·Vₒᵤₜ_{_}_{ACX}), and signals S₂₃₀, S₂₃₄, S₂₃₈, S₂₄₀, S₂₄₂, and S₂₄₄ for driving bidirectional switches 230 and 234 and transistors 238, 240, 242 and 244, respectively.

As shown in FIG. 8, bidirectional switches 230 and 234 begin switching when the forward energy transfer condition is satisfied and stop switching when the voltage at node Vᵢₙ_{_}_{ACX} peaks. Similarly, the transistors of ACX secondary circuit 203 begin switching when the forward energy transfer condition is satisfied and stop switching when the voltage at node Vᵢₙ_{_}_{ACX} peaks. In some embodiments, operating the ACX converter with the fourth mode of control may result in a higher voltage at node Vₒᵤₜ_{_}_{ACX} compared to using the third mode of control.

The ACX secondary circuit may be implemented in various topologies. For example, FIG. 9a shows ACX converter 908, according to another embodiment of the present invention. ACX converter 908 includes ACX primary circuit 201, transformer 916, ACX secondary circuit 903, and controller 945. Transformer 916 includes primary winding 218, upper secondary winding 921 and lower secondary winding 922. ACX secondary circuit 903 includes transistors 938, and 940.

ACX converter 908 may operate in a similar manner as ACX converter 208 and may implement method 271 of operating an ACX converter. ACX converter 908 may also implement ZVS and method 370 of operating an ACX primary circuit with ZVS. ACX converter 908, however, implements ACX secondary circuit 908 with a center-tap topology instead of the full-bridge topology of ACX secondary circuit 208. Controller 945 may be adapted accordingly.

FIGS. 9b-9e illustrate the switching and current behavior of ACX converter 908, according to an embodiment of the present invention. In particular, FIGS. 9b and 9c correspond to current and switching behavior when the voltage of node Vᵢₙ_{_}_{ACX} is positive and FIGS. 9d and 9e correspond to current and switching behavior when the voltage of node Vᵢₙ_{_}_{ACX} is negative. As shown in FIGS. 9b-9e, the switching and operation of ACX primary circuit 203 of ACX converter 908 is similar to that of ACX converter 208, as illustrated by FIGS. 2e-2h.

As shown in FIG. 9b, when the voltage of node Vᵢₙ_{_}_{ACX} is positive, bidirectional switch 230 is closed and bidirectional switch 234 is open. Current 246, therefore, may flow from capacitor Cᵢₙ towards resonant capacitor 228 and resonant inductor 226. Current flowing through primary winding 218 may induce current 948 to flow from ground 211, through transistor 940, and lower secondary winding 922 towards node Vₒᵤₜ_{_}_{ACX}. Transistor 940, therefore, may be on, in part, to reduce conduction losses, while transistor 938 may be off.

After a resonant period, current 246 may change polarity and bidirectional switch 230 is open and bidirectional switch 234 is closed, as show in FIG. 9c. When current flowing through primary winding 218 flows in the opposite direction, current 948 may change. Current 948, therefore, may flow from ground 211, through transistor 938, and secondary upper winding 921 towards node Vₒᵤₜ_{_}_{ACX}. Transistor 938, therefore, may be on, in part, to reduce conduction losses, while transistor 940 may be off.

When the voltage of node Vᵢₙ_{_}_{ACX} is negative, bidirectional switch 230 is closed and bidirectional switch 234 is open, as shown in FIG. 9d. Current 246, therefore, may flow from primary ground 209, through resonant inductor 226, resonant capacitor 228 and bidirectional switch 230 towards capacitor Cᵢₙ. Current flowing through primary winding 218 may induce current 948 to flow from ground 211, through transistor 938, and upper secondary winding 921 towards node Vₒᵤₜ_{_}_{ACX}. Transistor 938, therefore, may be on, in part, to reduce conduction losses, while transistor 940 may be off.

After a resonant period, current 246 may change polarity and bidirectional switch 230 is open and bidirectional switch 234 is closed, as show in FIG. 2h. When current flowing through primary winding 218 flows in the opposite direction, current 948 may change. Current 948, therefore, may flow from ground 211, through transistor 940, and lower secondary winding 922 towards node Vₒᵤₜ_{_}_{ACX}. Transistor 940, therefore, may be on, in part, to reduce conduction losses, while transistor 938 may be off.

ACX secondary circuit 903 may implement ZVS and may switch according to known synchronous rectification techniques. Some embodiments may implement ACX secondary circuit 903 with diodes instead of transistors 938 and 940. Other implementations and modifications are also possible.

FIG. 10a shows ACX converter 1008, according to another embodiment of the present invention. ACX converter 1008 includes ACX primary circuit 201, transformer 216, ACX secondary circuit 1003, and controller 1045. ACX secondary circuit 1003 includes transistors 1038, and 1040. ACX secondary circuit 1003 is coupled to energy storage 1012.

ACX converter 1008 may operate in a similar manner as ACX converter 208 and may implement method 271 of operating an ACX converter. ACX converter 1008 may also implement ZVS and method 370 of operating an ACX primary circuit with ZVS. ACX converter 1008, however, implements ACX secondary circuit 1008 with a half-bridge voltage doubler topology instead of the full-bridge topology of ACX secondary circuit 208. Controller 1045 may be adapted accordingly.

FIGS. 10b-10e illustrate the switching and current behavior of ACX converter 1008, according to an embodiment of the present invention. In particular, FIGS. 10b and 10c correspond to current and switching behavior when the voltage of node Vᵢₙ_{_}_{ACX} is positive and FIGS. 10d and 10e correspond to current and switching behavior when the voltage of node Vᵢₙ_{_}_{ACX} is negative. As shown in FIGS. 10b-10e, the switching and operation of ACX primary circuit 203 of ACX converter 1008 is similar to that of ACX converter 208, as illustrated by FIGS. 2e-2h.

As shown in FIG. 10b, when the voltage of node Vᵢₙ_{_}_{ACX} is positive, bidirectional switch 230 may be closed and bidirectional switch 234 may be open. Current 246, therefore, may flow from capacitor Cᵢₙ towards resonant capacitor 228 and resonant inductor 226. Current flowing through primary winding 218 may induce current 1048 to flow from node V_{mid}, through secondary winding 220, and transistor 1038 towards node Vₒᵤₜ_{_}_{ACX}. Transistor 1038, therefore, may be on, in part, to reduce conduction losses, while transistor 1040 may be off.

After a resonant period, current 246 may change polarity and bidirectional switch 230 may be open and bidirectional switch 234 may be closed, as show in FIG. 10c. When current flowing through primary winding 218 flows in the opposite direction, current 1048 may also change direction. Current 1048, therefore, may flow from ground 211 through transistor 1040, and secondary winding 220 towards node V_{mid}. Transistor 1040, therefore, may be on, in part, to reduce conduction losses, while transistor 1038 may be off.

When the voltage of node Vᵢₙ_{_}_{ACX} is negative, bidirectional switch 230 may be closed and bidirectional switch 234 may be open, as shown in FIG. 10d. Current 246, therefore, may flow from primary ground 209, through resonant inductor 226, resonant capacitor 228 and bidirectional switch 230 towards capacitor Cᵢₙ. Current flowing through primary winding 218 may induce current 1048 to flow from ground 211, through transistor 1040, and secondary winding 220 towards node V_{mid}. Transistor 1040, therefore, may be on, in part, to reduce conduction losses, while transistor 1038 may be off.

After a resonant period, current 246 may change polarity and bidirectional switch 230 may be open and bidirectional switch 234 may be closed, as show in FIG. 10e. When current flowing through primary winding 218 flows in the opposite direction, current 1048 may also change direction. Current 1048, therefore, may flow from node V_{mid}, through secondary winding 220, and transistor 1038 towards node Vₒᵤₜ_{_}_{ACX}. Transistor 1038, therefore, may be on, in part, to reduce conduction losses, while transistor 1040 may be off.

ACX secondary circuit 1003 may implement ZVS and may switch according to known synchronous rectification techniques. Some embodiments may implement ACX secondary circuit 1003 with diodes instead of transistors 1038 and 1040. Other implementations and modifications are also possible.

Referring back to FIG. 2a, any of the ACX converter implementations may be coupled to a DC-DC converter. The DC-DC converter may be implemented according to various ways known in the art. A person skilled in the art may modify and combine particular implementations of the ACX converter and the DC-DC converter when implementing a converter. For example, FIG. 11a shows converter 1100 using ACX converter 1108, according to an embodiment of the present invention. Converter 1100 includes ACX converter 1108, energy storage stage 1112, DC-DC converter 1122, and controller 1145. ACX converter 1108 includes ACX primary circuit 201, transformer 216 and ACX secondary circuit 1103. ACX secondary circuit 1103 includes transistors 1138, 1140, 1142, 1144 and bidirectional switches 1149 and 1151. Energy storage stage 1112 includes capacitors 1114 and 1115. DC-DC converter 1122 is implemented as a buck converter and includes transistors 1153 and 1155, inductor 1157 and capacitor 1159. Capacitor 1159 also serves as output capacitor Cₒᵤₜ.

During normal operation, ACX converter 1108 receives an AC signal at node Vᵢₙ_{_}_{ACX} and produces a rectified voltage at node Vₒᵤₜ_{_}_{ACX}. Energy storage stage 1112 stores energy and may also reduce the voltage ripple of node Vₒᵤₜ_{_}_{ACX}. DC-DC converter 1122 receives the rectified voltage of node Vₒᵤₜ_{_}_{ACX} and produces a regulated voltage at node Vₒᵤₜ. Since DC-DC converter 1122 is operating as a buck converter, the voltage of node Vₒᵤₜ may be lower than the voltage of node Vₒᵤₜ_{_}_{ACX}.

More particularly, ACX converter 1100 may be configured such that ACX converter 1100 operates with ACX secondary circuit 1103 switching in a full-bridge configuration when the AC signal of node Vᵢₙ_{_}_{ACX} is a high-line signal and in a voltage doubler configuration when the AC signal of node Vᵢₙ_{_}_{ACX} is a low-line signal. For example, when the AC signal of node Vᵢₙ_{_}_{ACX} is a high-line signal, bidirectional switch 1149 may be closed and bidirectional switch 1151 may be open. When bidirectional switch 1149 is closed and bidirectional switch 1151 is open, transistor 1138, 1140, 1142 and 144 may switch in a similar as ACX converter 208.

When the AC signal of node Vᵢₙ_{_}_{ACX} is a low-line signal, bidirectional switch 1149 may be open and bidirectional switch 1151 may be closed and transistors 1140 and 1144 may be off. When bidirectional switch 1149 is open, bidirectional switch 1151 is closed, and transistors 1140 and 144 are off, transistor 1138 and 1142 may switch in a similar manner as ACX converter 1008.

When the AC input is a high-line signal and bidirectional switch 1149 is closed and bidirectional switch 1151 is open, ACX converter 1108 charges capacitor 1114 in series with capacitor 1115. When the AC input is a low-line signal and bidirectional switch 1149 is open and bidirectional switch 1151 is closed, ACX converter 1108 charges capacitor 1114 and capacitor 1115 alternatively. When the AC input is a low-line signal, therefore, the voltage at node Vₒᵤₜ_{_}_{ACX} is the sum of the voltages across capacitors 1114 and 1115. DC-DC converter 1122, therefore, may receive similar voltage levels irrespective of whether the AC signal of node Vᵢₙ_{_}_{ACX} is a high-line signal or a low-line signal.

DC-DC converter 1122 may regulate the voltage of node Vₒᵤₜ to, for example, 20 V, 18 V, 12 V, 10 V, 5 V, 3.3 V, 1.8 V, 1.2 V, or 1 V. Other values may be used. DC-DC converter 1122 may be implemented according to various ways known in the art and may be configured to regulate the voltage while complying with a particular standard such as, for example, USB-PD.

Bidirectional switches 1149 and 1151 may be implemented according to various ways known in the art. For example, bidirectional switches 1149 and 1151 may be implemented with the topologies shown in FIGS. 2c and 2d.

Controller 1145 is configured to produce signals S₂₃₀, S₂₃₄, S₁₁₃₈, S₁₁₄₀, S₁₁₄₂, S₁₁₄₄, S₁₁₅₃, S₁₁₅₅, S₁₁₄₉, and S₁₁₅₁ to drive bidirectional switches 230 and 234, transistors 1138, 1140, 1142, 1144, 1153, and 1155, and bidirectional switches 1149 and 1151, respectively. Coupling controller 1145 to bidirectional switches 230 and 234, transistors 1138, 1140, 1142, 1144, 1153, and 1155, and bidirectional switches 1149 and 1151 may be achieved through direct electrical connection or indirect electrical connections. For example, opto-couplers may be used to electrically isolate controller 1145 from other parts of the circuit. Coupling between controller 1145 and other components of converter 1100 may also be achieved in other ways known in the art.

Controller 1145 may be implemented as a single chip. For example, controller 1145 may be implemented in a monolithic substrate. Alternatively, controller 1145 may be implemented as a collection of controllers, such as, for example, a controller for controlling ACX converter 1108, and a controller for controlling DC-DC converter 1122. Other implementations known in the art are also possible.

FIGS. 11b-11e illustrate the switching and current behavior of a ACX converter 1108, according to an embodiment of the present invention. In particular, FIGS. 11b and 11c correspond to current and switching behavior when the voltage of node Vᵢₙ_{_}_{ACX} corresponds to a high-line signal and is positive and FIGS. 11d and 11e correspond to current and switching behavior when the voltage of node Vᵢₙ_{_}_{ACX} corresponds to a low-line signal and is positive. For operation during negative input voltages, refer back to FIGS. 2g-2h, and 10d-10e. As shown in FIGS. 11b-11e, the switching and operation of ACX primary circuit 203 of ACX converter 1108 is similar to that of ACX converter 208, as illustrated by FIGS. 2e-2h.

As shown in FIG. 11b, when the voltage of node Vᵢₙ_{_}_{ACX} is a positive high-line voltage, bidirectional switch 230 may be closed and bidirectional switch may be open, and bidirectional switch 1149 may be closed and bidirectional switch 1151 may be open. Current 246, therefore, may flow from capacitor Cᵢₙ towards resonant capacitor 228 and resonant inductor 226. Current flowing through primary winding 218 may induce current 1148 to flow from ground 211, through transistor 1144, secondary winding 220, and transistor 1038 towards node Vₒᵤₜ_{_}_{ACX}. Transistors 1138 and 1144, therefore, may be on, in part, to reduce conduction losses, while transistors 1040 and 1042 may be off.

After a resonant period, current 246 may change polarity and bidirectional switch 230 may be open and bidirectional switch 234 may be closed, as show in FIG. 11c. When current flowing through primary winding 218 flows in the opposite direction, current 1148 may also change direction. Current 1148, therefore, may flow from ground 211 through transistor 1142, secondary winding 220 and transistor 1140 towards node Vₒᵤₜ_{_}_{ACX}. Transistors 1140 and 1142, therefore, may be on, in part, to reduce conduction losses, while transistors 1138 and 1144 may be off.

When the voltage of node Vᵢₙ_{_}_{ACX} is a positive low-line voltage, bidirectional switch 230 may be closed and bidirectional switch may be open, bidirectional switch 1149 may be open and bidirectional switch 1151 may be closed, and transistors 1140 and 1144 may be off, as shown in FIG. 11d. Current 246, therefore, may flow from Cᵢₙ, through bidirectional switch 230, resonant inductor 226 and resonant capacitor 228. Current flowing through primary winding 218 may induce current 1148 to flow from node V_{mid}, through secondary winding 220 and transistor 1138 towards node Vₒᵤₜ_{_}_{ACX}. Transistor 1138, therefore, may be on, in part, to reduce conduction losses, while transistor 1140 may be off.

After a resonant period, current 246 may change polarity and bidirectional switch 230 may be open and bidirectional switch 234 may be closed, as show in FIG. 11e. When current flowing through primary winding 218 flows in the opposite direction, current 1148 may also change direction. Current 1148, therefore, may flow from ground 211, through transistor 1142, and secondary winding 220 towards node V_{mid}. Transistor 1142, therefore, may be on, in part, to reduce conduction losses, while transistor 1138 may be off.

ACX secondary circuit 1103 may implement ZVS and may switch according to known synchronous rectification techniques. Some embodiments may implement ACX secondary circuit 1103 with diodes instead of transistors 1138, 1140, 1142 and 1144. Other implementations and modifications are also possible.

FIGS. 11f-11i illustrate waveforms of converter 1100 during normal operation using the fourth mode of control, according to an embodiment of the present invention. In particular, FIGS. 11f and 11g illustrate waveforms of converter 1100 delivering 65 W to load R_{load} with a voltage at node Vₒᵤₜ of 20 V, and with a high-line input signal (240 VAC/50 Hz) and a low-line input (120 VAC/60 Hz) signal, respectively. The waveforms of FIGS. 11f-11i may be understood in view of FIGS. 11a-11e. FIGS. 11f-11i include curves 1150 and 1152 of the voltage across bidirectional switches 230 and 234, respectively, curve 1164 of the voltage of node Vₒᵤₜ_{_}_{ACX}, curve 1165 of the voltage of node Vₒᵤₜ, and signals S₂₃₀, S₂₃₄, S₁₁₃₈, S₁₁₄₀, S₁₁₄₂, S₁₁₄₄, S₁₁₄₉, S₁₁₅₁, S₁₁₅₃ and S₁₁₅₅ for driving bidirectional switches 230 and 234, transistors 1138, 1140, 1142 and 1144, bidirectional switches 1149 and 1151, and transistors 1153 and 1155, respectively.

As shown in FIG. 11f, when the AC signal is a high-line signal, ACX converter 1108 operates in high-line mode with bidirectional switch 1149 closed and bidirectional switch 1151 open. Energy transfer from the primary side of transformer 216 to the secondary side of transistor 216 between times t₀ and t₁ and between times t₂ and t₃. In other words, the forward energy transfer period begins at time t₀ and ends at time t₁ and begins again at time t₂ and ends at time t₃.

Since transistors 1153 and 1155 of DC-DC converter 1122 operate continuously to deliver energy to load R_{load} at a regulated voltage, as shown by curve 1165, part of the energy stored in energy storage stage 1112 is delivered to the load. The voltage of node Vₒᵤₜ_{_}_{ACX}, therefore, may decrease during times when energy is not being transferred to the secondary side of transformer 216, such as between time t₁ and t₂, as shown by curve 1164. For example, the voltage of node Vₒᵤₜ_{_}_{ACX} may decrease from a peak voltage of about 43 V to a voltage of about 21 V.

When the AC signal is a low-line signal, ACX converter 1108 operates in low-line mode with bidirectional switch 1149 open, bidirectional switch 1151 closed and transistors 1140 and 1144 off, as shown in FIG. 11g. As shown by FIG. 11g, the voltage of node Vₒᵤₜ_{_}_{ACX} may decrease from a peak voltage of about 42 V to a voltage of about 24 V.

The capacitance of energy storage stage 1112 may be given by

$${C}_{1112} = \frac{2 \times {P}_{out} \times {t}_{d}}{{V}_{out\_ACX \_max}^{2} - {V}_{out\_ACX \_min}^{2}} \qquad ( 2 )$$

where Pₒᵤₜ is the maximum power of the converter, t_{d} is the discharge time, for example, as shown in FIG. 11f, and Vₒᵤₜ_{_}_{ACX}_{_}ₘₐₓ and Vₒᵤₜ_{_}_{ACX}_{_}ₘᵢₙ are the maximum and minimum voltage of node Vₒᵤₜ_{_}_{ACX}, respectively. As a person skilled in the aft may recognize, the capacitances of capacitors 1114, and 1115 may be twice the value given for C₁₁₁₂ by Equation 2.

Since when node Vᵢₙ_{_}_{ACX} node receives a low-line signal capacitors 1114 and 1115 are independently charged and when during high-line signals capacitors 1114 and 1115 are charged in series, the energy stored by capacitors 1114 and 1115 may be higher in low-line mode than in high-line mode. The minimum peak voltage of node Vₒᵤₜ_{_}_{ACX} when node Vᵢₙ_{_}_{ACX} node receives a low-line signal may be higher than when node Vᵢₙ_{_}_{ACX} receives a high-line signal. An additional benefit of operating in low-line mode is that switching losses may be lower than during high-line mode since transistors 1140 and 1144 do not switch during low-line mode.

FIGS. 11h and 11i illustrate waveforms of converter 1100 delivering power to R_{load} while receiving a high-line input signal (240 VAC/50 Hz), according to an embodiment of the present invention. FIG. 11h illustrates waveforms of converter 1100 delivering 6.5 W to load R_{load} with a voltage at node Vₒᵤₜ of 20 V. FIG. 11i illustrates waveforms of converter 1100 delivering 10 W to load R_{load} with a voltage at node Vₒᵤₜ of 5 V. As shown in FIGS. 11h and 11i, the duty cycle of energy delivery is smaller compared to a converter delivering 65 W. In various embodiments, multiple DC-DC converters (not shown), such as buck converters, may be connected in parallel, each receiving a voltage from node Vₒᵤₜ_{_}_{ACX} and delivering an output to multiple output nodes (not shown). Each of the DC-DC converters connected in parallel may be connected to a different load and may regulate its output to a different voltage. Other configuration may be used.

Advantages of some embodiments of the present invention include that the DC-DC converter may be optimized for a particular DC-DC input voltage irrespective of the mains voltage. Other advantages includes that operating with low-line input signal may result in an increase in efficiency.

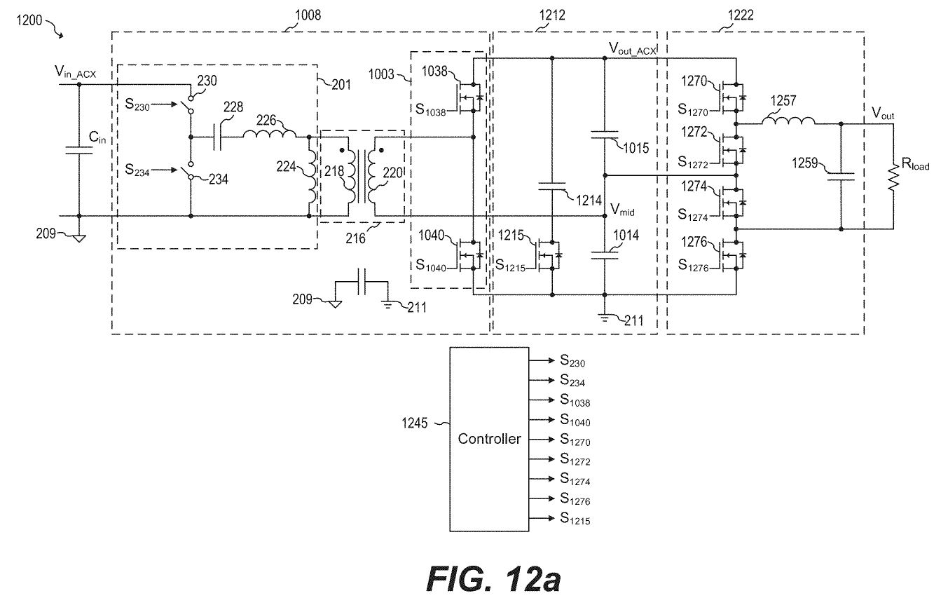

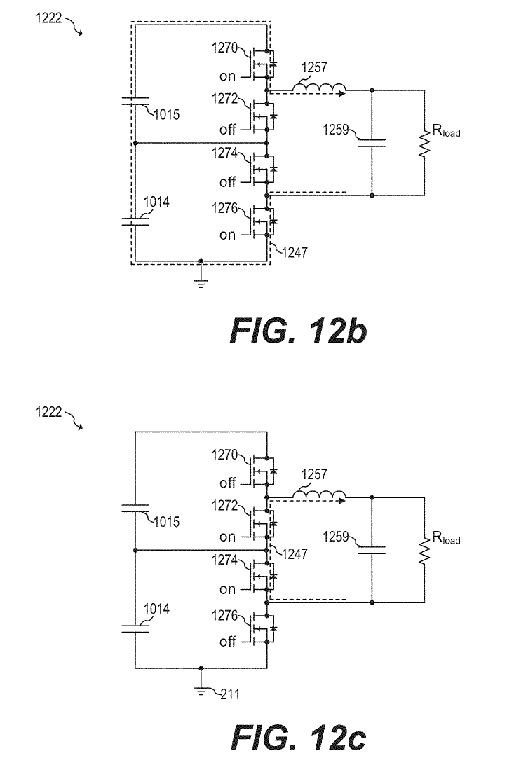

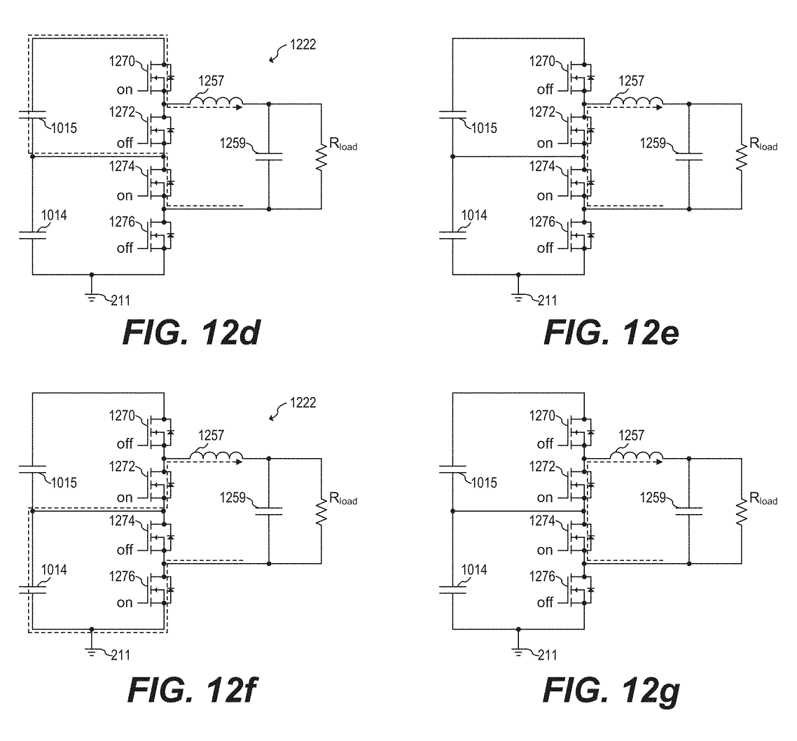

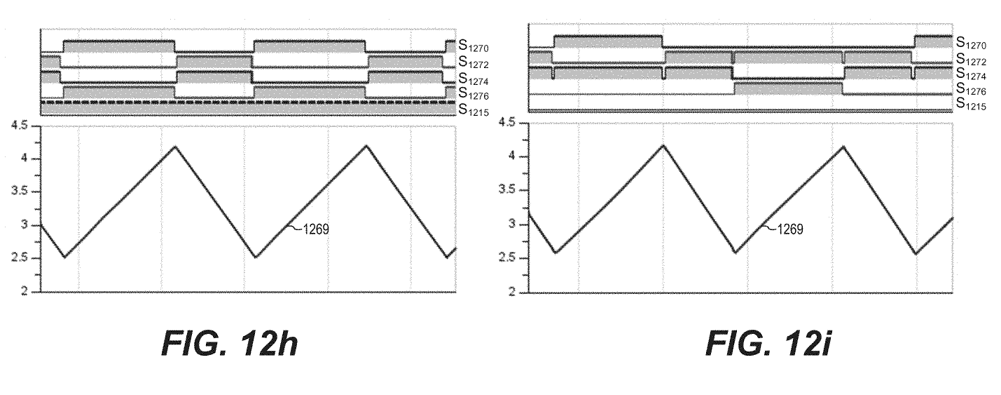

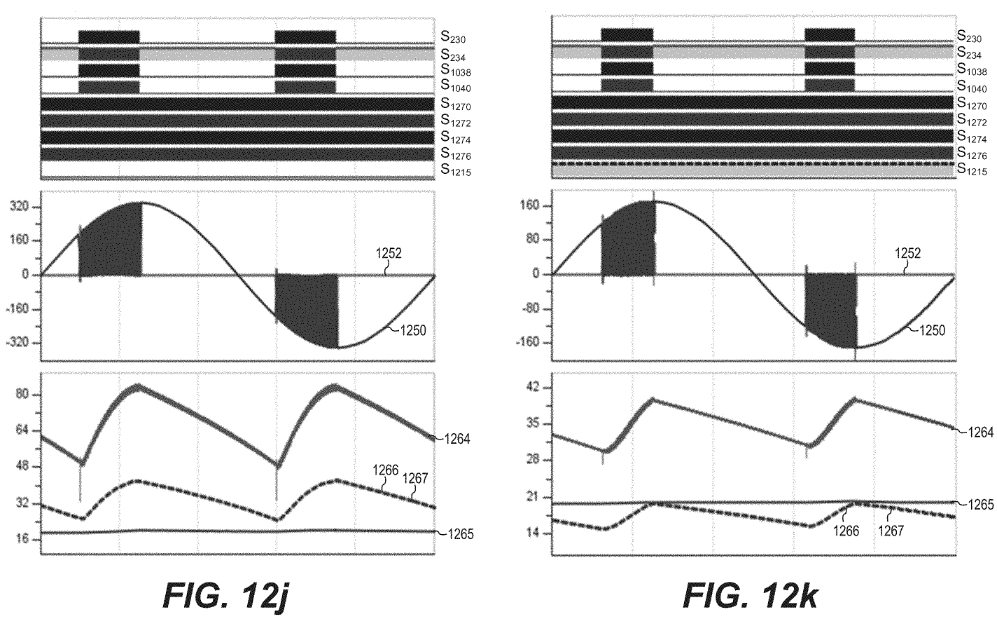

FIG. 12a shows converter 1200, according to an embodiment of the present invention. Converter 1200 includes ACX converter 1008, energy storage stage 1212, DC-DC converter 1222, and controller 1245. Energy storage stage 1212 includes capacitors 1014, 1015, and 1214 and transistor 1215. DC-DC converter 1222 is implemented as a cascaded buck converter and includes transistors 1270, 1272, 1274, and 1276, inductor 1257 and capacitor 1259. Capacitor 1259 also serves as output capacitor Cₒᵤₜ.

During normal operation, ACX converter 1008 receives an AC signal at node Vᵢₙ_{_}_{ACX} and produces a rectified voltage at node Vₒᵤₜ_{_}_{ACX}. Energy storage stage 1212 stores energy and may also reduce the voltage ripple of node Vₒᵤₜ_{_}_{ACX}. DC-DC converter 1222 receives the rectified voltage of node Vₒᵤₜ_{_}_{ACX} and produces a regulated voltage at node Vₒᵤₜ. ACX converter 1008 may operate, for example, as described with respect to FIGS. 10a-10e. For example, the operation of ACX converter 1008 may be the same with a low-line input or a high-line input.

Since the amount of energy stored in a capacitor is proportional to the voltage across the capacitor, energy storage stage 1212 may turn on transistors 1215 during a low-line input mode to increase the amount of capacitance available to, for example, double the amount. Alternatively, energy storage stage 1212 may be implemented without transistor 1215 and capacitor 1214.

DC-DC converter 1222 may be configured to switch in a high-line mode or low-line mode depending on the input that ACX converter 1008 receives. For example, when ACX converter 1008 receives a low-line input, the voltage of node Vₒᵤₜ_{_}_{ACX} may be, for example, about 35 V. DC-DC converter 1222, therefore, may transfer energy from capacitors 1014 and 1015, simultaneously, to load R_{load}. When ACX converter 1008 receives a high-line input, the voltage of node Vₒᵤₜ_{_}_{ACX} may be twice the voltage compared to the voltage when the ACX converter 1008 receives a low-line input. Therefore, DC-DC converter 1222 may transfer energy from either capacitor 1014 or 1015 and alternating cycle to cycle.

DC-DC converter 1222 may regulate the voltage of node Vₒᵤₜ, for example, to 20 V, 18 V, 12 V, 10 V, 5 V, 3.3 V, 1.8 V, 1.2 V, or 1V. Other values may be used. DC-DC converter 1222 may be implemented according to various ways known in the art and may be configured to regulate the voltage while complying with a particular standard such as, for example, USB-PD.

Controller 1245 is configured to produce signals S₂₃₀, S₂₃₄, S₁₀₃₈, S₁₀₄₀, S₁₂₇₀, S₁₂₇₂, S₁₂₇₄, S₁₂₇₆, and S₁₂₁₅ to drive bidirectional switches 230 and 234, transistors 1238, 1240, 1270, 1272, 1274, 1276, and 1215, respectively. Coupling controller 1245 to bidirectional switches 230 and 234, and transistors 1238, 1240, 1270, 1272, 1274, 1276 and 1215 may be achieved through direct electrical connection or indirect electrical connections. For example, opto-couplers may be used to electrically isolate controller 1245 from other parts of the circuit. Coupling between controller 1245 and other components of converter 1200 may also be achieved in other ways known in the art.

Controller 1245 may be implemented as a single chip. For example, controller 1245 may be implemented in a monolithic substrate. Alternatively, controller 1245 may be implemented as a collection of controllers, such as, for example, a controller for controlling ACX converter 1008 and energy storage stage 1212, and a controller for controlling DC-DC converter 1222. Other implementations known in the art are also possible.

FIGS. 12b-12g illustrate the switching and current behavior of DC-DC converter 1222, according to an embodiment of the present invention. In particular, FIGS. 12b and 12C correspond to current and switching behavior when the voltage of node Vᵢₙ_{_}_{ACX} corresponds to a low-line signal and FIGS. 12d-12g correspond to current and switching behavior when the voltage of node Vᵢₙ_{_}_{ACX} corresponds to a high-line signal.

As shown in FIG. 12b, when the AC signal of Vᵢₙ_{_}_{ACX} is a low-line signal, DC-DC converter 1222 may have a first state with transistors 1270 and 1276 on and transistors 1272 and 1274 off. The first state may be an energizing state. In the first state, current 1247 may flow from capacitors 1014 and 1015, through transistor 1270, inductor 1257, and transistor 1276 towards ground 211.

As shown in FIG. 12C, when Vᵢₙ_{_}_{ACX} is a low-line signal, DC-DC converter 1222 may have a second state with transistors 1270 and 1276 off and transistors 1272 and 1274 on. The second state may be a de-energizing state. In the second state, current 1247 may circulate through transistors 1274, and 1272 and inductor 1257. DC-DC converter 1222 may alternate between the first state and the second state to deliver power to load R_{load} when the AC signal of Vᵢₙ_{_}_{ACX} is a low-line signal.

As shown in FIG. 12d, when the AC signal of Vᵢₙ_{_}_{ACX} is a high-line signal, DC-DC converter 1222 may have a third state with transistors 1270 and 1274 on and transistors 1272 and 1276 off. The third state may be an energizing state. In the third state, current 1247 may flow from capacitor 1015, through transistor 1270, inductor 1257, and transistor 1274 towards capacitor 1015.

As shown in FIG. 12e, when Vᵢₙ_{_}_{ACX} is a high-line signal, DC-DC converter 1222 may transition to the second state after the third state. As shown in FIG. 12f, when the AC signal of Vᵢₙ_{_}_{ACX} is a high-line signal, DC-DC converter 1222 may have a fourth state with transistors 1272 and 1276 on and transistors 1270 and 1274 off. The fourth state may be an energizing state. In the fourth state, current 1247 may flow from capacitor 1014, through transistor 1272, inductor 1257, and transistor 1276 towards capacitor 1014. As shown in FIG. 12g, when the AC signal of Vᵢₙ_{_}_{ACX} is a high-line signal, DC-DC converter 1222 may transition to the second state after the fourth state.

As shown by FIGS. 12d-12g, DC-DC converter 1222 may go from a third state, then to a second state, then to the fourth state, then to the second state, then back to the third state, repeating the sequence, to deliver power to load R_{load} when Vᵢₙ_{_}_{ACX} is a high-line signal. A person skilled in the art may recognize that intermediate states may be used, for example, to achieve ZVS when switching transistors 1270, 1272, 1274 and 1276.

FIGS. 12h-12i illustrate waveforms of DC-DC converter 1222 switching at 500 kHz with ZVS, according to an embodiment of the present invention. In particular, FIGS. 12h and 12i illustrate waveforms of DC-DC converter 1222 delivering 65 W to load R_{load} with a low-line input signal (120 VAC/60 Hz) and a high-line input (240 VAC/50 Hz) signal, respectively. The waveforms of FIGS. 12h-12i may be understood in view of FIGS. 12a-12g. FIGS. 12h-12i include curve 1269 of the current flowing through inductor 1257, and signals S₁₂₇₀, S₁₂₇₂, S₁₂₇₄, S₁₂₇₆, and S₁₂₁₅ for driving transistors 1270, 1272, 1274, 1276, and 1215, respectively.

As shown in FIG. 12h, when the AC signal is a low-line signal, transistor 1215 is on and transistors 1270, 1272, 1274 and 1276 alternate between the first state and the second state. As shown in FIG. 12h there is a delay between signals S₁₂₇₀ and S₁₂₇₆ and S₁₂₇₂ and S₁₂₇₄ as they transition DC-DC converter 1222 transitions between the first and second states. The delay is used to allow for the drain capacitance of the transistors that are to be turned on to discharge. After the drain capacitances of the transistors that are to be turned on are discharged, the transistors may be turned on with ZVS.

During high-line signal, transistor 1215 is off and transistors 1270, 1272, 1274 and 1276 transition between the third state, second state, fourth state, second state and back to the third state, repeating the sequence. The delays between the switching signals as DC-DC converter 1222 transitions between states are used to allow for ZVS switching.

FIGS. 12j and 12k illustrate waveforms of converter 1200 delivering 65 W to load R_{load} with a voltage at node Vₒᵤₜ of 20 V, with a high-line input signal (240 VAC/50 Hz) and low-line input signal (120 VAC/60 Hz), respectively, and with a fourth mode of control, according to an embodiment of the present invention. FIGS. 12j and 12k include curves 1250 and 1252 of the voltage across bidirectional switches 230 and 234, respectively, curve 1264 of the voltage of node Vₒᵤₜ_{_}_{ACX}, curve 1265 of the voltage of node Vₒᵤₜ, curves 1266 and 1267 of the voltage across capacitors 1014 and 1015, respectively, and signals S₂₃₀, S₂₃₄, S₁₀₃₈, S₁₀₄₀, S₁₂₇₀, S₁₂₇₂, S₁₂₇₄, S₁₂₇₆, and S₁₂₁₅ for driving bidirectional switches 230 and 234, and transistors 1038, 1040, 1270, 1272, 1274, 1276, and 1215, respectively.

Advantages of some embodiments of the present invention include that the ACX secondary circuit may conduct a current through one switch at any time. Conduction losses, therefore, may be smaller than in other embodiments. Additionally, since the DC-DC converter operates with either a high input voltage or a low input voltage, the ACX converter may operate without being configured based on the whether the input is high-line or low-line.

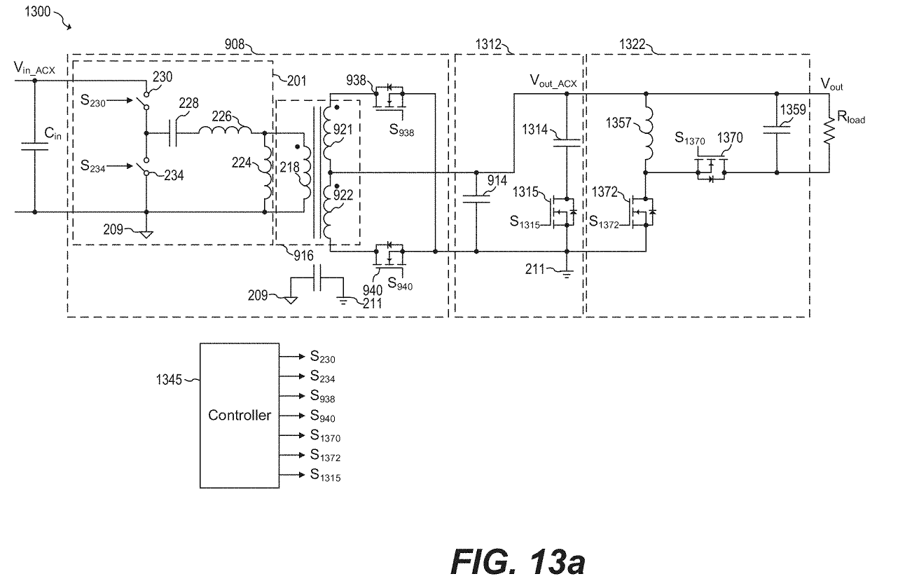

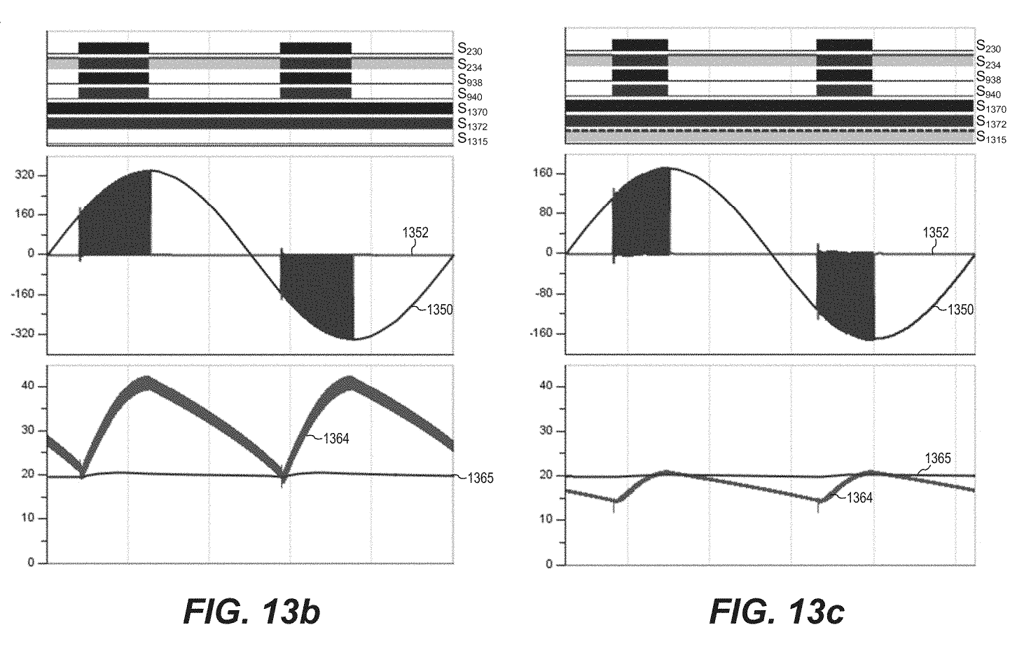

FIG. 13a shows converter 1300, according to an embodiment of the present invention. Converter 1300 includes ACX converter 908, energy storage stage 1312, DC-DC converter 1322, and controller 1345. Energy storage stage 1312 includes capacitors 914, and 1314 and transistor 1315. DC-DC converter 1322 is implemented as an inverted buck-boost converter and includes transistors 1370, and 1372, inductor 1357 and capacitor 1359. Capacitor 1359 also serves as output capacitor Cₒᵤₜ.

During normal operation, ACX converter 908 receives an AC signal at node Vᵢₙ_{_}_{ACX} and produces a rectified voltage at node Vₒᵤₜ_{_}_{ACX}. ACX converter 908 may operate, for example, as described with respect to FIGS. 9a-9e. Energy storage stage 1312 stores energy and may also reduce the voltage ripple of node Vₒᵤₜ_{_}_{ACX}. DC-DC converter 1322 receives the rectified voltage of node Vₒᵤₜ_{_}_{ACX} and produces a regulated voltage at node Vₒᵤₜ.

Since the amount of energy stored in a capacitor is proportional to the voltage across the capacitor, energy storage stage 1312 may turn on transistors 1315 during a low-line input mode to increase the amount of capacitance available to, for example, double the amount. Alternatively, energy storage stage 1312 may be implemented without transistor 1315 and capacitor 1314.

Since DC-DC converter 1322 is implemented as an inverted buck-boost converter, DC-DC converter 1322 may produce a regulated output irrespective of whether the input is a high-line input or a low-line input. For example, when the voltage of node Vᵢₙ_{_}_{ACX} is a high-line voltage, DC-DC converter 1322 may step down the voltage for the majority of the time. When the voltage of node Vᵢₙ_{_}_{ACX} is a low-line voltage, DC-DC converter 1322 may step down the voltage during some times and step up the voltage during other times.

DC-DC converter 1322 may regulate the voltage across R_{load} to, for example, 20 V, 18 V, 12 V, 10 V, 5 V, 3.3 V, 1.8 V, 1.2 V, or 1 V. Other values may be used. The voltage at node Vₒᵤₜ may be referred to as a negative voltage. DC-DC converter 1322 may be implemented according to various ways known in the art and may be configured to regulate the voltage while complying with a particular standard such as, for example, USB-PD.

Controller 1345 is configured to produce signals S₂₃₀, S₂₃₄, S₉₃₈, S₉₄₀, S₁₃₇₀, S₁₃₇₂, and S₁₃₁₅ to drive bidirectional switches 230 and 234, and transistors 938, 940, 1370, 1372, and 1315, respectively. Coupling controller 1345 to bidirectional switches 230 and 234, and transistors 938, 940, 1370, 1372, and 1315 may be achieved through direct electrical connection or indirect electrical connections. For example, opto-couplers may be used to electrically isolate controller 1345 from other parts of the circuit. Coupling between controller 1345 and other components of converter 1300 may also be achieved in other ways known in the art.

Controller 1345 may be implemented as a single chip. For example, controller 1345 may be implemented in a monolithic substrate. Alternatively, controller 1345 may be implemented as a collection of controllers, such as, for example, a controller for controlling ACX converter 908 and energy storage stage 1312, and a controller for controlling DC-DC converter 1322. Other implementations known in the art are also possible.

FIGS. 13b and 13c illustrate waveforms of converter 1300 delivering 65 W to load R_{load} with a voltage at node Vₒᵤₜ of 20 V, with a high-line input signal (240 VAC/50 Hz) and low-line input signal (120 VAC/60 Hz), respectively, and with a fourth mode of control, according to an embodiment of the present invention. FIGS. 13b and 13c include curves 1350 and 1352 of the voltage across bidirectional switches 230 and 234, respectively, curve 1364 of the voltage of node Vₒᵤₜ_{_}_{ACX}, curve 1265 of the absolute voltage of node Vₒᵤₜ, and signals S₂₃₀, S₂₃₄, S₉₃₈, S₉₄₀, S₁₃₇₀, S₁₃₇₂, and S₁₃₁₅ for driving bidirectional switches 230 and 234, and transistors 938, 940, 1370, 1372, and 1315, respectively.

As shown in FIG. 13b, when the voltage of Vᵢₙ_{_}_{ACX} is a high-line voltage, the voltage of node Vₒᵤₜ_{_}_{ACX} remains higher than the absolute voltage of node Vₒᵤₜ for most of the time, as shown by curves 1364 and 1365, respectively. Therefore, DC-DC converter 1322 may step down the voltage for most of the time. When the voltage of Vᵢₙ_{_}_{ACX} is a low-line voltage, the voltage of node Vₒᵤₜ_{_}_{ACX} remains lower than the absolute voltage of node Vₒᵤₜ for most of the time, as shown by curves 1364 and 1365 of FIG. 13c, respectively. Therefore, DC-DC converter 1322 may step up the voltage for most of the time.

Advantages of some embodiments of the present invention include operating the ACX converter without configuring the ACX converter based on the whether the input is high-line or low-line. Other advantages include that a converter may be implemented with two bidirectional switches and five transistors.

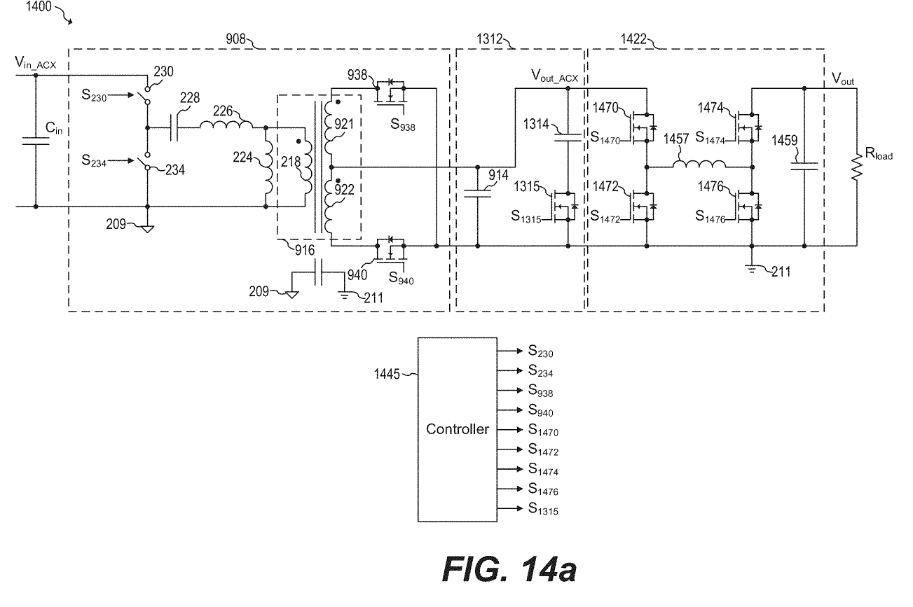

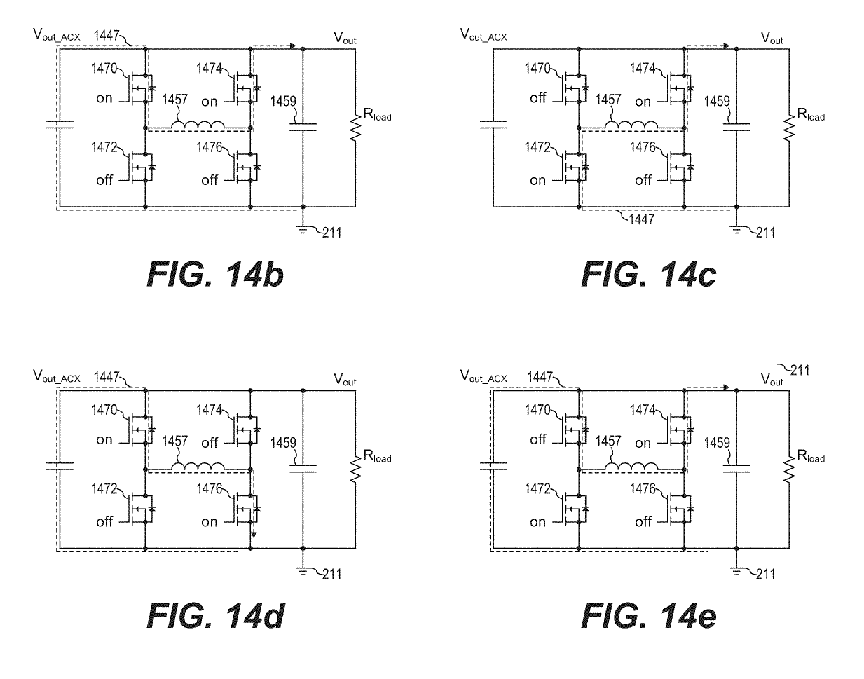

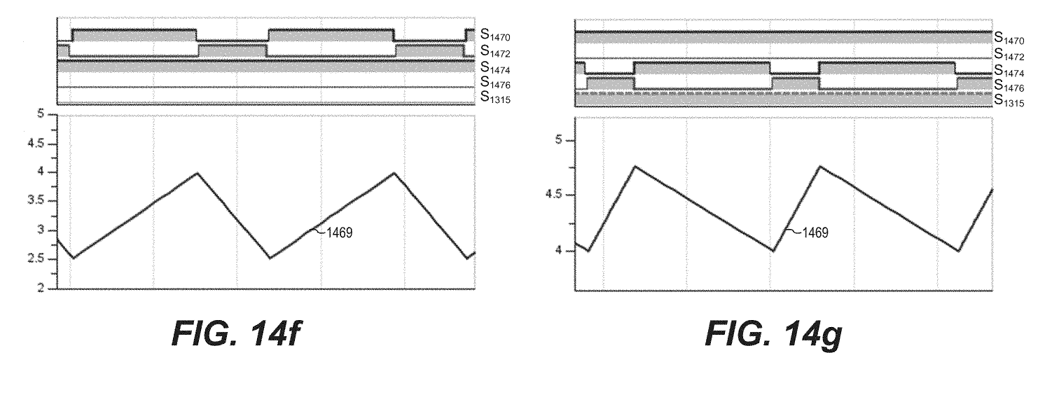

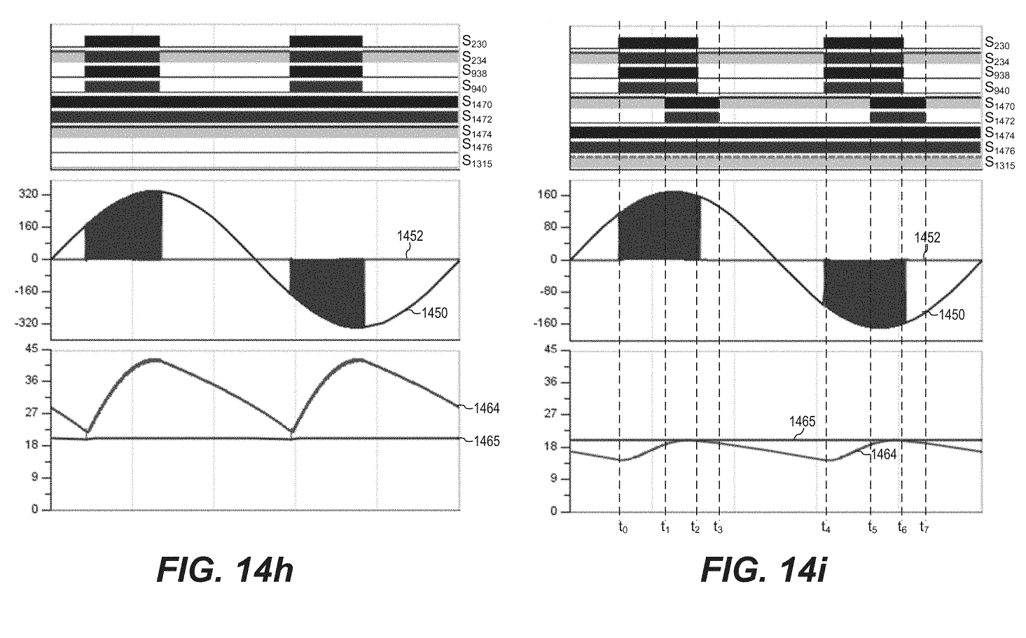

FIG. 14a shows converter 1400, according to an embodiment of the present invention. Converter 1400 includes ACX converter 908, energy storage stage 1312, DC-DC converter 1422, and controller 1445. DC-DC converter 1422 is implemented as a non-inverted buck-boost converter and includes transistors 1470, 1472, 1474, and 1476, inductor 1457 and capacitor 1459. Capacitor 1459 also serves as output capacitor Cₒᵤₜ.

During normal operation, ACX converter 908 receives an AC signal at node Vᵢₙ_{_}_{ACX} and produces a rectified voltage at node Vₒᵤₜ_{_}_{ACX}. ACX converter 908 may operate, for example, as described with respect to FIGS. 9a-9e. Energy storage stage 1312 stores energy and may also reduce the voltage ripple of node Vₒᵤₜ_{_}_{ACX}. Energy storage stage 1312 may operate, for example, as described with respect to FIGS. 13a and 13b. DC-DC converter 1422 receives the rectified voltage of node Vₒᵤₜ_{_}_{ACX} and produces a regulated voltage at node Vₒᵤₜ.

Since DC-DC converter 1422 is implemented as a non-inverted buck-boost converter, DC-DC converter 1422 may produce a regulated output irrespective of whether the ACX converter 1408 receives a high-line voltage or a low-line voltage. For example, when ACX converter 1408 receives a high-line voltage, DC-DC converter 1422 may step down the voltage for the majority of the time. When ACX converter 1408 receives a low-line voltage, DC-DC converter 1422 may step up the voltage for the majority of the time.

DC-DC converter 1422 may regulate the voltage of node Vₒᵤₜ to, for example, 20 V, 18 V, 12 V, 10 V, 5 V, 3.3 V, 1.8 V, 1.2 V, or 1 V. Other values may be used. DC-DC converter 1422 may be implemented according to various ways known in the art and may be configured to regulate the voltage while complying with a particular standard such as, for example, USB-PD.

Controller 1445 is configured to produce signals S₂₃₀, S₂₃₄, S₉₃₈, S₉₄₀, S₁₄₇₀, S₁₄₇₂, S₁₄₇₄, S₁₄₇₆ and S₁₃₁₅ to drive bidirectional switches 230 and 234, and transistors 938, 940, 1470, 1472, 1474, 1476, and 1315, respectively. Coupling controller 1445 to bidirectional switches 230 and 234, and transistors 938, 940, 1470, 1472, 1474, 1476, and 1315 may be achieved through direct electrical connection or indirect electrical connections. For example, opto-couplers may be used to electrically isolate controller 1345 from other parts of the circuit. Coupling between controller 1445 and other components of converter 1400 may also be achieved in other ways known in the art.

Controller 1445 may be implemented as a single chip. For example, controller 1445 may be implemented in a monolithic substrate. Alternatively, controller 1445 may be implemented as a collection of controllers, such as, for example, a controller for controlling ACX converter 908 and energy storage stage 1312, and a controller for controlling DC-DC converter 1422. Other implementations known in the art are also possible.

FIGS. 14b-14e illustrate the switching and current behavior of DC-DC converter 1422, according to an embodiment of the present invention. In particular, FIGS. 14b and 14c correspond to current and switching behavior when DC-DC converter 1422 steps down the voltage and FIGS. 14d and 14e correspond to current and switching behavior when DC-DC converter steps up the voltage.

As shown in FIG. 14b, when DC-DC converter 1422 steps down the voltage, DC-DC converter 1422 may have a first state with transistors 1470 and 1474 on and transistors 1472 and 1476 off. The first state may be an energizing state. In the first state, current 1447 may flow from node Vₒᵤₜ_{_}_{ACX}, through transistor 1470, inductor 1457, and transistor 1474 towards node Vₒᵤₜ.

As shown in FIG. 14c, when DC-DC converter 1422 steps down the voltage, DC-DC converter 1422 may have a second state with transistors 1472 and 1474 on and transistors 1470 and 1476 off. The second state may be a de-energizing state. In the second state, current 1447 may flow from ground 211, through transistor 1472, inductor 1457, and transistor 1474 towards node Vₒᵤₜ. DC-DC converter 1422 may alternate between the first state and the second state to deliver power to load R_{load} when DC-DC converter 1422 steps down the voltage.

As shown in FIG. 14d, when DC-DC converter 1422 steps up the voltage, DC-DC converter 1422 may have a third state with transistors 1470 and 1476 on and transistors 1472 and 1474 off. The third state may be an energizing state. In the third state, current 1447 may flow from node Vₒᵤₜ_{_}_{ACX}, through transistor 1470, inductor 1457, and transistor 1476 towards ground 211.

As shown in FIG. 14e, when DC-DC converter 1422 steps up the voltage, DC-DC converter 1422 may have a fourth state with transistors 1470 and 1476 on and transistors 1472 and 1474 off. The fourth state may be a de-energizing state. In the fourth state, current 1447 may flow from node Vₒᵤₜ_{_}_{ACX}, through transistor 1470, inductor 1457, and transistor 1474 towards node Vₒᵤₜ. DC-DC converter 1422 may alternate between the third state and the fourth state to deliver power to load R_{load} when DC-DC converter 1422 steps up the voltage. A person skilled in the art may recognize that intermediate states may be used, for example, to achieve ZVS when switching transistors 1470, 1472, 1474 and 1476.

FIGS. 14f and 14g illustrate waveforms of DC-DC converter 1422 switching with ZVS, according to an embodiment of the present invention. In particular, FIGS. 14f and 14h illustrate waveforms of DC-DC converter steps down the voltage with a high-line input and steps up the voltage with a low-line input, respectively. The waveforms of FIGS. 14f and 14g may be understood in view of FIGS. 14a-14e. FIGS. 14f and 14g include curve 1469 of the current flowing through inductor 1457, and signals and signals S₁₄₇₀, S₁₄₇₂, S₁₄₇₄, S₁₄₇₆, and S₁₃₁₅ for driving transistors 1470, 1472, 1474, 1476, and 1315, respectively.

As shown in FIG. 14f, when DC-DC converter 1422 steps down the voltage with a high-line input, transistor 1315 is off and transistors 1470, 1472, 1474 and 1476 alternate between the first state and the second state. As shown in FIG. 14f, there is a delay between signals S₁₄₇₀ and S₁₄₇₂ as DC-DC converter 1422 transitions between the first and second states. The delay is used to allow for the drain capacitance of transistors 1472 and 1470 to discharge, respectively. After the drain capacitance of the respective transistors is discharged, such transistors may be turned on with ZVS.

When DC-DC converter 1422 steps up the voltage with a low-line input, transistor 1315 is on and transistors 1470, 1472, 1474 and 1476 alternate between the third state and the fourth state, as shown in FIG. 14g. The delay between switching signals S1474 and S1476 as DC-DC converter 1422 transitions between the third and fourth state is used to allow for ZVS switching.

FIGS. 14h and 14i illustrate waveforms of converter 1400 delivering 65 W to load R_{load} with a voltage at node Vₒᵤₜ of 20 V, with a high-line input signal (240 VAC/50 Hz) and low-line input signal (120 VAC/60 Hz), respectively, and with a third mode of control, according to an embodiment of the present invention. FIGS. 14h and 14i include curves 1450 and 1452 of the voltage across bidirectional switches 230 and 234, respectively, curve 1464 of the voltage of node Vₒᵤₜ_{_}_{ACX}, curve 1465 of the voltage of node Vₒᵤₜ, and signals S₂₃₀, S₂₃₄, S₉₃₈, S₉₄₀, S₁₄₇₀, S₁₄₇₂, S₁₄₇₄, S₁₄₇₆, and S₁₃₁₅ for driving bidirectional switches 230 and 234, and transistors 938, 940, 1470, 1472, 1474, 1476 and 1315, respectively.

As shown in FIG. 14h, when the voltage of Vᵢₙ_{_}_{ACX} is a high-line voltage, the voltage of node Vₒᵤₜ_{_}_{ACX} may remain higher than the voltage of node Vₒᵤₜ, as shown by curves 1464 and 1465, respectively. Therefore, DC-DC converter 1422 may step down the voltage continuously when the voltage of Vᵢₙ_{_}_{ACX} is a high-line voltage. When the voltage of Vᵢₙ_{_}_{ACX} is a low-line voltage, the voltage of node Vₒᵤₜ_{_}_{ACX} remains lower than the voltage of node Vₒᵤₜ for most of the time, as shown by curves 1464 and 1465 of FIG. 14i, respectively. Therefore, DC-DC converter 1422 may step up the voltage for a period of time, step down the voltage for another period of the time, and step up and down the voltage for yet another period of time. For example, as shown in FIG. 14i, DC-DC converter 1422 operates steps up the voltage between times t₀-t₁ and times t₃-t₅ and steps up and down the voltage between times t₁-t₃ and times t₅-t₇.

FIG. 15a shows converter 1500, according to an embodiment of the present invention. Converter 1500 includes ACX converter 1508, energy storage stage 912, DC-DC converter 1122, and controller 1545. ACX converter 1508 includes ACX primary circuit 201, transformer 1516 and ACX secondary circuit 903. Transformer 1516 includes upper primary winding 1518, lower primary winding 1519, upper secondary winding 921, lower secondary winding 922, and bidirectional switches 1523, 1525 and 1527.

During normal operation, ACX converter 1508 receives an AC signal at node Vᵢₙ_{_}_{ACX} and produces a rectified voltage at node Vₒᵤₜ_{_}_{ACX}. Energy storage stage 912 stores energy and may also reduce the voltage ripple of node Vₒᵤₜ_{_}_{ACX}. DC-DC converter 1122 receives the rectified voltage of node Vₒᵤₜ_{_}_{ACX} and produces a regulated voltage at node Vₒᵤₜ.

More particularly, the switching and operation of DC-DC converter 1122 may be similar to that of DC-DC converter 1122, as illustrated in FIGS. 11f,-h-i. The switching and operation of ACX primary circuit 201 may be similar to that of primary circuit 201 as illustrated in FIGS. 2a-2k, and 3a-3k. The switching and operation of ACX secondary circuit 903 may be similar to that of ACX secondary circuit 903 as illustrated in FIGS. 9a-9e.

Transformer 1516 may be configured in a first state with primary winding 1518 in series with primary winding 1519 by closing bidirectional switch 1523 and opening bidirectional switches 1525 and 1527. Alternatively, transformer 1516 may be configured in a second state with primary winding 1518 in parallel with primary winding 1519 by opening bidirectional switch 1523 and closing bidirectional switches 1525 and 1527. When transformer 1516 is configured in the first state, transformer 1516 may have a turn ratio of 2n to 1. When transformer 1516 is configured in the second state, transformer 1516 may have a turn ratio of n to 1.

ACX converter 1508 may configure transformer 1516 to the first state when the voltage of node Vᵢₙ_{_}_{ACX} is a high-line voltage and to the second state when the voltage of node Vᵢₙ_{_}_{ACX} is a low-line voltage. By configuring ACX converter 1508 in a first and second state when the voltage node Vᵢₙ_{_}_{ACX} is a high-line voltage or a low-line voltage, respectively, ACX converter 1508 produces a voltage at node Vₒᵤₜ_{_}_{ACX} with a peak amplitude that does not substantially change based on whether the input voltage is a high-line voltage or a low-line voltage. Energy storage stage 912, therefore, may be implemented with capacitor 914, without using additional transistors.

Since the peak amplitude of voltage of node Vₒᵤₜ_{_}_{ACX} does not substantially vary based on whether the input voltage of ACX converter 1508, DC-DC converter 1122 may be implemented as a buck converter, as shown in FIG. 15a.

Bidirectional switches 1523, 1525 and 1527 may be implemented according to various ways known in the art. For example, bidirectional switches 1523, 1525 and 1527 may be implemented with the topologies shown in FIGS. 2c and 2d. Some embodiments may implement bidirectional switches 1523, 1525 and 1527 with mechanical relays. Other implementations are also possible.

Controller 1545 is configured to produce signals S₂₃₀, S₂₃₄, S₁₅₂₃, S₁₅₂₅, S₁₅₂₇, S₉₃₈, S₉₄₀, S₁₁₅₃ and S₁₁₅₅ to drive bidirectional switches 230, 234, 1523, 1525, 1527, and transistors 938, 940, 1153 and 1155, respectively. Coupling controller 1545 to bidirectional switches 230, 234, 1523, 1525, 1527, and transistors 938, 940, 1153 and 1155 may be achieved through direct electrical connection or indirect electrical connections. For example, opto-couplers may be used to electrically isolate controller 1145 from other parts of the circuit. Coupling between controller 1545 and other components of converter 1500 may also be achieved in other ways known in the art.

Controller 1545 may be implemented as a single chip. For example, controller 1545 may be implemented in a monolithic substrate. Alternatively, controller 1545 may be implemented as a collection of controllers, such as, for example, a controller for controlling ACX converter 1508, and a controller for controlling DC-DC converter 1122. Other implementations known in the art are also possible.

FIGS. 15b-15c illustrate waveforms of converter 1500 during normal operation using the fourth mode of control, according to an embodiment of the present invention. In particular, FIGS. 15b-15c illustrate waveforms of converter 1500 delivering 65 W to load R_{load} with a voltage at node Vₒᵤₜ of 20 V, and with a high-line input signal (240 VAC/50 Hz) and a low-line input (120 VAC/60 Hz) signal, respectively. The waveforms of FIGS. 15b-15c may be understood in view of FIG. 15a. FIGS. 15b-15c include curves 1550 and 1552 of the voltage across bidirectional switches 230 and 234, respectively, curve 1564 of the voltage of node Vₒᵤₜ_{_}_{ACX}, curve 1565 of the voltage of node Vₒᵤₜ, and signals S₂₃₀, S₂₃₄, S₉₃₈, S₉₄₀, S₁₁₅₃ and S₁₁₅₅ for driving bidirectional switches 230 and 234, and transistors 938, 940, 1153 and 1155, respectively.

As shown in FIGS. 15b-15c, since the turn ratio of transformer 1516 is configured based on whether the input of ACX converter 1508 is a high-line input or a low-line input, the maximum peak voltage of node Vₒᵤₜ_{_}_{ACX} may be substantially similar between the high-line and low-line inputs, as shown by curve 1564. The maximum peak voltage of node Vₒᵤₜ_{_}_{ACX} may be, for example, 42 V. Other maximum peak voltages may be used.

Advantages of some embodiments of the present invention include simplifying the energy storage state by implementing a transformer with a configurable turn ratio based on the input voltage. Other advantages include implementing a converter with five bidirectional switches and four transistors.

Converters using an ACX converter stage may also be implemented with PFC. For example, FIG. 16a shows converter 1600 with PFC, according to an embodiment of the present invention. Converter 1600 includes AC power source 202, EMI filter 204, input capacitor Cᵢₙ, AC-LLC (ACX) converter with PFC 1608, energy storage stage 1612, DC-DC converter with PFC 1622, output capacitor Cₒᵤₜ and load R_{load}.

During normal operation, converter 1600 may operate in a similar manner as converter 200. Converter 1600, however, operates ACX converter 1608 with PFC, instead of without PFC.

ACX converter 1608 may achieve PFC by operating with a fifth mode of control. When ACX converter 1608 is operated with the fifth mode of control, bidirectional switches 230 and 234 continuously switch at a constant frequency and a constant duty cycle. Similarly, the transistors of the secondary circuit of ACX converter 1608 continuously switch. In other words, ACX converter 1608 may transfer energy from the primary side of the transformer of ACX converter 1608 to the secondary side of the transformer and vice-versa. The forward energy transfer rule, as given by Equation 1, may not be followed in the fifth mode of control.

ACX converter 1608 may implement DC-DC converter 1622 with PFC, as opposed to without PFC. The implementation of DC-DC converters with PFC are known in the art, and any DC-DC converter implementation with PFC may be used.

Since ACX converter 1608 is configured to receive an AC signal, ACX converter 1608 may operate with a small input capacitor Cᵢₙ. The main energy storage, however, may be implemented in output capacitor Cₒᵤₜ rather than in energy storage stage 1612. Therefore, the capacitors of energy storage stage 1612 may also be small. As illustrated in FIG. 16a, the voltage waveform of node V. ACX may be a high voltage (HV) AC signal. The voltage waveform of node Vₒᵤₜ_{_}_{ACX} may be a low voltage (LV) rectified DC signal. The voltage waveform of node Vₒᵤₜ may be a regulated low voltage DC waveform.

FIG. 16b shows a particular implementation of converter 1600 with PFC, according to an embodiment of the present invention. Converter 1600 may be implemented, for example, with ACX converter 908, energy storage stage 1612, and DC-DC converter 1622. DC-DC converter 1622 may be implemented as a boost converter with PFC.

The switching and operation of ACX converter 908 may be similar to that of ACX converter 908 as illustrated in FIGS. 9a-9e and operating with the fifth mode of control. DC-DC converter 1622 may operate as any boost converter with PFC known in the art.

FIG. 16c illustrate waveforms of converter 1600 during normal operation using the fifth mode of control, according to an embodiment of the present invention. In particular, FIG. 16c illustrate waveforms of converter 1600 delivering 100 W to load R_{load} with a voltage at node Vₒᵤₜ of 20 V, and with a high-line input signal (240 VAC/50 Hz). The waveforms of FIG. 16c may be understood in view of FIGS. 16a and 16b. FIG. 16c includes curves 1650 and 1652 of the voltage across bidirectional switches 230 and 234, respectively, curve 1664 of the voltage of node Vₒᵤₜ_{_}_{ACX}, curve 1665 of the voltage of node Vₒᵤₜ, curve 1662 of the voltage of node Vᵢₙ, curve 1661 of current Iᵢₙ flowing though AC power source 202, and signals S₂₃₀, S₂₃₄, S₉₃₈, and S₉₄₀ for driving bidirectional switches 230 and 234, and transistors 938, and 940, respectively.

As shown in FIG. 16c, bidirectional switches 230 and 234 and transistors 938 and 940 are continuously switching. The voltage of node Vₒᵤₜ_{_}_{ACX} is a rectified AC signal that may reach 0 V, as shown by curve 1664. As a result of the PFC, current Iᵢₙ is in phase with the voltage of node Vᵢₙ, as shown by curves 1661 and 1662, respectively. As shown by curves 1664 and 1665, DC-DC converter 1622 is operating as a boost converter.

Advantages of some embodiments of the present invention include that converters utilizing an ACX converter may be implemented with PFC and without PFC. ACX converters, therefore, may be useful for implementing power supplies in a wide power delivery range. For example, embodiments of the present invention may be configured to deliver power levels of 1 W or less. Other embodiments may be configured to deliver power levels of 65 W, 100 W or higher. Other power delivery levels may be used.

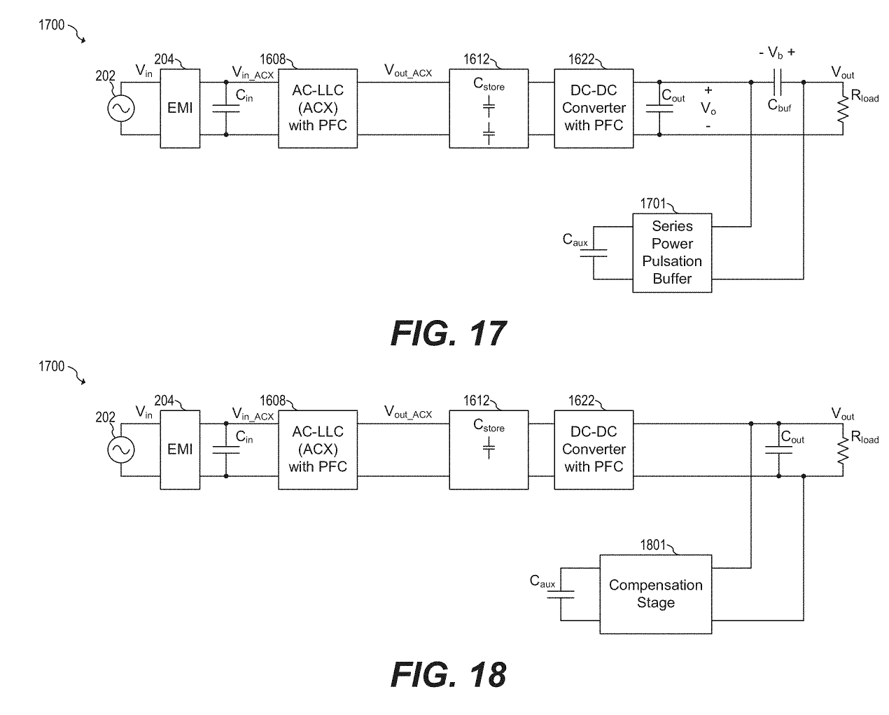

Some converters may exhibit output ripple in the output voltage. For example, output ripple at twice the mains frequency may be present in the output voltage. Some converters having a converter stage using an ACX converter with PFC may reduce output ripple by using various techniques. For example, FIG. 17 shows a converter having ACX converter with PFC 1608 and series-power-pulsation buffer 1701, according to an embodiment of the present invention. Converter 1700 includes AC power source 202, EMI filter 204, input capacitor Cᵢₙ, AC-LLC (ACX) converter with PFC 1608, energy storage stage 1612, DC-DC converter with PFC 1622, output capacitor Cₒᵤₜ, series-power-pulsation buffer 1701, buffer capacitor C_{buf}, auxiliary capacitor Cₐᵤₓ, and load R_{load}.

During normal operation, converter 1700 may operate in a similar manner as converter 1600. Converter 1700, however, has buffer capacitor C_{buf} in series with load R_{load}. To maintain a regulated output, series-power-pulsation buffer 1701 may control the voltage across buffer capacitor C_{buf} such that Vₒᵤₜ=V₀+V_{b} is constant.

Series-power-pulsation buffer 1701 may be implemented according to various ways known in the art. For example, series-power-pulsation buffer 1701 may include a buck or buck-boost converter coupled from auxiliary capacitor Cₐᵤₓ to buffer capacitor C_{buf}. Other implementations are also possible.

FIG. 18 shows a converter having ACX converter with PFC 1608 and compensation stage 1801, according to an embodiment of the present invention. Converter 1800 includes AC power source 202, EMI filter 204, input capacitor Cᵢₙ, AC-LLC (ACX) converter with PFC 1608, energy storage stage 1612, DC-DC converter with PFC 1622, output capacitor Cₒᵤₜ, compensation stage 1801, auxiliary capacitor Cₐᵤₓ, and load R_{load}.

During normal operation, converter 1800 may operate in a similar manner as converter 1600. Converter 1800, however, has compensation stage 1801 coupled in parallel to load R_{load}. To maintain a regulated output, compensation stage 1801 may transfer energy from auxiliary capacitor Cₐᵤₓ to output capacitor Cₒᵤₜ and transfer energy from output capacitor Cₒᵤₜ to auxiliary capacitor Cₐᵤₓ.

Compensation stage 1801 may be implemented according to various ways known in the art. For example, compensation stage 1801 may include a buck or boost converter coupled between auxiliary capacitor Cₐᵤₓ and output capacitor Cₒᵤₜ. Other implementations are also possible.

### Example 1

A converter including: a rectifying stage having a first supply terminal and a second supply terminal, the first supply terminal and the second supply terminal configured to receive a bipolar AC signal from an AC power source, the rectifying stage including a half-bridge circuit coupled between the first supply terminal and the second supply terminal, a transformer, and a resonant tank coupled between an output of the half-bridge circuit and a primary winding of the transformer; and a DC-DC converter stage coupled between the rectifying stage and an output terminal.

### Example 2

The converter of example 1, where the resonant tank includes a resonant capacitor, a first resonant inductor and a second resonant inductor.

### Example 3

The converter of one of examples 1 or 2, where an output of the DC-DC converter stage is configured to provide power to a USB power delivery (USB-PD) interface.

### Example 4

The converter of one of examples 1 to 3, where the half-bridge circuit includes: a first bidirectional switch coupled between the first supply terminal and the output of the half-bridge circuit; and a second bidirectional switch coupled between the output of the half-bridge circuit and the second supply terminal.

### Example 5

The converter of one of examples 1 to 4, where the first bidirectional switch is turned off and the second bidirectional switch is turned on when a voltage between the first and second supply terminal of the rectifying stage is lower than an output of the rectifying stage multiplied by a first factor.

### Example 6

The converter of one of examples 1 to 5, further including a controller configured to turn on and off the first bidirectional switch and the second bidirectional switch with a constant frequency and a constant duty cycle.

### Example 7

The converter of one of examples 1 to 6, where the controller turns on the first bidirectional switch with zero voltage switching (ZVS) or quasi-ZVS (QZVS).

### Example 8

The converter of one of examples 1 to 7, where the rectifying stage further includes a switching network coupled to a first secondary winding of the transformer.

### Example 9

The converter of one of examples 1 to 8, further including a controller configured to turn on and off transistors of the switching network when a voltage between the first and second supply terminal of the rectifying stage is lower than an output of the rectifying stage multiplied by a first factor.

### Example 10

The converter of one of examples 1 to 8, further including a controller configured to turn off transistors of the switching network when a voltage between the first and second supply terminal of the rectifying stage is lower than an output of the rectifying stage multiplied by a first factor.

### Example 11

The converter of one of examples 1 to 10, where the first factor is based on a turning ratio of the transformer.

### Example 12

The converter of one of examples 1 to 11, where the switching network includes a first transistor coupled between a first terminal of the first secondary winding and a first switching terminal, a second transistor coupled between the first terminal of the first secondary winding and a second switching terminal; and the DC-DC converter stage is coupled between the first switching terminal and the second switching terminal.

### Example 13

The converter of one of examples 1 to 12, where the switching network further includes: a first capacitor coupled between the first switching terminal and a second terminal of the first secondary winding; and a second capacitor coupled between the second terminal of the first secondary winding and the second switching terminal.

### Example 14

The converter of one of examples 1 to 13, where the switching network further includes: a third transistor coupled between the first switching terminal and a second terminal of the first secondary winding; a fourth transistor coupled between the second terminal of the first secondary winding and the second switching terminal; and a first capacitor coupled between the first switching terminal and the second switching terminal.

### Example 15

The converter of one of examples 1 to 14, where the switching network further includes: a first bidirectional switch coupled between the fourth transistor and the second terminal of the first secondary winding.

### Example 16

The converter one of examples 1 to 11, where the switching network includes a first transistor coupled between a first terminal of the first secondary winding and a first switching terminal; a second transistor coupled between a second terminal of a second secondary winding and the first switching terminal; and a first capacitor coupled between the first switching terminal and a second switching terminal, the second switching terminal coupled to a second terminal of the first secondary winding and a first terminal of the second secondary winding; and the DC-DC converter stage coupled between the first switching terminal and the second switching terminal.

### Example 17

The converter one of examples 1 to 11 and 16, where the primary winding of the transformer includes a first portion of the primary winding coupled to a second portion of the primary winding via a first switch.

### Example 18

The converter one of examples 1 to 11 and 16 to 17, where the first switch includes a mechanical relay.

### Example 19

The converter one of examples 1 to 11 and 16 to 18, where the DC-DC converter stage includes a non-inverted buck-boost converter.

### Example 20

The converter one of examples 1 to 11 and 16 to 18, where the DC-DC converter stage includes a boost converter.

### Example 21

The converter one of examples 1 to 4, 6 to 18, where the DC-DC converter stage includes a boost converter with power factor correction (PFC).

### Example 22

A method of operating a converter including: receiving a bipolar AC signal from an AC power source with a half-bridge circuit coupled to a resonant tank, where the resonant tank includes a first resonant capacitor, a first resonant inductor and a second resonant inductor; activating the resonant tank; rectifying the bipolar AC signal with a switching network to produce a rectified signal; galvanically isolating the half-bridge circuit from the switching network; and converting the rectified signal to a first voltage with a DC-DC converter.

### Example 23

The method of example 22, where activating the resonant tank includes: turning on and off a first bidirectional switch of the half-bridge circuit at a constant frequency and a constant duty cycle; and turning on and off a second bidirectional switch of the half-bridge circuit at a constant frequency and a constant duty cycle.

### Example 24

The method of one of examples 22 or 23, where gavanically isolating the half-bridge circuit from the switching network includes using a transformer coupled between the half-bridge circuit and the switching network; and the rectifying the bipolar AC signal further includes turning on and off transistors of the switching network.

### Example 25

The method of one of examples 22 to 24, where the rectifying the bipolar AC signal further includes turning off transistors of the switching network when the bipolar AC signal is lower than the rectified signal multiplied by a first factor.

### Example 26

The method of one of examples 22 to 25, where the rectifying the bipolar AC signal further includes turning off the first bidirectional switch and turning on the second bidirectional switch when a voltage across a secondary winding of the transformer is larger than a voltage across a primary winding of the transformer multiplied by a first factor.

### Example 27

The method of one of examples 22 to 26, where the bipolar AC signal includes a root-mean-square (RMS) voltage between 85 V and 140 V and the first voltage includes a DC level between 3 V and 20 V.

### Example 28

The method of one of examples 22 to 26, where the bipolar AC signal includes an RMS voltage between 200 V and 270 V and the first voltage includes a DC level larger than 3 V.

### Example 29

A resonant converter including: a half-bridge circuit configured to receive a bipolar AC signal, the half-bridge circuit including a first bidirectional switch coupled between a first supply terminal and a second supply terminal; a second bidirectional switch coupled between the first bidirectional switch and the second supply terminal; and a resonant tank coupled between the half-bridge circuit and a primary winding of a transformer, where the first bidirectional switch and the second bidirectional switch turn on and off at a constant frequency and a constant duty cycle.

### Example 30

The resonant converter of example 29, where the resonant tank includes a resonant capacitor, a first resonant inductor, and a second resonant inductor.

### Example 31

The resonant converter of one of examples 29 or 30, where the transformer includes the first resonant inductor.

### Example 32

The resonant converter of one of examples 29-31, further including a switching network coupled between a secondary winding of the transformer and an output terminal.

### Example 33

The resonant converter of one of examples 29-32, where switches of the switching network are configured to turn off when a voltage of the bipolar AC signal is lower than a voltage of the output terminal multiplied by a first factor.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A converter, comprising:
a half-bridge circuit configured to receive a bipolar AC signal without rectification and comprising a first bidirectional switch and a second bidirectional switch coupled in series to form an output of the half-bridge circuit, each of the first bidirectional switch and the second bidirectional switch being configured to accommodate positive and negative voltages across the bidirectional switch,
a transformer, and
a resonant tank coupled between the output of the half-bridge circuit and a primary winding of the transformer.

2. The converter of claim 1, wherein the resonant tank comprises a resonant capacitor, a first resonant inductor and a second resonant inductor.

3. The converter of claim 1, further comprising a DC-DC converter stage coupled between the rectifying stage and an output terminal, wherein an output of the DC-DC converter stage is configured to provide power to a USB power delivery (USB-PD) interface.

4. (canceled)

5. (canceled)

6. The converter of claim 1, further comprising a controller configured to turn on and off the first bidirectional switch and the second bidirectional switch with a constant frequency and a constant duty cycle.

7. The converter of claim 6, wherein the controller turns on the first bidirectional switch with zero voltage switching (ZVS) or quasi-ZVS (QZVS).

8. The converter of claim 1, further comprising a switching network coupled to a first secondary winding of the transformer.

9-11. (canceled)

12. The converter of claim 8, wherein:
the switching network comprises a first transistor coupled between a first terminal of the first secondary winding and a first switching terminal, and a second transistor coupled between the first terminal of the first secondary winding and a second switching terminal; and
a DC-DC converter stage is coupled between the first switching terminal and the second switching terminal.

13. (canceled)

14. The converter of claim 12, wherein the switching network further comprises:
a third transistor coupled between the first switching terminal and a second terminal of the first secondary winding; and
a fourth transistor coupled between the second terminal of the first secondary winding and the second switching terminal.

15. The converter of claim 14, wherein the switching network further comprises:
a first bidirectional switch coupled between the fourth transistor and the second terminal of the first secondary winding.

16. The converter of claim 8, wherein:
the switching network comprises a first transistor coupled between a first terminal of the first secondary winding and a first switching terminal; a second transistor coupled between a second terminal of a second secondary winding and the first switching terminal; and a first capacitor coupled between the first switching terminal and a second switching terminal, the second switching terminal coupled to a second terminal of the first secondary winding and a first terminal of the second secondary winding; and
a DC-DC converter stage is coupled between the first switching terminal and the second switching terminal.

17. The converter of claim 16, wherein the primary winding of the transformer comprises a first portion of the primary winding coupled to a second portion of the primary winding via a first switch.

18. The converter of claim 17, wherein the first switch comprises a mechanical relay.

19. The converter of claim 16, wherein the DC-DC converter stage comprises a non-inverted buck-boost converter.

20. The converter of claim 16, wherein the DC-DC converter stage comprises a boost converter.

21. The converter of claim 1, further comprising a DC-DC converter stage coupled between the rectifying stage and an output terminal, wherein the DC-DC converter stage comprises a boost converter with power factor correction (PFC).

22. A method of operating a converter, the method comprising:
receiving a bipolar AC signal from an AC power source with a half-bridge circuit coupled to a reason tank without first rectifying the bipolar AC signal, wherein the resonant tank comprises a first resonant capacitor, a first resonant inductor and a second resonant inductor, wherein the half-bridge circuit comprises a first bidirectional switch and a second bidirectional switch coupled in series, each of the first bidirectional switch and the second bidirectional switch being configured to accommodate positive and negative voltages across the bidirectional switch;
activating the resonant tank;
rectifying an output of the half-bridge circuit with a switching network to produce a rectified signal;
galvanically isolating the half-bridge circuit from the switching network; and
converting the rectified signal to a first voltage with a DC-DC converter.

23. The method of claim 22, wherein activating the resonant tank comprises:
turning on and off the first bidirectional switch of the half-bridge circuit at a constant frequency and a constant duty cycle; and
turning on and off the second bidirectional switch of the half-bridge circuit at a constant frequency and a constant duty cycle.

24. The method of claim 23, wherein
gavanically isolating the half-bridge circuit from the switching network comprises using a transformer coupled between the half-bridge circuit and the switching network; and
rectifying the output of the half-bridge circuit comprises turning on and off transistors of the switching network.

25. (canceled)

26. (canceled)

27. The method of claim 22, wherein the bipolar AC signal comprises a root-mean-square (RMS) voltage between 85 V and 140 V and the first voltage comprises a DC level between 3 V and 20 V.

28. The method of claim 22, wherein the bipolar AC signal comprises an RMS voltage between 200 V and 270 V and the first voltage comprises a DC level larger than 3 V.

29. A resonant converter, comprising:
a half-bridge circuit configured to receive a bipolar AC signal without rectification, the half-bridge circuit comprising a first bidirectional switch coupled between a first supply terminal and an output of the half-bridge circuit and a second bidirectional switch coupled between the output and a second supply terminal, each of the first bidirectional switch and the second bidirectional switch being configured to accommodate positive and negative voltages across the bidirectional switch; and
a resonant tank coupled between the output of the half-bridge circuit and a primary winding of a transformer, wherein the first bidirectional switch and the second bidirectional switch turn on and off at a constant frequency and a constant duty cycle.

30. The resonant converter of claim 29, wherein the resonant tank comprises a resonant capacitor, a first resonant inductor, and a second resonant inductor.

31. The resonant converter of claim 30, wherein the transformer comprises the first resonant inductor.

32. The resonant converter of claim 29; further comprising a switching network coupled between a secondary winding of the transformer and an output terminal of the resonant converter.

33. (canceled)

34. The converter of claim 1, further comprising:
a first capacitor coupled between first and second supply terminals for the bipolar AC signal; and
at least one second capacitor coupled between first and second output terminals of the converter,
wherein the first capacitor is smaller than the at least one second capacitor and is not configured to store energy for the converter,
wherein the at least one second capacitor is configured to store energy for the converter.

35. The converter of claim 34, wherein the at least one second capacitor is rated for lower peak voltages than peak voltages preset in the bipolar AC signal.

36. The method of claim 22, wherein:
a first capacitor is coupled between first and second supply terminals for the bipolar AC signal;
a second capacitor is coupled between first and second output terminals of the converter;
the first capacitor is smaller than the second capacitor and is not configured to store energy for the converter; and
the second capacitor is configured to store energy for the converter.

37. The method of claim 36, wherein the at least one second capacitor is rated for lower peak voltages than peak voltages present in the bipolar AC signal.

38. The resonant converter of claim 29, further comprising:
a first capacitor coupled between first and second supply terminals for the bipolar AC signal; and
at least one second capacitor coupled between first and second output terminals of the converter,
wherein the first capacitor is smaller than the at least one second capacitor and is not configured to store energy for the converter,
wherein the at least one second capacitor is configured to store energy for the converter.

39. The resonant converter of claim 38, wherein the at least one second capacitor is rated for lower peak voltages than peak voltages present in the bipolar AC signal.
